(19) United States
(12) Patent Application Publication
(10) Pub. No.: US 2005/0251408 A1
(43) Pub. Date: Nov. 10, 2005

(54) System and method for conducting intelligent multimedia marketing operations

(76) Inventors: S. Swaminathan, Corralitos, CA (US); Scott Knowles, Eagle Point, CA (US)

Correspondence Address: WAGNER, MURABITO & HAO LLP, Third Floor, Two North Market Street, San Jose, CA, 95113, US

(21) Appl. No.: 11/111,021

(22) Filed: Apr. 21, 2005

Related U.S. Application Data
(60) Provisional application No. 60/565,248, filed on Apr. 23, 2004.

(51) Int. Cl. G06F 17/60

(52) U.S. Cl. 705/1; 705/14

(57) ABSTRACT

A system and method for conducting intelligent multimedia marketing operations is disclosed. A computer based system, which can operate in a network environment, conducts the intelligent multimedia operation. In one embodiment, the system can be deployed in a physical asset such as a multimedia outlet (e.g., a store) wherein an intelligent infrastructure monitors customer behavior therein and inventory. The system performs a variety of computer implemented processes related to conducting intelligent multimedia marketing operations.P

### RELATED UNITED STATES APPLICATION

This utility patent application claims priority to Provisional U.S. patent application Ser. No. 60/565,248, entitled System and Method for Conducting Intelligent Multimedia Marketing Operations, by S. Swaminathan and Scott J. Knowles, filed on Apr. 23, 2004, with attorney docket number GPV-001.PRO, which is incorporated herein by reference in its entirety.

### TECHNICAL FIELD

The present invention relates to the field of computer implemented business operations methods. More specifically, embodiments of the present invention relate to a computer based system and a computer implemented method for conducting intelligent multimedia marketing operations.

### BACKGROUND

Media products such as movies on Digital Versatile Disc (DVD), Video Cassette Recording (VCR) formats such as ‘VHS’, and similar formats are provided to customers by a variety of business operations. Such media products can be purchased in a variety of conventional stores, including stores specializing in media, stores selling general merchandise, and even in supermarkets and the like.

There are large media stores that allow customers to purchase such media products from a large, well rounded selection of media choices (movies in various formats such as DVD and VHS, electronic games, music products, etc.). Their large, diverse selection also includes choices from various genres, sub-genres, genre combinations, and artistic considerations (actors, studios, music scores, etc.).

Large media stores also allow customers, typically subscribing customers or other customers who have otherwise identified themselves to the business entity operating the store (e.g., with some sort of security, such as a major credit card) to check media products out for temporary use elsewhere, with some promise or security to return them after a pre-agreed period of time.

More recently, advances in computer and communications technology have promoted the widespread use of large networks such as the Internet and its World Wide Web (Web; www) and the like by media consumers (e.g., potentially or actually customers). This has allowed some business operations to market media products accordingly. For instance, movies are rented via the Web.

The conventional Web-based method for renting movies proceeds by a Web-based media providing entity receiving one or more item selection criteria from a customer, which correspond to items such as media products that the customer desires to rent. One or more of these items, up to some specified number and indicated by the selection criteria, are provided to the customer, typically by mail, parcel delivery service, or the like.

Then, upon receiving the items from the customer (e.g., by returning the items provided, such as after it is used at the customer's locale), one or more other items also indicated by the selection criteria, not to exceed that specified number, are provided to the customer, also typically by mail, parcel delivery service, or the like. In this conventional process, the selection criteria constitute a customer generated “wish list.”

While this conventional process provides a convenient method to provide movies to customers, it can tend to constrain some multimedia marketing operations that are attempted to be conducted using its design. For instance, the conventional Web-based method of providing movies to customers provides the movies based on the customer's wish list. Thus, a multimedia marketing entity operating using the conventional process can be constrained in other operational aspects, such as inventory management, procurement, and the like to await an inflow of customer generated wish lists.

This conventional constraint can cause delays in providing movies on a wish list. This can occur for example where a large number of customers all request the same movie at the same time and where the stock on hand of that particular movie are insufficient to meet the demand. In order to alleviate this conventional constraint, a backlog of demand for that movie must be met by procurement or other efforts to obtain additional copies of the movie. This can cause additional delay, and as demand is increasing for the particular product being procured, can result in additional cost. Unavailability and concomitant delays in receiving “wished for” movies can adversely affect customer satisfaction levels and thus can cause customer migration, sometimes referred to as “churn,” and thus can cause diminished revenue flows.

The conventional approach of providing movies based on customer generated wish lists is thus inherently reactive, and lacking in proactive predictability apart from the wish lists. Further, the conventional approach is limited in its inferential usefulness to other than providing movies in response to the wish lists. A multimedia marketing entity applying the conventional approach can not easily use its customers' wish lists, its inventory, and the logistical and other aspects of its operations, for applications apart from simple demand-based provision of requested movies.

Further still, the conventional Web-based movie providing method can lack ready applicability to a business entity outside of its Web-based model. Thus, while the conventional method provides a modicum of convenience to its customers, in allowing the ease of requesting movies they want to watch from their home or office computer or the like, it can not easily be applied by some business entities without it setting up a dedicated Web-based operation. Setting up such a Web-based operation can be outside of a business entity's plans, business model, and can be expensive. Thus, from the standpoint of some business entities, the conventional Web-based movie rental model can lack a degree of practicality.

Additionally, the conventional Web-based movie rental model can lack flexibility, where it is attempted to be applied in some business environments. Retail based and/or store based multimedia marketing operations for instance have physical assets such as structures, infrastructures, personnel, and stocked inventories. Some such multimedia marketing operations have more than one such physical asset. For example, some such multimedia marketing operations have multiple stores in various locales. They engage in marketing multimedia products using these physical assets.

Where such multiple physical assets are based in different locations, they may well conduct their marketing operations amongst a demographically varied and diverse customer base. This diversity can be as rich as the geographic diversity, which can range from rural, semi-rural, and suburban mall based locales to urban commercial sites. Economic diversity may well also be a factor. For instance, a multimedia marketing entity's stores or other outlets can be in retail locations ranging from older discount based shopping centers to new upscale downtown boutique districts.

However, the conventional Web-based movie rental model can lack sufficient flexibility to allow it to be readily and easily applied to multimedia marketing businesses that are retail based, store based, or otherwise based on some established structure or other physical asset. In particular, the conventional Web-based movie rental model can be unresponsive to the economic, geographic, and demographic diversity of the customer base of a multimedia marketing operation conducted upon a physical asset platform.

Some business entities that conduct multimedia marketing operations are also engaged in marketing products other than media products. For example, some such business entities may conduct multimedia marketing operations among or proximate to other marketing operations, such as the sale of retail products. Such retail products may be very wide ranging, from groceries to consumer electronics products and appliances, to clothing, and any other conceivable product or product class. However, the conventional Web-based movie rental method can also lack the flexibility for application to such an entity, such as to promote its marketing of products other than the media products.

Further, some business entities that conduct multimedia marketing operations are also engaged in marketing multimedia products other than movies, and/or marketing multimedia products by a Web-based method other than the conventional Web-based movie rental method. As to such other multimedia marketing operations, the conventional Web-based movie rental method can also lack practicality and/or flexibility.

Thus, the conventional Web-based movie rental method can tend to constrain some multimedia marketing operations. Based on ever changing customer whim expressed through wish lists, this tendency can constrain inventory management, cause delays and expense, and adversely impact customer satisfaction. This can result in churn, such as customer migration, and negatively impact revenue.

The conventional Web-based movie rental method can be impractical and/or expensive to apply for some multimedia marketing entities. Further, the conventional Web-based movie rental method can lack either practicality, flexibility, or both, for application to business entities engaged in marketing of multimedia products. This is especially evident where the multimedia marketing operations are conducted in conjunction with other marketing operations.

### SUMMARY

Accordingly, what is needed is a system and/or method that does not constrain multimedia marketing operations. What is also needed is a system and/or method for conducting multimedia marketing operations that does not constrain inventory management, cause delays or undue expense, or thereby adversely impact customer satisfaction. The needed system and/or method should thus function to minimize churn factors such as customer migration, and thus to minimize negative revenue impacts. Further, what is needed is a system and/or method that is practical and/or inexpensive to apply for a multimedia marketing entity and should provide flexibility thereto. The needed system and/or method should thus also function to provide comprehensive and efficient multimedia marketing operations in conjunction with other marketing operations that a business entity may conduct.

A system and method for conducting intelligent multimedia marketing operations is disclosed. In one embodiment, a computer based system, which can operate in a network environment, conducts the intelligent multimedia operation. In one embodiment, the system can be deployed in a physical asset such as a multimedia outlet (e.g., a store) wherein an intelligent infrastructure monitors customer behavior therein and inventory.

The intelligent infrastructure can employ a sensor system arrayed in a grid so as to map the interior of the structure, monitor the customer, and arrange and stock inventory therein. The grid can have many arrangements and can employ sensors such as radio frequency identification (RFID) or another electronic tag, electronic label, code plate, transponder, etc. Detectors and readers allow these tags to be read to input data to the system. In one embodiment, a multimedia intelligent label writer device and/or a self-contained multimedia intelligent label writer system, encodes such tags.

The intelligent infrastructure can map and monitor aisles, shelves, inventory, and customer movement and other behavior therein, and can include interactive stations, such as intelligent kiosks, to provide information, customer service, checkout, and other functions. The intelligent infrastructure is managed, in one embodiment, by a computer based subsystem manager.

In one embodiment, the computer based system employs software in a powerful integrated applications suite, to perform a computer based process for operating an intelligent multimedia rental operation. In one embodiment, inventory and customer information is databased. Such databased information can include an inventory item history document, and a customer profile document, which can include a variety of relational data regarding the customer's preferences, behavior, and history.

The computer based system in one embodiment performs a number of computer implemented processes related to conducting intelligent multimedia marketing operations. Such processes can be flexibly combined and include, in various embodiments, identifying a customer, intelligently checking out multimedia items, monitoring a customer, performing a simple non-cash transaction, detecting the return of multimedia materials, restocking inventory, and/or detecting customer dissatisfaction.

In various embodiments, such computer implemented processes include detecting a pattern characterizing customer dissatisfaction, acting to ameliorate customer dissatisfaction, profiling multimedia items, profiling a customer, profiling a multimedia outlet, including for instance profiling using geographic and/or demographic data.

In various embodiments, such computer implemented processes include those related to marketing. For instance, such processes include marketing a multimedia product based on multimedia product usage, marketing a multimedia related product based on various consumer behavior, creating a list of targeted multimedia consumers, marketing narrowcasting services based on multimedia consumer behavior, marketing video on demand products, marketing a multimedia product based on consumer preferences for other products, and/or for marketing using directed incentive.

In various embodiments, such computer implemented processes include those related to customer satisfaction. For instance, such processes include identifying patterns relating to subscription cancellations, identifying a customer as a potential for subscription cancellation, improving and/or monitoring customer satisfaction.

In various embodiments, such computer implemented processes include those related to inventory management. For instance, such processes include replenishing inventory in a multimedia outlet, replenishing inventory in a multimedia outlet from another multimedia outlet, replacing saturated inventory in a multimedia outlet, transmigrating saturated inventory between multimedia outlets, and/or profiling retail environments.

In one embodiment, a sub-system provides for downloading on-line media products as part of an intelligent multimedia rental operation. The present embodiment performs a computer implemented process for marketing downloadable on-line media products to customers of an intelligent multimedia rental operation, in a network environment. One embodiment performs marketing of media products to customers based on downloaded on-line media products.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1A depicts an exemplary network based system for operating an intelligent multimedia operation, according to one embodiment of the present invention.

FIG. 1B depicts an exemplary system for operating an intelligent multimedia operation, according to one embodiment of the present invention.

FIG. 2 depicts an exemplary unique data bearing customer identifier card, according to one embodiment of the present invention.

FIG. 3 depicts an exemplary data bearing multimedia case and slot, according to one embodiment of the present invention.

FIG. 4 depicts an exemplary grid arrayed intelligent multimedia outlet, according to one embodiment of the present invention.

FIG. 5 depicts an exemplary applications suite, according to one embodiment of the present invention.

FIG. 6 is a flowchart of an exemplary computer implemented process for operating an intelligent multimedia rental operation, according to one embodiment of the present invention.

FIG. 7 depicts an exemplary network environment, according to one embodiment of the present invention.

FIG. 8A depicts one exemplary intelligent multimedia outlet layout, according to one embodiment of the present invention.

FIG. 8B depicts another exemplary intelligent multimedia outlet layout, according to one embodiment of the present invention.

FIG. 9 depicts an exemplary intelligent aisle subsystem, according to one embodiment of the present invention.

FIG. 10 depicts an exemplary intelligent aisle subsystem manager, according to one embodiment of the present invention.

FIG. 11 depicts an exemplary intelligent multimedia outlet kiosk, according to one embodiment of the present invention.

FIG. 12 is a flowchart of an exemplary computer implemented process for identifying a customer, according to one embodiment of the present invention.

FIG. 13 is a flowchart of an exemplary computer implemented process for intelligently checking out multimedia items, according to one embodiment of the present invention.

FIG. 14 is a flowchart of an exemplary computer implemented process for monitoring a customer, according to one embodiment of the present invention.

FIG. 15 is a flowchart of an exemplary computer implemented process for performing a simple non-cash transaction, according to one embodiment of the present invention.

FIG. 16 is a flowchart of an exemplary computer implemented process for detecting the return of multimedia materials, according to one embodiment of the present invention.

FIG. 17 is a flowchart of an exemplary computer implemented process for restocking inventory, according to one embodiment of the present invention.

FIG. 18 is a flowchart of an exemplary computer implemented process for detecting customer dissatisfaction, according to one embodiment of the present invention.

FIG. 19 depicts a databased inventory item history document, according to one embodiment of the present invention.

FIG. 20 depicts a databased customer profile document, according to one embodiment of the present invention.

FIG. 21 is a flowchart of an exemplary computer implemented process for detecting a pattern characterizing customer dissatisfaction, according to one embodiment of the present invention.

FIG. 22 is a flowchart of an exemplary computer implemented process for acting to ameliorate customer dissatisfaction, according to one embodiment of the present invention.

FIG. 23 is a flowchart of an exemplary computer implemented process for profiling multimedia items, according to one embodiment of the present invention.

FIG. 24 is a flowchart of an exemplary computer implemented process for profiling a customer, according to one embodiment of the present invention.

FIG. 25 is a flowchart of an exemplary computer implemented process for profiling a multimedia outlet, according to one embodiment of the present invention.

FIG. 26 is a flowchart of an exemplary computer implemented process for profiling using geographic and/or demographic data, according to one embodiment of the present invention.

FIG. 27 is a flowchart of an exemplary computer implemented process for is a flowchart of an exemplary computer implemented process for marketing a multimedia product based on multimedia product usage, according to one embodiment of the present invention.

FIG. 28 is a flowchart of an exemplary computer implemented process for marketing a multimedia related product based on various consumer behavior, according to one embodiment of the present invention.

FIG. 29 is a flowchart of an exemplary computer implemented process for creating a list of targeted multimedia consumers, according to one embodiment of the present invention.

FIG. 30 is a flowchart of an exemplary computer implemented process for marketing narrowcasting services based on multimedia consumer behavior, according to one embodiment of the present invention.

FIG. 31 is a flowchart of an exemplary computer implemented process for marketing video on demand products, according to one embodiment of the present invention.

FIG. 32 is a flowchart of an exemplary computer implemented process for marketing a multimedia product based on consumer preferences for other products, according to one embodiment of the present invention.

FIG. 33 is a flowchart of an exemplary computer implemented process for marketing using directed incentive, according to one embodiment of the present invention.

FIG. 34 is a flowchart of an exemplary computer implemented process for identifying patterns relating to subscription cancellations, according to one embodiment of the present invention.

FIG. 35 is a flowchart of an exemplary computer implemented process for identifying a customer as a potential for subscription cancellation, according to one embodiment of the present invention.

FIG. 36 is a flowchart of an exemplary computer implemented process for improving and monitoring customer satisfaction, according to one embodiment of the present invention.

FIG. 37 is a flowchart of an exemplary computer implemented process for replenishing inventory in a multimedia outlet, according to one embodiment of the present invention.

FIG. 38 is a flowchart of an exemplary computer implemented process for replenishing inventory in a multimedia outlet from another multimedia outlet, according to one embodiment of the present invention.

FIG. 39 is a flowchart of an exemplary computer implemented process for detecting and replacing saturated inventory in a multimedia outlet, according to one embodiment of the present invention.

FIG. 40 is a flowchart of an exemplary computer implemented process for transmigrating saturated inventory between multimedia outlets, according to one embodiment of the present invention.

FIG. 41 is a flowchart of an exemplary computer implemented process for profiling retail environments, according to one embodiment of the present invention.

FIG. 42 depicts an exemplary multimedia intelligent label writer device, according to one embodiment of the present invention.

FIG. 43 depicts an exemplary self-contained multimedia intelligent label writer system, according to one embodiment of the present invention.

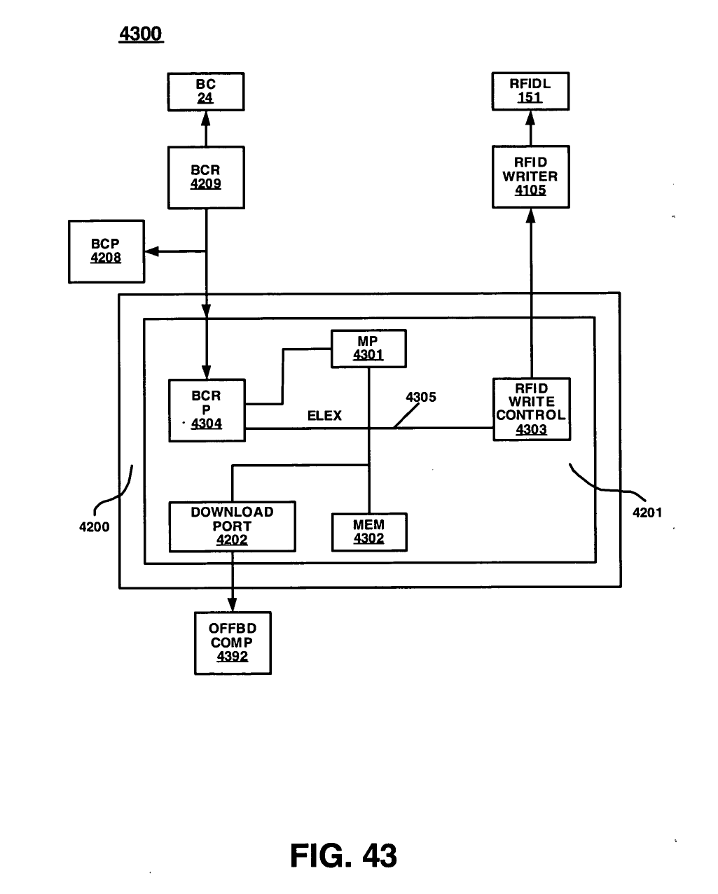

FIG. 44 depicts an exemplary system for downloading on-line media products with an intelligent multimedia rental operation, according to one embodiment of the present invention.

FIG. 45 is a flowchart of an exemplary computer implemented process for downloading on-line media products with an intelligent multimedia rental operation, according to one embodiment of the present invention.

FIG. 46 is a flowchart of an exemplary computer implemented process for marketing downloadable on-line media products to customers of an intelligent multimedia rental operation, according to one embodiment of the present invention.

FIG. 47 is a flowchart of an exemplary computer implemented process for marketing media products to customers of an intelligent multimedia rental operation based on downloaded on-line media products, according to one embodiment of the present invention.

FIG. 48 is a flowchart of a process for expediting customer signups, according to one embodiment of the present invention.

### DETAILED DESCRIPTION

A system and method for conducting intelligent multimedia marketing operations is disclosed. Reference will now be made in detail to embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications, and equivalents, which may be included within the spirit and scope of the invention as defined by the appended claims.

Furthermore, in the following detailed description of embodiments of the present invention, numerous specific details are set forth in order to provide a thorough understanding of the present invention. In other instances, well known components, circuits, methods, materials, and procedures have not been described in detail so as not to unnecessarily obscure aspects of the present invention. Embodiments of the present invention are discussed primarily in the context of a method and system for conducting intelligent multimedia marketing operations.

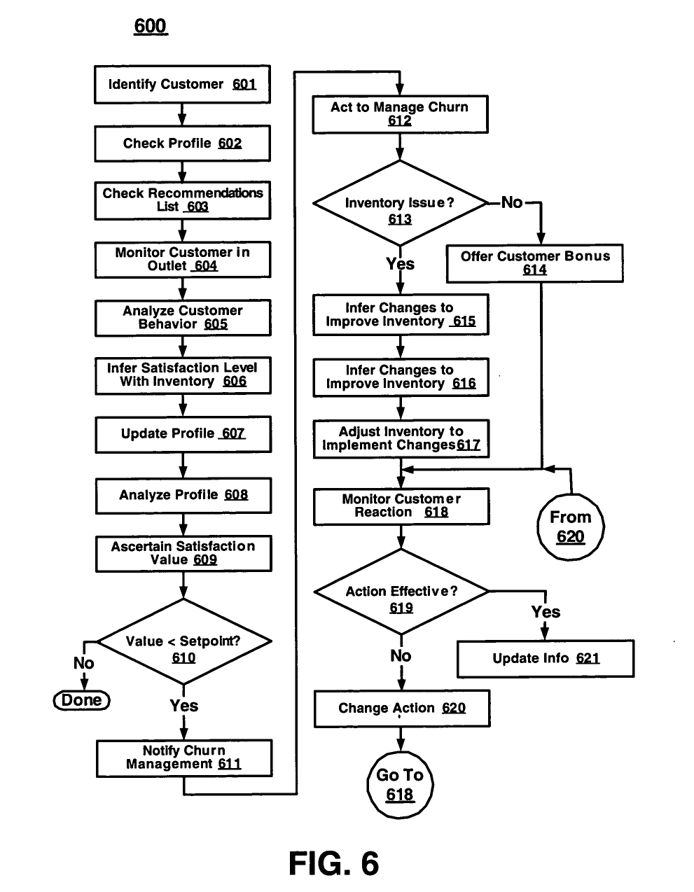

Certain portions of the detailed descriptions of embodiments of the invention, which follow, are presented in terms of processes (e.g., processes 600 and 1200-1800, 2100-4100 of FIGS. 6, 12-18, and 12-41, respectively). Although specific steps are disclosed herein describing the operations of these processes, such steps are exemplary. That is, embodiments of the present invention are well suited to performing various other steps or variations of the steps and/or sequences of steps recited in the flowcharts herein.

In one embodiment, such processes are carried out by processors and electrical/electronic components under the control of computer readable and computer executable instructions comprising code contained in a computer usable medium. The computer readable and computer executable instructions reside, for example, in code within a computer usable medium and used in the processor, data storage features, memory, registers and other components of a computer system performing the method for interactively configuring a device. However, the computer readable and computer executable instructions may reside in any type of computer readable medium.

A computer system that embodies a system and performs a method for conducting intelligent multimedia marketing operations can comprise any kind of computer system with sufficient computing power and memory capacity. For example, the computer system can comprise a specialized marketing computer system, a client computer system, a specialized business control computer system, a workstation computer system, a personal computer system, or a specialized outlet operations computing system. Modules of the system for conducting intelligent multimedia marketing operations can be implemented in software, firmware, and/or hardware or any combination of software, firmware, and/or hardware.

A method and system for conducting intelligent multimedia marketing operations is disclosed. In one embodiment, a computer based system, which can operate in a network environment, conducts the intelligent multimedia operation. In one embodiment, the system is deployed in a physical asset such as a multimedia outlet (e.g., a store) wherein an intelligent infrastructure monitors customer behavior therein and inventory. In one embodiment, the system performs a variety of computer implemented processes related to conducting intelligent multimedia marketing operations.

Therefore, a system and method is disclosed that do not apply constraints to multimedia marketing operations that can result from conventional Web-based movie rental systems. The system and method disclosed herein do not constrain inventory management, cause delays or undue expense, or adversely impact customer satisfaction. The system and method disclosed herein thus function to minimize churn factors such as customer migration, and thus minimize negative revenue impacts. Further, the system and method disclosed herein is practical and inexpensive to apply for a multimedia marketing entity and provides increased flexibility thereto. The system and method disclosed herein thus also function to provide comprehensive and efficient multimedia marketing operations in conjunction with other marketing operations that a business entity may conduct.

Exemplary System

Details characterizing a system for conducting intelligent multimedia marketing operations can vary from one embodiment of the present invention to another. In one embodiment, a system for conducting intelligent multimedia marketing operations may have a more or less distributed characteristic than in another. That system may have a correspondingly less centralized characteristic than the other.

Embodiments of the present invention are well suited to conduct intelligent multimedia marketing operations upon a system platform comprising a variety of integrated and/or networked components and subsystems. Elements of a system for conducting intelligent multimedia marketing operations can comprise computer software, firmware, hardware, and/or combinations of software, firmware, and/or hardware.

Exemplary System Overviews

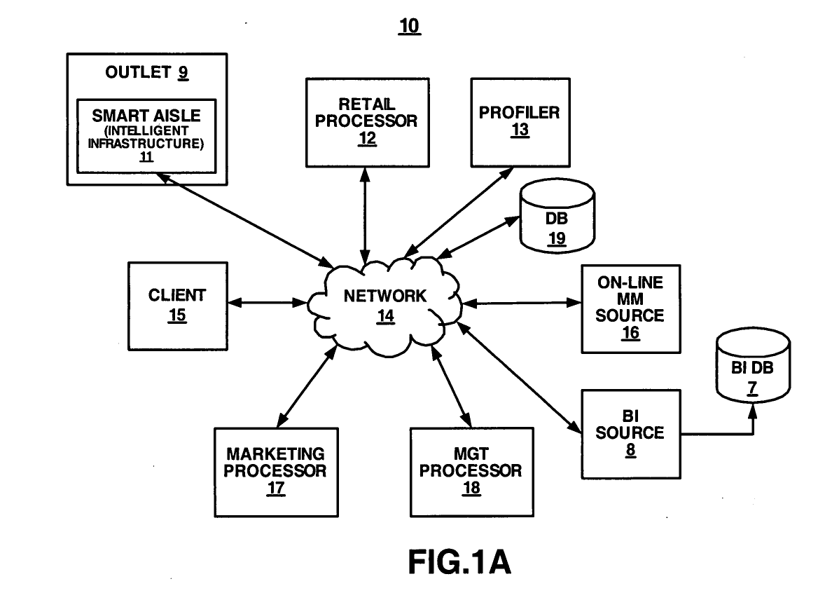

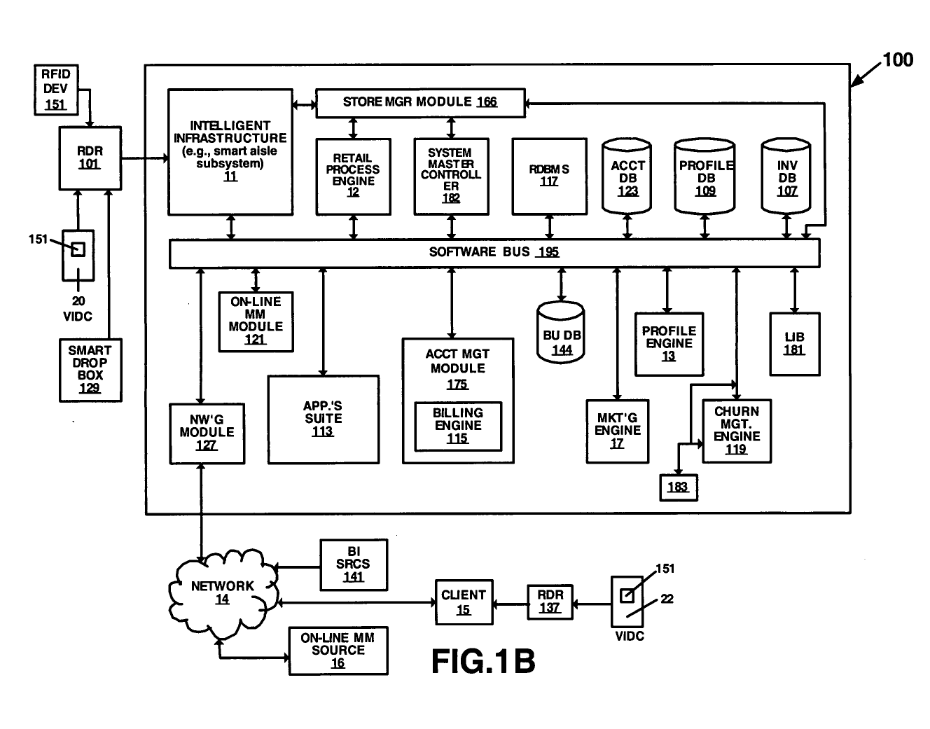

FIG. 1A depicts an exemplary network based system 10 for operating an intelligent multimedia rental operation, according to one embodiment of the present invention. A multimedia outlet 9, such as a store for renting for digital versatile discs (DVD), electronic games, and other electronic entertainment, educational, and/or other media. Multimedia outlet 9 comprises an intelligent infrastructure 11, which will also be referred to herein as a smart aisle subsystem.

Intelligent infrastructure 11 functions via a network 14 with a retail processor 12. In one embodiment, retail processor 12 is integrated with intelligent infrastructure 11. Network 14 can comprise any network of sufficient bandwidth capacity and interconnection facilities. Network 14 can comprise, for instance, a local area network (LAN), a wide area network (WAN), a public or a private network, a virtual private network, the Internet.

Intelligent infrastructure 11 functions via a network 14 with a profiler 13. Profiler 13 analyzes data obtained from database 19 via network 14 to generate profiles relating to subscribing or other customer users of system 10, such as customers of multimedia outlet 9, profiles relating to inventory items, such as particular DVD titles and/or other multimedia product identifiers, and/or other profiles of commercial significance.

A management processor 18 functions via network 14 with profiler 13, retail processor 12, and intelligent infrastructure 11 to intelligently control retail operations at multimedia outlet 9, based on profiles generated thereby. Some of these functions of management processor 18 include minimizing factors leading to subscription churning, wherein subscribing customers of multimedia outlet 9 do not renew their subscriptions. For example, management processor 18 can direct the control of multimedia product inventory to accord with a customer's preference, as derived from analysis of a customer profile generated by profiler 13.

Management processor 18 functions via network 14 with marketing processor 17 to perform marketing operations so as to increase customer satisfaction, so as to minimize factors leading to subscription churn. In one embodiment, system 10 functions to allow a client computer 15 used by a subscribing customer to access and utilize an on-line source 16 of products of various entertainment and other media, such as an on-line source of downloadable music (e.g., Itunes™, of Apple Computers, Inc., a corporation in Cupertino, Calif.), with billing there for and other such transactions handled by components of system 10.

System 10 can access source 8 of business intelligence (BI) information via network 14. BI source 8 can retrieve data from (and write to) a BI database 7. BI information significant to the operations of system 10 can include, for example, any kind of economic, financial, credit, business, logistical, and/or other data that can affect the pricing, availability, demand for, or production of any kind of entertainment, educational, music, video, or other multimedia products, services, related or other products and commodities, credit information, and demographic, geographic, historical, political, and/or other information. In one embodiment, system 10 comprises a distributed network of some centralized and/or partially centralized subsystems and/or components.

FIG. 1B depicts an exemplary system 100 for operating an intelligent multimedia rental operation with centralized and/or partially centralized subsystems and/or components, according to one embodiment of the present invention. In one embodiment, a system master controller 182 provides an control and/or oversight function over system 100. System 100 comprises a software bus 195 or another programming interface that allows other component software modules to efficiently transfer data one to another. In an alternative embodiment, modules, components, elements or subsystems of system 100 operate directly, one with another. In one embodiment, the functionality depicted in FIG. 1B of various modules, components, elements or subsystems comprising herein can be combined in an entity, and/or subsumed by another. For instance, in one embodiment, the functions of outlet manager module 166 and retail process engine 12 can be combined by subsuming one of the components into the other.

In one embodiment, intelligent infrastructure 11 operates via software bus 195 (e.g., is co-functional) with an outlet manager module 166 and a retail process engine 12. Together (and with other components), these components of system 100 function to control and facilitate the intelligent operation of a multimedia outlet (e.g., multimedia outlet 9; FIG. 1A). In one embodiment, outlet manager module 166 and/or retail process engine 12 operate together to manage, control, and safeguard inventory, conduct transactions, provide information to customers, personnel, and visitors, and conduct other business related activities.

A relational database management system (RDBMS) 117 functions via software bus 195 to control the organization, indexing, storage, retrieval, security, and integrity of data stored in a profile database 109, an inventory database 107, an accounting database 123, and a backup database 144. RDBMS 117 allows access to and usage of this data by various modules, components, elements, subsystems, and/or applications comprising system 100. Backup database 144 provides redundant storage of data stored in profile database 109, inventory database 107, and accounting database 123. In one embodiment, a single database functions as profile database 109, inventory database 107, and accounting database 123. A library 181 functions as a code library for applications, components, and subsystems comprising system 100.

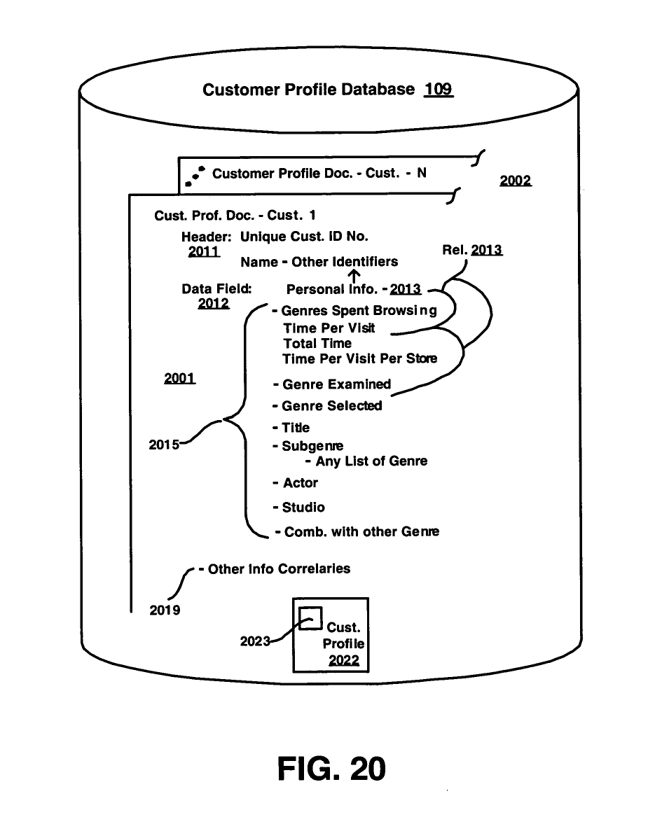

Information retrieved from profile database 109 can be used, for example, by profile engine 13 to generate a customer profile (e.g., customer profile 200; FIG. 20). Such a customer profile is used by churn (e.g., subscription cancellation) management engine 119 to detect a pattern that can indicate a probability that the customer profiled therein might not renew a subscription, and to recommend or trigger ameliorative action by system 100. Churn management engine 119 can comprise an incentive engine 183 for providing incentives to subscribing customers to continue their subscriptions. In one embodiment, incentive engine 183 is independent or churn management engine 119, and thus can operate with software bus 195 independently.

For instance, the customer's profile may indicate that the customer's visits to multimedia outlets served by system 100 have become less frequent, dropping below some threshold value indicative of a greater than 70 percent probability that the customer will not renew a current subscription. This exemplary setpoint (or any other determined to be an accurate predictor) can trigger an analyzing action by churn management engine 119.

The customer's profile may indicate that the customer is a young single female who shops at a particular multimedia outlet associated with system 100, and that she is quite fond of movies on DVD format media in the action/adventure genre, and starring Arnold Schwarzenegger. The customer profile might indicate that the customer spends an inordinate amount of time in an area of the multimedia outlet housing this genre, and that she picks up and examines other movies in this genre, but does not rent them, and that her rental history indicates that she has already viewed a number of movies in the action/adventure genre, particularly those starring Arnold Schwarzenegger.

Analysis of this exemplary customer profile by churn management engine 119, triggered by sensing that the frequency of this customer's visits have dropped below a churn alert threshold can perceive this as a significant pattern which can be expanded or understood by seeking other relevant, perhaps related information. For instance, detection of this pattern may automatically and/or programmatically trigger churn management engine 119 to examine information from inventory database 107. Such information can relate, for example, to the inventory of action/adventure DVDs in general, and in particular those starring Arnold Schwarzenegger, in the media outlet this customer normally patronizes.

The information from inventory database 107 might reveal that this customer is saturated on the relevant titles available in the particular outlet he frequents, and/or that the inventory of action/adventure genre DVDs in that store is low. Churn management engine 119 analyzes these data together to further analyze the pattern and infers that a dearth of inventory in the genre this customer prefers may be a cause of his dissatisfaction (e.g., his apparent likelihood not to renew his subscription). This may trigger an examination of profiles of other customers, with profiles similar to the exemplary customer.

Churn management engine 119 operates via software bus 195 with marketing engine 17 to generate a corresponding plan to ameliorate the exemplary customer's satisfaction level (e.g., acts to reduce the likelihood of cancellation). Using the analysis provided by churn management engine 119 and/or other information retrieved from the databases or elsewhere, marketing engine 17 analyzes histories of similar patterns and infers which remedies are effective to reduce the likelihood of churn (e.g., subscription cancellation).

Marketing engine 17 may thus operate via software bus 195 with account management module 175, which incorporates a billing engine functionality, to provide some incentive to the exemplary customer to remain a subscribing customer (e.g., not allow his subscription to lapse). For instance, a call from marketing engine 17 might trigger billing engine 115 to provide a free term of subscription renewal, a discount coupon, a free or discounted special attraction directed to Arnold Schwarzenegger fans, or another premium to the customer, in an effort to raise her satisfaction level and thus reduce her potential to churn.

Marketing engine 17 and/or churn management engine 119 might infer that increasing the inventory in the genre preferred by a customer might reduce her likelihood to churn. Thus, marketing engine 17 and/or churn management engine 119 operate via software bus 195 with store manager module 166 to bolster or replenish the available inventory in this genre by procurement or inventory transfer actions.

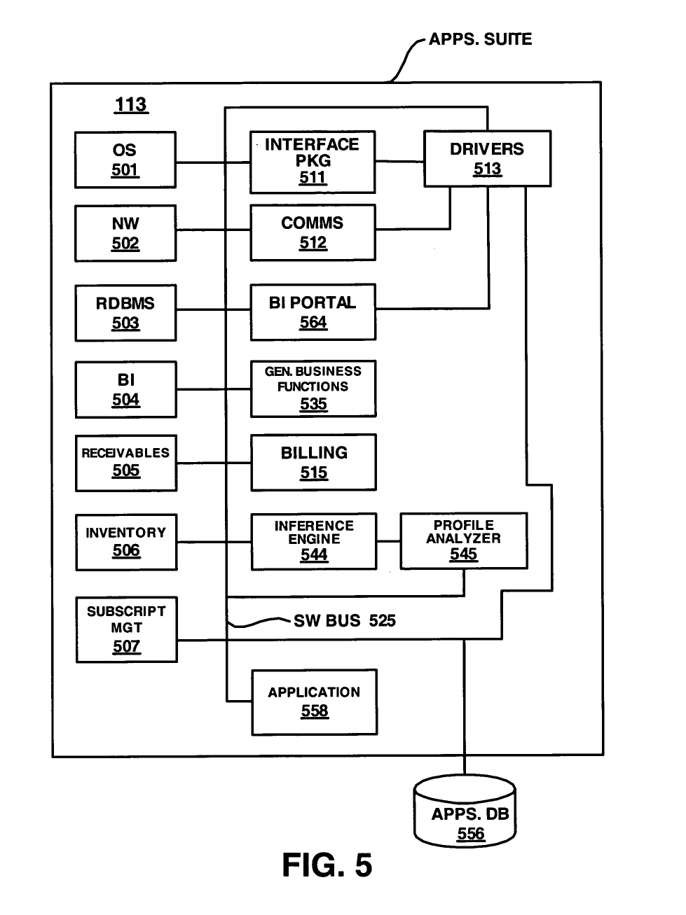

An applications suite 113 provides a variety of programs useful to the operation of system 100 in its functions and operation, in one embodiment via software bus 195. For instance, applications suite 113 may combine a general comprehensive business software package handling receivables, inventory control, contracts management, and the like, or a business software package specially tailored to operating a multimedia marketing system, with an operating system (OS), a networking functionality, drivers, and other programs or software (e.g., OS 501, networking module 502, drivers 513, and other elements; FIG. 5). In one embodiment, applications suite 113 can be loaded onto system master controller 182, account management module 175, and/or another component of system 100.

Various components, subsystems, and modules of system 100 can operate with a networking function, which can be inherent in their character, or in one embodiment, be provided via software bus 195 through a dedicated networking module 127. Networking module 127 allows system 100 to interface with network 14. Through network 14, system 100 can access BI information source 141, which can provide BI information relevant (e.g., significant) to the function of a multimedia operation.

Intelligent infrastructure 100 takes inputs from a detector 101. Detector 101 detects the presence, proximity, position, presentation, or some other aspect characteristic of a device 151. In one embodiment, device 151 comprises a radio frequency identification (RFID) tag. Device 151 stores identification data that can comprise a variety of information. Detector 101 wirelessly reads the identification data of device 151 (and can power the device), such as by a radio frequency (RF) interaction. The reading of device 151 by detector 101 effectuates a data collection ability for intelligent infrastructure 101. Further, system 100 can update device 151 with new or fresh information at any time, for instance by writing data to the device using the detector 101 (which thus functions as a reader/writer). In other embodiments, device 151 comprises a type of electronic tag, electronic label, code plate, or transponder, which can include (but is not limited to) RFID devices.

In one embodiment, a device 151 is provided in (e.g., or on) a media products, such as the case of rental DVDs and includes information relating to those media products, including (but not limited to) titles, stars, genre, subgenre classifications (to any level of granularity desired by or useful to system 100), and profile information relating to customers renting or otherwise accessing the media. In one embodiment, device 151 comprises a feature of a unique customer identity card 22 and encodes a unique customer number relating to the customer to whom it was issued, as well as information relating to that customer, such as profile information, identification data, and account status.

An intelligent media product return receptacle apparatus 129 such as a smart drop box can incorporate a secure structure that allows a media product to be returned by a customer yet deters removal of the product by anyone except an authorized operator of system 100 or a component thereof, such as personnel at intelligent infrastructure 11. Further, intelligent media product return apparatus 129 uses a reader/writer 101 to automatically (e.g., via store manager module 166) log the return of an RFID tagged multimedia inventory item, updates (e.g., via software bus 195) inventory database 107 and notifies outlet personnel as well as inquiring customers (or customers to whom the returned multimedia product will be recommended) as to its returned status. Advantageously, this feature can deter theft of returned items by employees. Further, upon return, reader/writer 101 can automatically reactivate an anti-theft bit or other security feature on the RFID or other tag associated with the multimedia inventory item.

In one embodiment, an on-line multimedia module 121 operates with networking module 127 to allow a remote client computer 15, such as a customer's personal computer (PC) to access an on-line source 16 of multimedia products, such as an on-line source of downloadable music, via network 14. A customer can access system 100 via network 14 by, for example, presenting a unique customer card 22 to a remote reader 137 (which can incorporate technology similar to device 101), which is communicatively coupled to a remote client computer 15.

On-line multimedia module 121 responsively links client computer 15 to on-line multimedia source 16 via network 14. The customer can then download multimedia products, such as music (e.g., songs in MP3 format) directly from the source 16. However, in one embodiment, components of system 100, such as billing engine 115 (or e.g., another component of account management module 175) handles the billing for the on-line multimedia purchase according to terms of the customer's subscription. In one embodiment, this can involve the operation of an application such as a contract administration application, which can be included in applications suite 113.

Exemplary Features

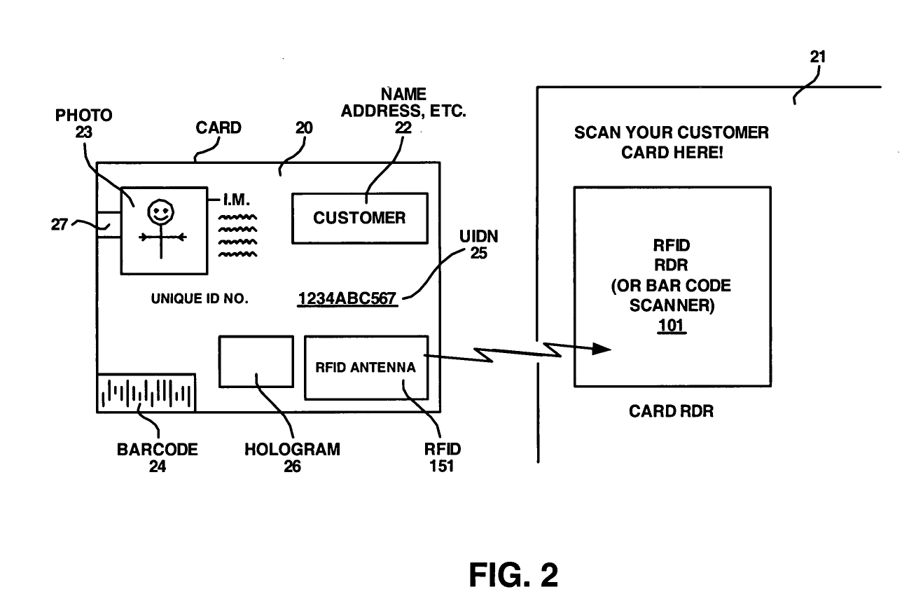

FIG. 2 depicts an exemplary unique data bearing customer identifier card 20, according to one embodiment of the present invention. Customer identifier card 22 can display a variety of textual and graphical information. For instance, customer identifier card 20 can display a field 22 that bears the customer's name, address, telephone number, and other such information. Identifier card 20 can also include a photograph 23 of the customer. Further, card 22 displays a unique customer identification number 25.

Unique customer identifier (e.g., a unique identification number) 25 is a number that uniquely identifies a particular customer to a system for operating an intelligent multimedia rental operation (e.g., systems 10, 100; FIG. 1A, 1B). In one embodiment, the system for operating an intelligent multimedia rental operation uses unique identifier 25 to identify, log, monitor, track, profile, bill, manage the account, and otherwise relate to or with the customer. Unique identifier 25 thus corresponds uniquely to a particular customer and relates a variety of information, obtained for instance from various databases (e.g., profile database 109, account database 123; FIG. 1B) to that customer.

Unique identifier 25 is coded upon (e.g., or within) customer identity card 20 for use by a system for operating an intelligent multimedia rental operation. Other information can also be so coded, including for example name/address field 22, photograph 23, account data, profile information, historical data, such as multimedia rental history, and the like. These data can be coded upon customer identity card 20 by a variety (e.g., and/or a plurality) of mechanisms.

In one embodiment, the information is coded upon an RFID device 151 or a similar type of electronic tag, such as an electronic label, code plate, or transponder, which is integrated with (e.g., or mounted within or upon) customer identity card 20. Such data can also be encoded within a barcode field 24, a magnetic strip 27 (e.g., or another magnetically encoded feature), and/or a holographic field 26. In one embodiment, holographic field 26 provides an anti-forgery or anti-counterfeit function for customer identity card 20. Such security features can also be provided by the other encoding mechanisms described herein.

In one embodiment, the data encoded upon customer identity card 20 is wirelessly read by a detector 101 (which can also so power the transponder function inherent in RFID device 151 within the card 20). Detector 101 makes the data read there from available to the system for operating an intelligent multimedia rental operation. For instance, as a customer approaches the entrance to an outlet for multimedia products (e.g., multimedia outlet 9; FIG. 1A) a scanner 21 is accessible there, for instance, mounted at an entrance thereof or at a kiosk therein.

Although in one embodiment the multimedia product outlet can be entered without scanning a customer identity card (e.g., to allow potential customers to browse therein), a customer can register her or his entrance with the system for operating an intelligent multimedia rental operation. Such registration can allow the intelligent infrastructure (e.g., intelligent infrastructure 11; FIG. 1B) to log the customer's presence. The system can then provide the customer with information (e.g., on monitors or at the kiosk), alert system personnel to the customer's presence, and/or proceed to monitor the customer therein for profiling.

Customers can register at the multimedia product outlet by presenting their customer identification cards 20 to the scanner 21. An RFID reader 101 component of (e.g., mounted within) scanner 21 wirelessly reads the RFID device 151 component of customer identity card 20 and logs the customer into the system for providing an intelligent multimedia rental operation, which begins to monitor the customer. In one embodiment, the system for providing an intelligent multimedia rental operation can then update the information encoded upon RFID device 151 of customer identity card 20. Thus, in the present embodiment, RFID reader 101 functions to write to the RFID device 151 of card 20, as well as read there from.

In one embodiment, customer identification card 20 functions as a financial transaction enabling card, bank card, automatic teller machine (ATM) card, debit card, credit card, or the like. Information to enable this feature is added to magnetically encoded and readable strip 27, and card 20 is otherwise configured so as to allow its use for effectuating financial transactions. In one embodiment, the intelligent multimedia marketing system (e.g., systems 10, 100; FIG. 1A, 1B) can network with a financial institution or other such source of finances to provide financial and credit related services.

In one embodiment, the intelligent multimedia marketing system functions with customer identification card 20 to allow a customer to conduct cashless one-step check-out transactions via RFID reader 101 and account management module 175, based for instance upon a subscription relationship with the intelligent multimedia marketing system, managed by an account management module and/or a subscription management application (e.g., account management module 175, subscription management application 517; FIG. 1B, FIG. 5). In one embodiment, coupons are encoded onto customer card 20, such as upon logging into a reader (e.g., reader/writer) 101 at a related multimedia outlet or a reader/writer 137 communicatively coupled to a remote computer 15 used by a customer (FIG. 1B).

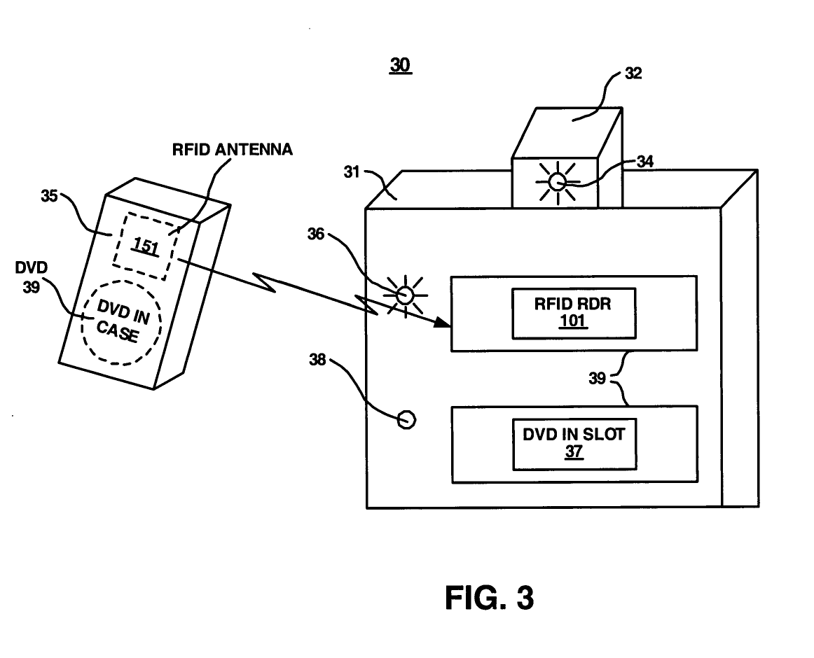

In one embodiment, an RFID (e.g., or a similar device) is used to monitor inventory. FIG. 3 depicts an exemplary data bearing multimedia case 35 and slot 39, according to one embodiment of the present invention. Data bearing multimedia case 35 comprises a case for a DVD or other medium. Mounted within (e.g., or affixed upon) data bearing multimedia case 35, there is an RFID device 151 or a similar type of electronic tag, such as an electronic label, code plate, or transponder. Information is encoded within RFID device 151. Alternatively, in one embodiment, RFID device 151 can be mounted directly upon the media platform 39 (e.g., affixed to the top of a DVD itself; and counterbalanced if necessary).

The information encoded within (e.g., or upon) RFID device 151 can comprise inventory control data such as a unique inventory identifier. The information encoded within RFID device 151 can also comprise data relating to the media product encased within case 35. For instance, the data can relate to the title and a description or summary of the media content, library, copyright, and/or publication related information, stars of a production comprising the media content, producers, studios, genre, subgenre (at any level of granularity desired), its procurement and rental history, characteristic profiles of customers renting the media, and anti-theft bit (or similar security data), related-related (e.g., by profiles) media references, and other aspects.

In one embodiment, this information are transferred to or stored in components of a system for providing an intelligent multimedia rental operation. For instance, the information can be stored in a database and/or used for inventory management, control, and security system. A detector 101 (e.g., an RFID reader) detects the proximity of device 151 when media case 35 is housed for display, for instance in a slot, port, or other such housing in a rack 31 (or e.g., a cabinet, shelf structure, or other such structure). When media case 35 is present in slot 31, detector 101 senses the proximity of the device 151 of case 35. Thus, the system for providing multimedia marketing operations can infer the presence of the inventory item corresponding to multimedia product 39 within its outlet (e.g., multimedia outlet 9; FIG. 1A).

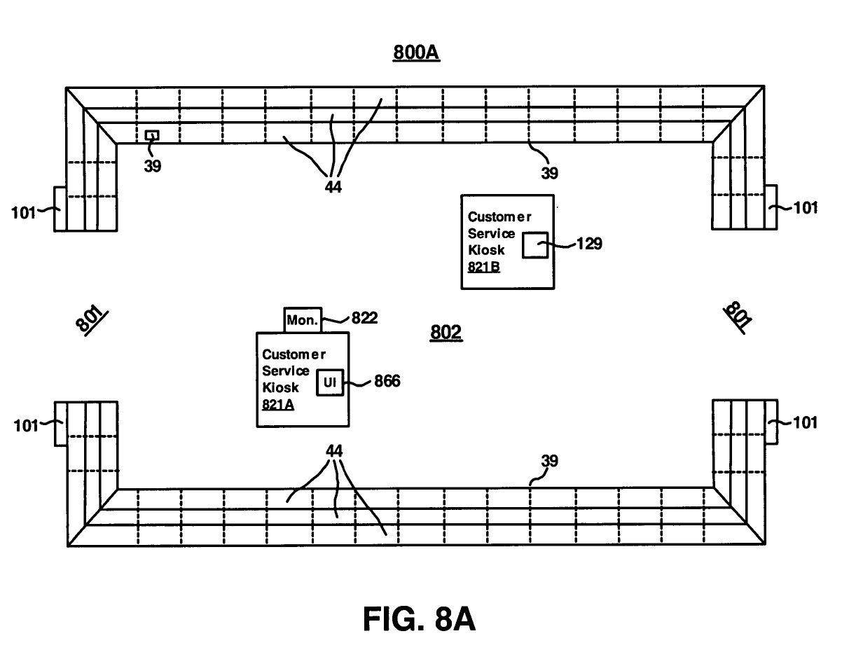

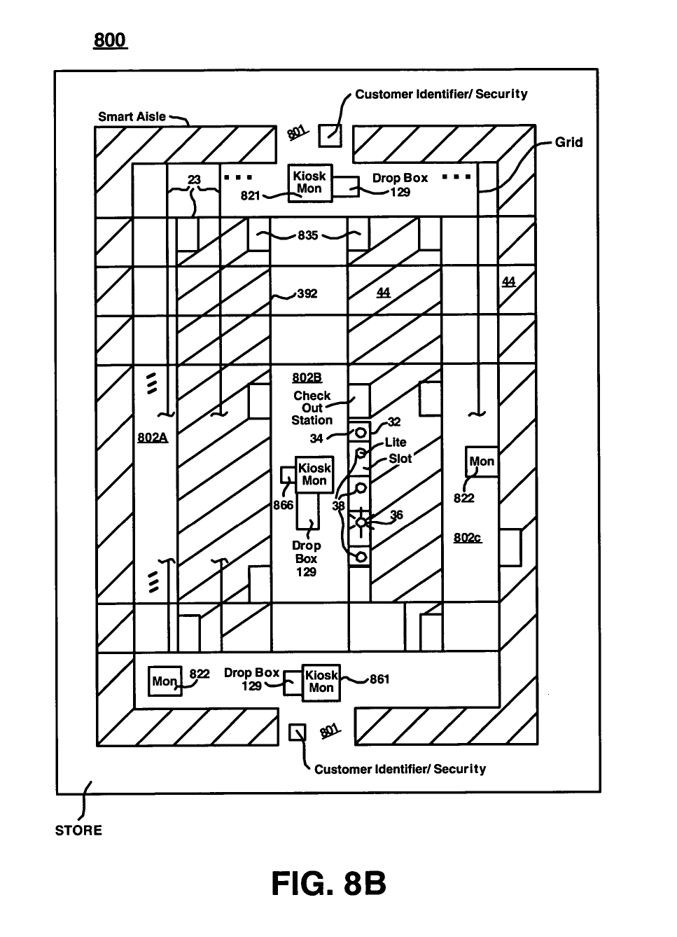

A light 36, such as an LED, can be lit by the system for providing multimedia marketing operations to mark the appropriate slot 39 for housing a particular inventory item, such as case 35 (e.g., containing multimedia product 39). Thus, in one embodiment, light 36 is used as a guide or beacon for system personnel for reshelving a multimedia product item 35/39 upon its return from a rental, restocking a product upon its sale or loss, or reassignment of a slot 39, etc. A light 34, such as that within a beacon 32, can be lit by the system for providing multimedia marketing operations to guide system personnel to the general area of where multimedia product item 35/39 is to be reshelved. In one embodiment, light 36 and beacon 32 is used in a similar way, so as to guide a customer seeking a particular product, for instance, in response to a query made to an automated kiosk (e.g., kiosk 821; FIG. 8A, 8B), or by direct action of an automated or human attendant. Where a slot 39 has a multimedia product 37 (e.g., in a case) stored therein, the light 38 is not lit. To guide someone to that product 37, light 38 and beacon 34 can be lit.

Exemplary Intelligent Infrastructure for a Multimedia Outlet

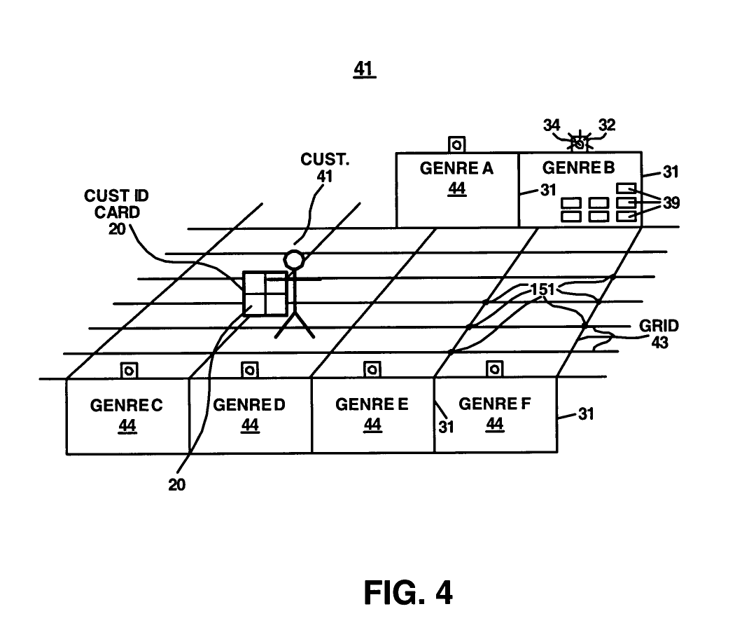

FIG. 4 depicts an exemplary intelligent infrastructure 11 in a multimedia outlet (e.g., multimedia outlet 9; FIG. 1A), according to one embodiment of the present invention. A customer 41 has a customer card 20 having an RFID device 151 or a similar type of electronic tag, such as an electronic label, code plate, or transponder. A grid 43 of RFID (e.g., or similar) detectors 101 is disposed throughout the intelligent infrastructure, for instance beneath a false floor, above a false ceiling, and/or disposed upon, behind, and/or within a rack 31 and/or other structures. Grid 43 (e.g., RFID detectors 101 comprising grid 43) can input information relating to the proximity of RFID devices 151 to intelligent infrastructure 11 or to a management entity (e.g., manager module 166; FIG. 1B) providing intelligence thereto.

As the customer 41 moves though the space defined by intelligent infrastructure 11, the customer's position changes with respect to grid 43. Thus, various detectors 101 comprising grid 43 have different and changing proximities relative to the RFID device 151 of the customer identity card 20 the customer carries. Thus, in the present embodiment, the location of the customer 41 within the multimedia outlet is inferred by intelligent infrastructure 11 determining the position of RFID device 151 of customer identity card 20 relative to grid 43. In one embodiment, this ability to infer the position of customer 151 can be used to track the customer within the multimedia outlet. Tracking information can be recorded (e.g., stored) for different customers 41, for example in a database (e.g., profile database 109; FIG. 1B).

Multimedia products are arranged, stored for instance within their cases (e.g., product 39, cases 35, 37; FIG. 3) in a plurality of assigned slots, ports, or other such housings in a rack 31 (or e.g., a cabinet, shelf structure, or other such structure). The location can be assigned to each multimedia product on the basis of a variety of attributes. For example, where the multimedia products comprise DVDs, they can be arranged according to genre (e.g., romance, comedy, action/adventure, educational, musical, etc.) in sections 44 of racks 31. Each genre can have a separate section, or where a genre is quite large, it can span multiple sections. Further, within each section, a genre can be split into multiple sub-genres (e.g., comedy-romance, musical-romance, action/adventure-romance-comedy, etc.), to any level of granularity desired.

In one embodiment, a shelf space is pre-assigned to a product prior to sending the product from, for instance, a central inventory management and/or storage facility, or from another multimedia product outlet, based on databased inventory information relating to that outlet. Advantageously, this can save labor and/or costs in deploying and/or arranging the product within a receiving multimedia product outlet.

The positioning of a particular multimedia product in a certain slot (e.g., slots 39; FIG. 3) within sections 44 of rack 31 can thus allow inventory management, such as detecting that a multimedia product is misplaced, for example, in an incorrect slot 39. In one embodiment, sections 44 comprise shelves deployed as an array of numbered rows and slots. In one embodiment, sections 44 and rack 31 contribute to the intelligence of infrastructure 11 by such detection. For instance, an inventory management feature is provided wherein the location of a misplaced multimedia product is ascertained and displayed to an attendant or an inquiring customer, a map or layout diagram f the multimedia outlet is displayed on a monitor, for instance at a customer service kiosk, and can be printed upon request for handy guidance. Lights 34 and beacons 36 can be used (and audio guidance, such as by speakers or tone generators as well).

In the present embodiment, the location of the customer 41 within the multimedia outlet is inferred by intelligent infrastructure 11 determining the position of RFID device 151 of customer identity card 20 relative to grid 43. Further, as a customer 41 handles a particular multimedia product, the handling is detected by the change in proximity of the RFID device 151 bearing multimedia product (e.g., or case) relative to the RFID detector 101 in its assigned slot 39. Such tracking and inventory handling data enables intelligent infrastructure 11 to infer how much time a particular customer 41 spends in any particular area therein, for example for a given genre, and which media products the customer peruses, examines, and/or inspects. Thus, a system for conducting intelligent multimedia marketing operations (e.g., systems 10, 100; FIG. 1A, 1B, respectively) can, by studying such tracking and inventory data, infer an interest level in a particular genre. These data can also comprise components of a profile that the system can generate for any customer 41.

These data can be dynamic and historically comparable. Thus, they can allow a profile generated for customer 41 to be updated. Further, by combining these data with other information, the system can infer other information, such as other profile information and rental and/or retail behavior of that customer. For instance, the system can infer inventory saturation for that customer and/or a low customer satisfaction level. Where customer 41 spends significant time in a particular area 44 and/or handles significant numbers of DVDs from a genre that a customer profile (e.g., profile 2002; FIG. 20) corresponding to the customer indicates has significant interest to that customer, yet without renting or buying a DVD, the system can infer a low satisfaction for that experience.

Exemplary Applications Suite

FIG. 5 depicts an exemplary applications suite 113, according to one embodiment of the present invention. Applications suite 113 comprises an applications software bus 525 or another programming interface that allows other component application software modules to efficiently transfer data one to another. In an alternative embodiment, various applications of applications suite 113 operate directly, one with another. In one embodiment, the function of software bus 525 is performed by another entity, such as software bus 195 (FIG. 1B).

In one embodiment, the functionality depicted in FIG. 5 of various applications herein can be combined in one application, and/or subsumed by another. For instance, in one embodiment, the functions of receivables application 505 and billing application 515 can be combined by subsuming one of the applications into the other. In another embodiment, the functions of receivables application 505 and billing application 515 can be combined into a general business functions application 535. In one embodiment, applications suite 113 is loaded onto system master controller 182, account management module 175, and/or another component of system 100 (FIG. 1B) or another intelligent multimedia marketing system.

Applications suite 113 provides a variety of applications useful to the operation of in its functions and operation. In one embodiment, applications suite 113 comprises a general comprehensive business software package that functions to handle receivables, control inventory, manage contracts, subscriptions, payroll, procurement, billing, payables, etc. In one embodiment, applications suite 113 comprises a business software package specially tailored to operating an intelligent multimedia marketing system.

In one embodiment, billing functions are handled by a billing application 515. In one embodiment, receivables functions are handled by a receivables application 505. In one embodiment, inventory management is handled by an inventory management application 506. In one embodiment, customer subscriptions are managed by a subscription management application 507. In one embodiment, various functions ascribed above to applications 515, 505, 506, and/or 507 are handled by a general business functions application 535, for instance as a backup or primary function, or subsumed in the operation thereof. In one embodiment, general business functions application 535 provides other functions, such as a spreadsheet program, a word processing program, a directory program, calendar, scheduling, time and appointment management, email, a Web browser, an electronic commerce and electronic banking function, and/or others.

An operating system (OS) 501 provides user interface, file management, job and task management, device and data management, and security related operations for other component applications comprising applications suite 113. A networking functionality 502 provides applications suite 113 with networking capability. In one embodiment, networking functionality 502 operates with a communications module 512 to allow a system deploying applications suite 113 to communicatively couple to another entity.

An interface package 511 provides user interface functions, such as a graphical user interface (GUI), a voice activated interface, an interface for allowing applications to read from and write to RFID or other data bearing devices, and others that allows the applications comprising applications suite 113 to interface with users and other entities. Drivers 513 allow applications to access external devices, such as databases (e.g., databases 107, 109, 123; FIG. 1B), printers, drives, etc.

A business intelligence (BI) application 514 allows users of an intelligent multimedia marketing operations system (e.g., systems 10, 100; FIG. 1A, 1B) to efficiently obtain enterprise-wide information. BI application 514 integrates various functions for the intelligent multimedia marketing operations system including on-line analytical processing (OLAP), querying, reporting, data mining, data warehousing, and other functions. In one embodiment, BI application 514 operates with BI portal 564 to query and report on enterprise-wide databases such as accounting database 123, inventory database 107, and profile database 109 (FIG. 1B).

BI application 504 finds, extracts, retrieves, and provides BI information including, in one embodiment, economic, financial, credit, business, logistical, and/or other data that can affect the pricing, availability, demand for, or production of any kind of entertainment, educational, music, video, or other multimedia products, services, related or other products and commodities, credit information, customer profiles and other customer information, and demographic, geographic, historical, political, social, and/or other information.

In one embodiment, applications suite 113 comprises an applications relational database management system (RDBMS) 503 to control the organization, indexing, storage, retrieval, security, and integrity of data stored in multiple databases, including for instance an applications database 556, profile database 109, inventory database 107, accounting database 123, and backup database 144 (FIG. 1B), and/or database 19 (FIG. 1A). RDBMS 503 allows access to and usage of this data by applications comprising suite 113. In one embodiment, the functionality of RDBMS 503 is subsumed in an RDBMS external to applications suite 113, such as RDBMS 117 (FIG. 1B).

In one embodiment, an inference engine 544 analyzes data from various sources, recognizes patterns and trends therein, and infers from them information useful to the efficient operations of an intelligent multimedia marketing system and reports them, directly to a management functionality (e.g., system master controller 182; FIG. 1B) or via the functioning of another application of suite 113. In one embodiment, a profile analyzer 545 functions with inference engine 544 to analyze profile related data, such as a customer profile (e.g., customer profile 2002; FIG. 20). Reports and reportlets generated by profile analyzer 545 and inference engine 544 are used by other applications of suite 113, such as subscription manager 507, and by other components of an intelligent multimedia marketing system (e.g., profile engine 13, churn management engine 119, marketing engine 17; FIG. 1B), such as for promoting customer satisfaction and concomitantly minimizing churn. Applications suite 113 can include an application 558 for providing another function desired for the operation of an intelligent multimedia marketing system.

Exemplary Operations Process

FIG. 6 is a flowchart of an exemplary computer implemented process 600 for operating an intelligent multimedia rental operation, according to one embodiment of the present invention. In one embodiment, process 600 is implemented by a computerized system for conducting intelligent multimedia marketing operations, such as systems 10 and 100 of FIGS. 1A and 1B, respectively.

Process 600 begins with step 601, wherein a customer is identified as arriving at an outlet for multimedia products (e.g., outlet 9; FIG. 1A), for instance, upon presenting a unique, coded, readable customer identification card to an input device for reading such cards (e.g., card 20, reader 101; FIG. 1B, 2), and extracting encoded information there from.

Upon identifying the customer, in step 602, a profile associated with that customer is checked. This profile can be accessed from a database (e.g., profile 2002, profile database 109; FIG. 20). In step 603, a recommendations list is generated for the customer of multimedia products the customer might be interested in, based on the profile and/or other information.

In step 604, the customer is monitored while within the intelligent infrastructure of a multimedia outlet (e.g., intelligent infrastructure 11; FIG. 1B, 4). In step 605, the customer's activity is analyzed as to position, movement, time in a particular section, examination of particular multimedia or other inventory items, whether a multimedia inventory item is checked out (and the identity thereof and other related information) or not, and other information.

In step 606, a level of customer satisfaction is inferred from this analysis. In step 607, the profile associated with this customer (e.g., customer profile 2002; FIG. 20) is updated to reflect this satisfaction level. In step 608, which can be performed in real time or upon stored data at any subsequent time, the updated profile associated with this customer is analyzed (e.g., by a profile engine 13 and/or a churn management engine 119; FIG. 1B), wherein the customer's current satisfaction level is read and the patterns of customer behavior in the multimedia outlet are sought.

From this analysis, in step 609, a value for the customer's satisfaction is ascertained. In step 610, it is determined whether this value falls below a setpoint value. The setpoint value in one embodiment corresponds to a threshold value at or below which there is a significant probability, for instance, it is more probable than not, that a customer will allow their subscription to lapse (e.g., not renew their subscription. If not, process 600 can be complete for a particular customer at that time.

If it is determined that the customer's satisfaction value falls below a threshold, then in step 611, a churn managing entity (e.g., churn management engine 119; FIG. 1B) is notified. In step 612, action is taken to reduce the probability that the customer will let their subscription lapse (e.g., to manage churn). In step 613, it is determined, for instance from the information gathered in performing steps 602, 604, and 605 and information relating to the inventory of the multimedia outlet used by the customer (e.g., from inventory database 107), whether an inventory characteristic is contributing to the customer's satisfaction value falling below the threshold value.

For example, the customer's profile might reveal that the customer is a female of a socio-economic-demographic background and displaying patterns indicating that she prefers to rent DVDs in the action/adventure genre, in a barbarian ancient fantasy sub-genre. Inventory analysis reveals that this customer has saturated on the inventory within this genre at this multi-media outlet. In one embodiment, such information can be inferred by the churn managing entity to contribute to the customer's suffering satisfaction value.

If it is determined that an inventory characteristic is contributing to the customer's low satisfaction value, then in step 616 action is taken to improve the inventory of the multimedia outlet frequented by the customer, such as by procuring new multimedia inventory items in the genre/sub-genre preferred by this customer, or transferring such items from another multimedia outlet. In performing step 616, an intelligent multimedia marketing system can take other factors into account, such as cost-effectiveness of changing inventory relative to retaining this particular customer's subscription. In step 617, the customer is notified, for instance by email, that the inventory of the multimedia outlet she frequents has been improved in relation to the genre/sub-genre she prefers.

If it is determined that an inventory characteristic is not contributing to the customer's low satisfaction value, then in step 614, an incentive is offered to the customer via a direct marketing route, which can include email. Incentives can include discounted merchandise, electronic or other coupons, cookies, coded premiums, or the like, free or subsidized admission to special events, such as live private chat time with a special star in the genre she prefers, reduced subscription renewal prices, or the like, and in any combinations. Step 614 can also be performed upon or in conjunction with performance of step 617. Thus, incentives can be provided where an inventory characteristic contributes to the customer's low satisfaction value.

In step 618, the customer is monitored. In step 619, it is determined whether the incentives are effective, for instance, by the customer continuing their subscription, and/or by displaying signs of increased satisfaction in subsequent visits to an associated multimedia outlet. For instance, if upon providing the incentive, the client continues their subscription, the incentives can be inferred to have worked. If not, then in step 620, another incentive is directed to the customer (and the original incentive can be assigned an inferior effectiveness rating relating to this customer). If the incentives are inferred to be effective, then in step 621, the account, subscription, and profile information corresponding to this customer are updated (and the original incentive can be assigned an superior effectiveness rating relating to this customer), completing process 600.

Exemplary Network Environment

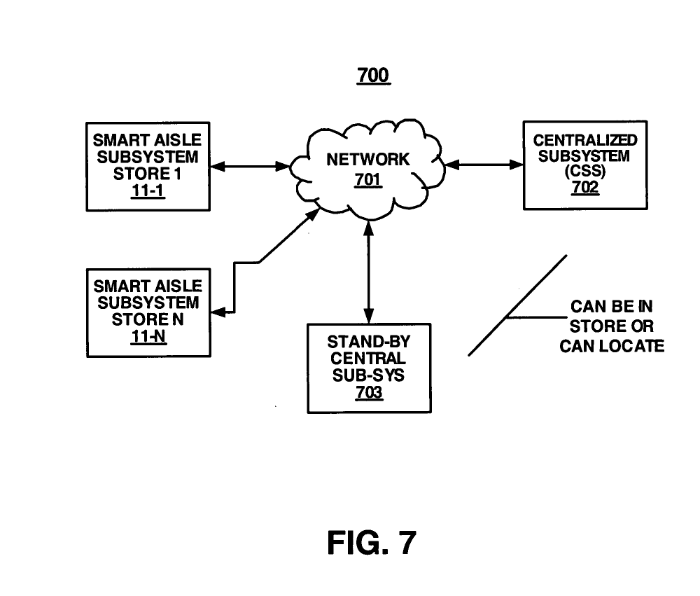

FIG. 7 depicts an exemplary network environment 700, according to one embodiment of the present invention. Network environment 700, in one embodiment, communicatively intercouples the intelligent infrastructures 11.1 through 11.N of a plurality of associated multimedia outlets for the exchange of data and other information via a network 701. Network 701 comprises a private or public network, a virtual private network (VPN), a wide area network (WAN), and/or the Internet.

Network 701 intercouples intelligent infrastructures 11.1-11.N with a centralized subsystem 702, and in one embodiment, with a standby or backup centralized subsystem 703. Centralized subsystems 702 and 703 combine components of an intelligent multimedia marketing system (e.g., systems 10, 100; FIG. 1A, 1B) for efficient control and/or backup of local operations of intelligent infrastructures 11.1-11.N.

In one embodiment, centralized subsystems 702 and 703 provide inventory management, for instance, allowing pre-shelving multimedia products (e.g., shrink-wrapped and pre-positioned) for rapid deployment, and allowing rapid setup of new multimedia product outlets.

Thus, in one embodiment, centralized subsystems 702 and 703 comprise control, management, data storage, analysis engines, and the like (e.g., manager module 166, master controller 182, engines 13, 17, 119, and/or databases 107, 109, 123, and 144; FIG. 1B). In one embodiment, centralized subsystems 702 and 703 are deployed at separate multimedia outlets (e.g., outlet 9; FIG. 1A) or at another location.

Exemplary Multimedia Outlet Layouts

FIG. 8A depicts one exemplary intelligent multimedia outlet layout 800A, according to one embodiment of the present invention. Intelligent multimedia outlet layout 800A is deployed within a multimedia outlet enclosure 9, which can comprise a separate structure, a store-like compartment within a mall or shopping center, a dedicated space or structure within a larger structure such as a supermarket, retail store, warehouse style store, etc. Intelligent multimedia outlet layout 800A comprises an entrance 801, which can be a portal such as an opening, a door, a gate, etc., and an inner space 802.

In one embodiment, outlet 800A can be rapidly deployed and set up, for instance, within an existing store, warehouse, or another facility, of any size or arrangement, advantageously using pre-shelved (e.g., shrink-wrapped and pre-arranged) multimedia products, under the control of a centralized entity (e.g., centralized subsystem 702; FIG. 7).

A rack 31 of shelves 44 house multimedia products and other inventory items within monitored slots 39. A detector 101 allows subscribing customers to register their presence using a customer identity card having an RFID or other device (e.g., card 20, RFID device 151; FIG. 2). Detector 101 also detects RFID or other devices placed on multimedia products (e.g., device 151, multimedia product 35, 39; FIG. 3), and thus detects unaccounted for removal of inventory to provide a security (e.g., theft deterrence or prevention) and inventory control function.

Customer service kiosks 821A and 821B provide services to customers including interactive information exchange, inventory item checkout and check in, locations of and directions to particular inventory items, communication with customer service representatives, printing of informative and rental/retail related matter, and others. A monitor 822 displays information to a customer.

A user interface such as a GUI, voice activated interface, touch screen interface, or the like allows a customer to interact with an intelligent multimedia marketing system. An intelligent inventory item return mechanism, such as a smart drop box, allows a customer to quickly and securely return items, updates an inventory database (e.g., inventory database 107; FIG. 1B), and informs an attendant or an inquiring other customer that a particular inventory item has been returned.

FIG. 8B depicts another exemplary intelligent multimedia outlet layout 800B, according to one embodiment of the present invention. Intelligent multimedia outlet layout 800B is deployed within a multimedia outlet enclosure 9. Intelligent multimedia outlet layout 800B comprises an entrance 801, which can be a portal such as an opening, a door, a gate, etc., and an inner space divided into a plurality of aisles 802A, 802B, and 802C. An office 803 is provided for attendants. In one embodiment, a component of intelligent multimedia marketing system 100B is located within layout 800B, for example within or proximate to office 803.

A grid 43 of RFID (e.g., or similar) detectors 101 is disposed through layout 800B. The detectors 101 comprising grid 43 are disposed for instance beneath a false floor, above a false ceiling, and/or disposed upon, behind, and/or within a rack 31 and/or other structures. The RFID detectors 101 grid 43 input information relating to the proximity of RFID devices 151 to components of an intelligent infrastructure (e.g., intelligent infrastructure 11; FIG. 1B, 4), or to a management entity (e.g., manager module 166; FIG. 1B). Thus, customers carrying customer identification cards having an RFID device therein can be tracked as they move about within aisles 802A, 8002B, and 802C. RFID or other detectors within grid 43 and associated with rack 31 and shelves 44 can register, locate, and track inventory items bearing RFID devices.

Beacons 32 and slot lights 36 provide guidance to a customer seeking a particular multimedia item within layout 800B. Using a user interface 866 at a kiosk 821 for instance, a customer can input the title or another attribute of the item to the intelligent multimedia marketing system 100B. A monitor 822 at the kiosk 821 (or other monitors 822 through layout 800B) provide the customer with a diagram of layout 800B, mapping a route therein to the item. A map the customer can take can also be printed at kiosk 821. System 100B lights the beacon 32 and slot light 36, in one embodiment flashing the lights, to lead the customer to the item. Such maps and lighting techniques also provide reshelving guidance and other inventory control features, such as drawing attention to an incorrectly placed item.

A plurality of checkout stations 835 are situated through layout 800B. Checkout stations 835 incorporate an RFID or other detector 101 and read RFID or other devices in customer identification cards and inventory items. In one embodiment, checkout stations are communicatively coupled with components of intelligent multimedia marketing system 100B such as a retail processor, a controller, and/or an account manager (e.g., retail process engine 12, system master controller 182, account module 175; FIG. 1B). Thus, the intelligent multimedia marketing system allows a customer to conduct a one-stop, one-step, cashless transaction wherein multimedia inventory items are checked out according to the customer's subscription arrangement, or purchased with billing through the subscription.

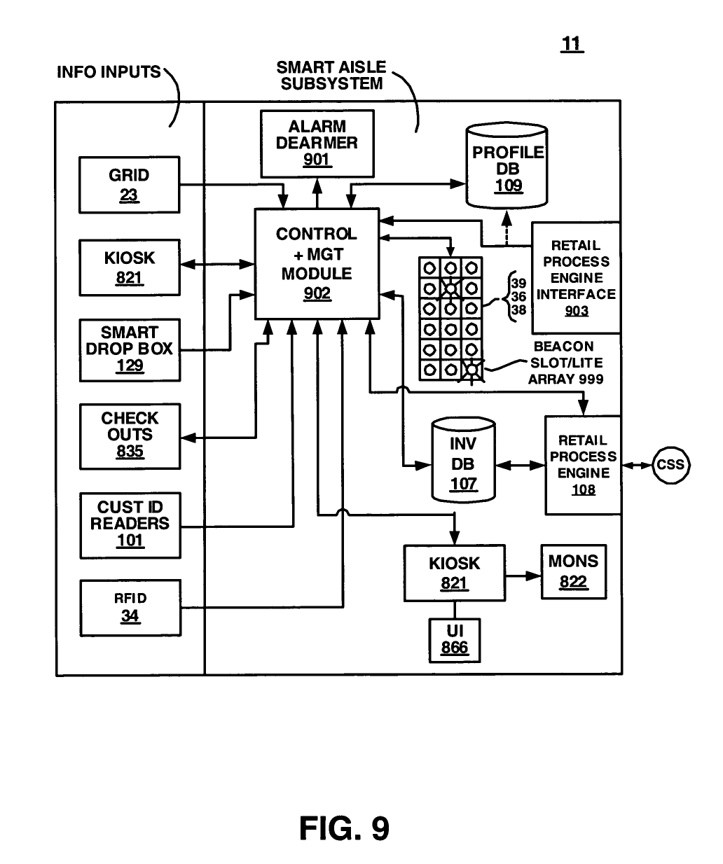

FIG. 9 depicts an exemplary intelligent infrastructure subsystem 11, according to one embodiment of the present invention. In one embodiment, intelligent infrastructure 11 comprises a subsystem of an intelligent multimedia marketing system (e.g., system 10, 100; FIG. 1A, 1B). A control and management module 902 receives inputs from grid 23 (e.g., from RFID or other detectors comprising the grid), from customer service kiosk 821, smart drop box 129, checkout stations 835, RFID detectors 101, and RFID devices 34 (within slots 39; FIG. 3).

Control and management module 902 controls an array of beacons 32 and lights 36 and 38 so as to guide customers seeking and attendants restocking or reshelving a particular media item. Control and management module 902 controls a security disarmer 901, so as to deactivate a security feature, such as an anti-theft bit programmed into an RFID device on an inventory item upon a checkout transaction thereof. Control and management module 902 stores data in profile database 109 and inventory database 107, which in one embodiment are remote from intelligent infrastructure subsystem 11. Inventory database 107 provides data to retail process engine 103. Kiosk 821 displays information on monitors 822 and receives information from a user interface 866.

In one embodiment, retail process engine 103 comprises a component of intelligent infrastructure subsystem 11 and operates with control and management module 902 to track and control multimedia rental and retail transactions, report information relating to the transaction to and retrieve information for the transaction from a remote centralized subsystem 702. In another embodiment, retail process engine 103 comprises a component of remote centralized substation 702, and the control and management module 902 interacts with the retail process engine via an interface 903. In alternative embodiments, the functions of control and management module 902 are subsumed in the function of retail process engine 103 and vice versa.

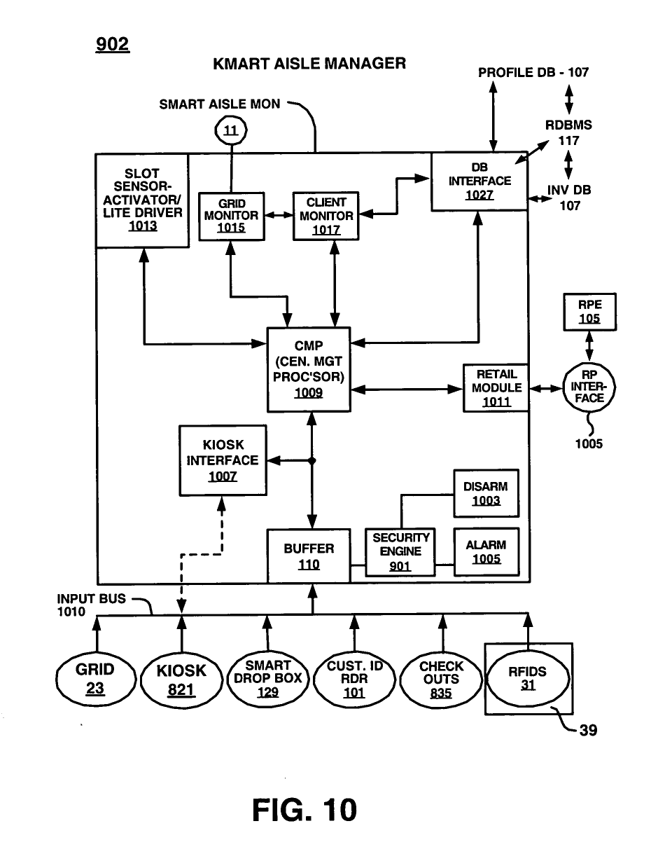

FIG. 10 depicts an exemplary control and management module 902, according to one embodiment of the present invention. A central management processor (CMP) 1009 receives input through an input/output (I/O) buffer 1001 via an input bus 1010 from grid 23, kiosk 821, smart drop box 129, RFID detector 101, checkout stations 835, and RFID detectors 151 in slots 39. CMP 1009 controls a security engine 901 via I/O buffer 1001 so as to disarm a security feature 1003 or fire an alarm 1005 upon removal of an inventory item that has not been checked out.

A slot sensor activator and light driver 1013 is controlled by CMP 1009 for providing customer guidance and inventory control activities such as reshelving of returned items and locating and replacing incorrectly shelved items. CMP 1009 interacts with RDBMS 117, profile database 109, and inventory database 107 via a database interface 1027. CMP 1009 provides control over a retail process engine 103 through retail/rental module 1011, via a retail process interface 1005. CMP 1009 monitors the grid of an intelligent infrastructure 11 through grid monitor module 1015. Further, CMP 1009 monitors a customer through a customer monitor module 1017, which operates with grid monitor 1015. Customer monitor module 1017 can store customer profile information in profile database 109 via database interface 1027.

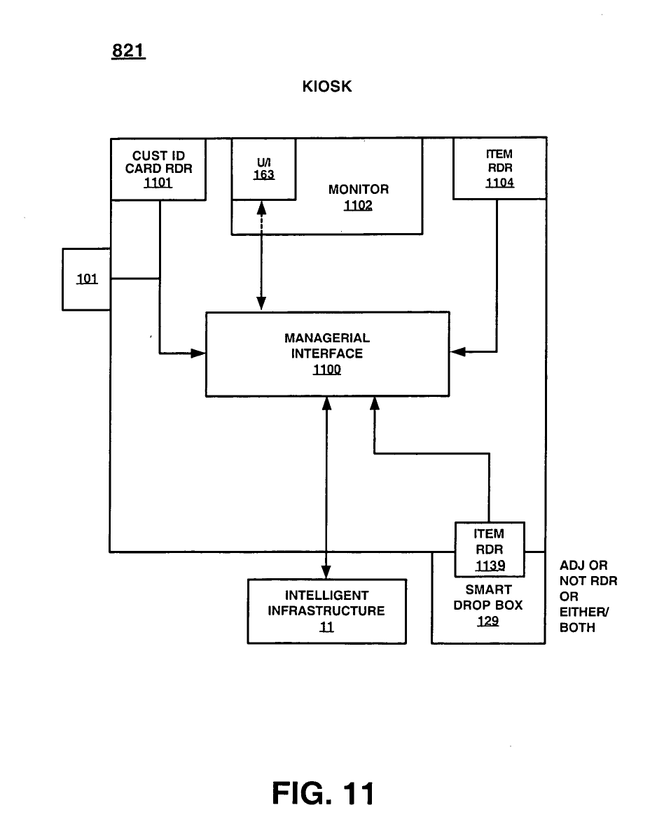

FIG. 11 depicts an exemplary intelligent multimedia outlet kiosk 821, according to one embodiment of the present invention. Kiosk 821 comprises a managerial interface 1100, communicatively coupled with an intelligent infrastructure 11 to receive information and instruction there from. A monitor 1102 displays information under control of managerial interface 1100. A user interface 1103 allows information, requests, prompts, queries, and the like to be inputted. In one embodiment, user interface 1103 comprises a GUI. In one embodiment, user interface 1103 comprises a touch screen interface. Thus, a functional aspect of user interface 1103 can be subsumed in or performed by monitor 1102. In one embodiment, user interface 1101 is voice activated.

Kiosk 821 has a detector/reader/writer 101 of RFID or other devices, such as for reading from or writing to a customer identity card or an inventory tag (e.g., card 20, tag 151; FIG. 2, 3). In one embodiment, a dedicated customer card reader/writer 1101 is provided. In one embodiment, a dedicated inventory item reader/writer 1104 is provided. In another embodiment, the functions of reader/writers 1101 and 1104 are combined in a device. Thus, kiosk 821 can serve to log customers into intelligent infrastructure 11 of a multimedia product outlet and to update their customer identification cards with fresh data, premiums, and the like, as well as to allow customers to check items out. Separate checkout stations, for instance with a monitor, can be located remote from the kiosk at any position within a multimedia outlet, yet be communicatively coupled to and controlled by (or e.g., through) kiosk 821.

An intelligent media product return apparatus (e.g., a smart drop box) 129 is communicatively coupled to kiosk 821. Smart drop box 129 can comprise part of kiosk 821 or can comprise a structure adjacent to or separated from kiosk 821. A smart drop box 129 can be remote from kiosk 821. For example, a smart drop box 129 can be deployed outside of a multimedia outlet (or e.g., a store having a multimedia outlet within it), so as to allow a customer to return an inventory item at any time, without having to enter.

Smart drop box 129 incorporates a secure structure that allows a media product to be returned by a customer, yet deters removal of the product by anyone except an authorized attendant of intelligent infrastructure 11. Further, intelligent media product return apparatus 129 uses a reader/writer 1139 to automatically, via managerial interface 1100, log the return of an RFID tagged multimedia inventory item, update an inventory database (e.g., database 107; FIG. 1B) and notifies outlet personnel as well as inquiring customers (or customers to whom the returned multimedia product will be recommended) as to its returned status, e.g., on monitor 1102. Advantageously, this feature can deter theft of returned items by employees. Further, upon return, reader/writer 101 can automatically reactivate an anti-theft bit or other security feature on the RFID or other tag associated with the multimedia inventory item. In one embodiment, reader/writer 1139 serves as a reading station that identifies batches of inventory within (e.g., or removed by an attendant from) smart drop box 129, prints a restocking list and/or list/map and similarly informs a control/management module (e.g., module 902; FIG. 9) to control an array of lights and beacons to guide an attendant in efficiently restocking them.

Exemplary Processes

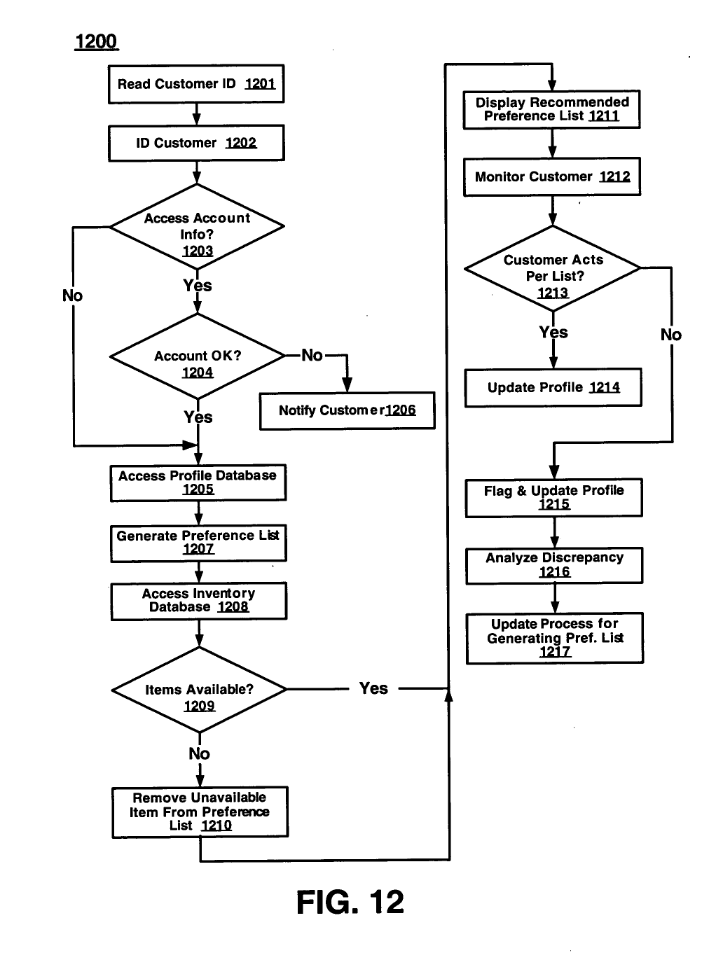

In embodiments of the present invention, an intelligent multimedia marketing system (e.g., systems 10, 100; FIG. 1A, 1B) performs a plurality of computer-based and/or computer-implemented processes. Examples of these processes (e.g., processes 1200-1800 and 2100-4100; FIGS. 12-18 and 21-41, respectively) are described below. Although specific steps are disclosed herein describing the operations of these processes, such steps are exemplary. That is, embodiments of the present invention are well suited to performing various other steps or variations of the steps and/or sequences of steps recited in the flowcharts herein. The exemplary computer based processes described herein are performed in one embodiment by a system for conducting intelligent multimedia marketing operations, such as system 10 of FIG. 1A and/or system 100 of FIG. 1B.

Exemplary Process for Identifying a Customer

FIG. 12 is a flowchart of an exemplary computer implemented process 1200 for identifying a customer, according to one embodiment of the present invention. Process 1200 begins with step 1201, wherein a customer logs in to a multimedia outlet associated with an intelligent multimedia marketing system. The customer can log in by scanning or otherwise presents a unique, coded customer identification card to a reader of such cards at a portal to the outlet, at an intelligent customer service kiosk therein, or elsewhere.

In step 1202, the intelligent multimedia marketing system identifies the customer. In step 1203, information is accessed relating to the customer, including account information. Process 1200 can include a step 1204, wherein the status of the customer's account is checked. In step 1205, it is determined whether the customer's account is clear. If not (e.g., there is a issue such as a problem with the account, a fee due, checked-out materials overdue, etc.), in step 1206 the customer is notified, for instance on a monitor at a kiosk.

In step 1207, profile information relating to the customer is accessed, for instance from a profile database. In step 1208, a list of multimedia products predicted from the customer's profile to comprise preferences tailored to that customer is generated, upon filtering out titles that the customer has already rented. In step 1208, the preference list is compared to an inventory database. In step 1209, it is determined whether the titles on the list are available in stock at the multimedia outlet.

Where it is determined that a title is currently unavailable at that outlet, in step 1210 that title is removed from the preference list. Where it is determined that the titles on the preference list are currently available at the multimedia outlet, in step 1211, the titles are displayed to the customer as recommendations on a monitor at a kiosk, and can be printed for that customer upon request. In step 1212, the customer is monitored while at the multimedia outlet. In step 1213, it is determined whether the customer acts in accordance with the recommendations.

If the customer acts in accordance with the recommendations, such as by renting or buying a recommended item, then in step 1214, the customer's profile is updated. If the customer does not act in accordance with the recommendations, for example, where the client does not rent a title from the recommendations list, then in step 1214, the customer's profile is updated and flagged for analysis. Upon flagging the customer's profile, the profile is analyzed to attempt to resolve the discrepancy between the preferences generated and the customer's behavior. In step 1219, the process by which the customer's preferences are determined is adjusted to account for the discrepancy, completing process 1200.

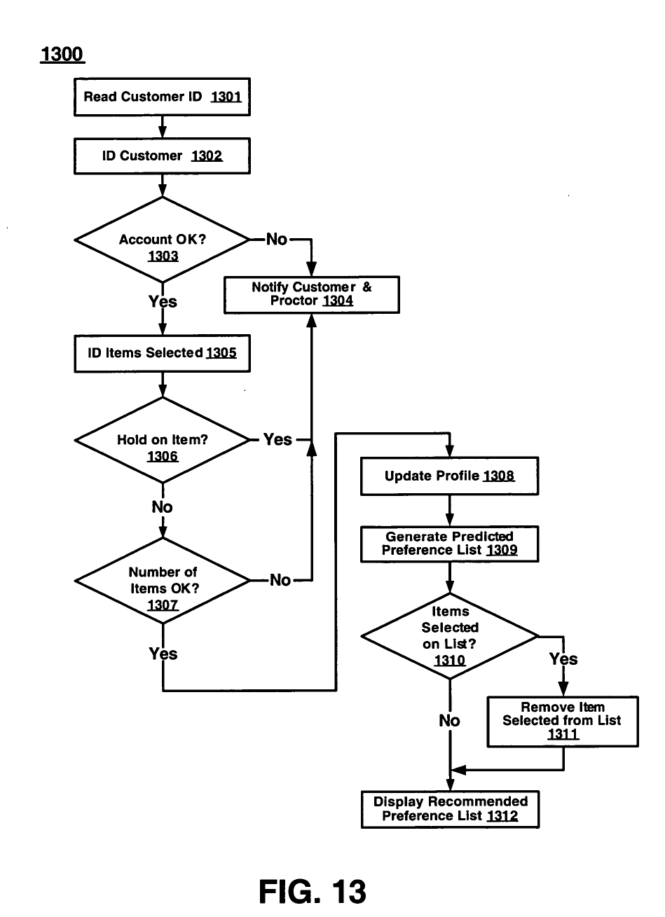

FIG. 13 is a flowchart of an exemplary computer implemented process 1300 for intelligently checking out multimedia items, according to one embodiment of the present invention. Process 1300 begins with step 1301, wherein a customer logs in to a multimedia outlet associated with an intelligent multimedia marketing system. In step 1302, the intelligent multimedia marketing system identifies the customer. In step 1303, it is determined whether the customer's account status is satisfactory. If not, in step 1304, the customer and/or an attendant are informed that there is an issue that needs to be addressed.

If the account status is satisfactory, then in step 1305, the multimedia or other items a customer has selected for checkout are identified, such as upon scanning into a reader of RFID or other tags marking them. In step 1306, it is determined whether any holds exist on that item. If so, the customer and/or an attendant are alerted in step 1304 that there is an issue that needs to be addressed. If not, then in step 1307, it is determined whether the number of items the customer desires to check out are satisfactory under the customer's subscription agreement.

This number can differ for various items. Newer hit movies on DVD for instance may comprise premium items, whereas older releases, certain documentaries, educational, foreign and art films on DVD may comprise regular or discount items. Premium items may have smaller allowable simultaneous checkout numbers than regular items, which may have smaller allowable simultaneous checkout numbers than discount items. If not, in step 1304, the customer and an attendant are informed that there is an issue that needs to be addressed.

If it is determined that the number of items the customer desires to check out are satisfactory, then in step 1308, the customer's profile is updated. In step 1309, the customer's profile is examined. In step 1310, it is determined whether an item the customer is checking out is on a recommendation/recommendation list corresponding to this customer, and a recording entity is notified. If so, then in step 1311, the item is removed from the recommendation/recommendation list. If not, or upon executing step 1311, in step 1312, the recommendation list is displayed to the customer, alerting the customer to other titles that may be of interest, and the customer profile is updated completing process 1300.

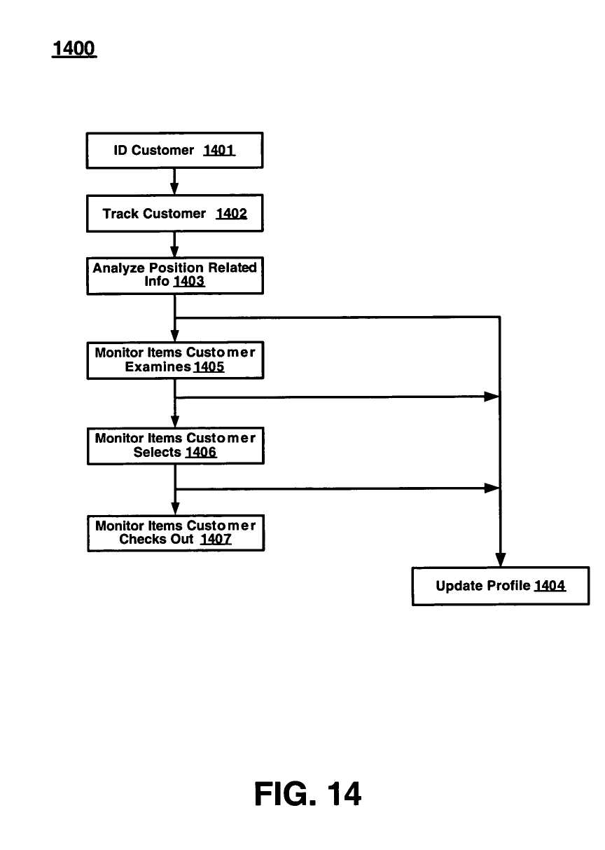

FIG. 14 is a flowchart of an exemplary computer implemented process 1400 for monitoring a customer, according to one embodiment of the present invention. Process 1400 begins with step 1401, wherein a customer is identified by an intelligent multimedia marketing system.

In step 1402, the customer is tracked while within the intelligent multimedia marketing system (or e.g., while accessing the intelligent multimedia marketing system remotely via a network, such as network 14 of FIG. 1, 2). For instance, the customer's movement and time in each area are tracked using RFID or other sensors arrayed in a grid (e.g., grid 43; FIG. 4) and the customer's handling (e.g., perusal) of stock items is monitored by similar sensors.

In step 1403, position related information relating to the customer is analyzed. For instance, significant time a customer spends in a certain area of a multimedia outlet relating to a particular genre or sub-genre (to any level of granularity) can be inferred to comprise browsing of items within that genre. In step 1404, the customer's profile is updated accordingly.

In step 1405, the inventory items that a customer picks up or handles (e.g., removes) from within their individually monitored slots are analyzed. For instance, it is inferred that a customer's handling of an item sufficient to allow an RFID or other sensor to detect the item's removal from its monitored storage slot comprises the examination, inspection, perusal, and/or browsing of the item by the customer. In step 1404, the customer's profile is updated accordingly.

In step 1406, the items a customer selects is monitored. In step 1404, the customer's profile is updated accordingly. In step 1407, items the customer checks out are monitored. In step 1404, the customer's profile is updated accordingly, completing process 1400.

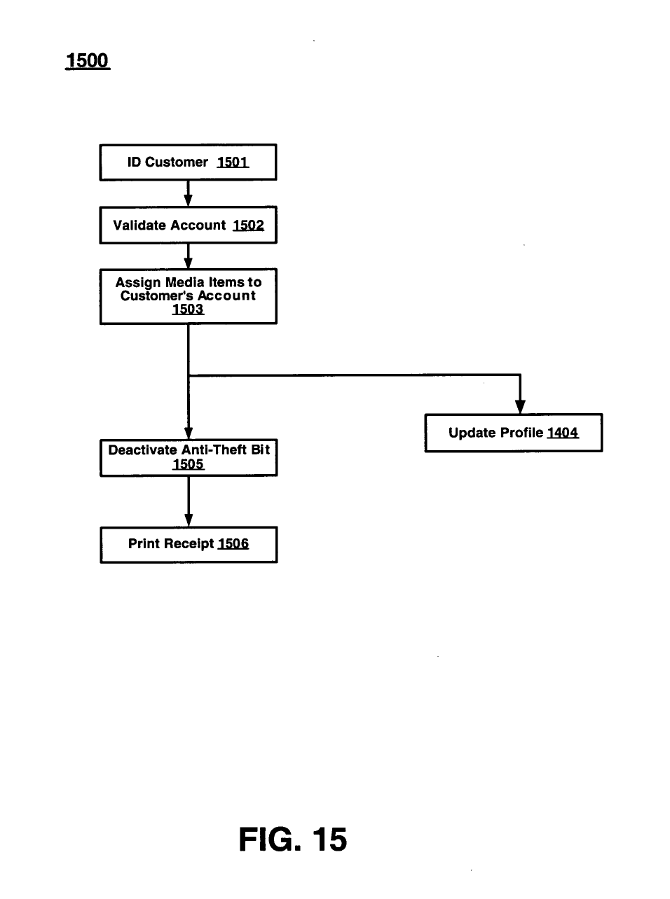

FIG. 15 is a flowchart of an exemplary computer implemented process 1500 for performing a simple non-cash transaction for checking out multimedia items, such as for rental, according to one embodiment of the present invention. Process 1500 begins with step 1501, wherein a customer is identified upon presenting a request to check out multimedia items to an intelligent multimedia marketing system, such as at a checkout station at a customer service kiosk or a separate checkout station within a multimedia outlet (e.g., item reader 1104, checkout station 835; FIG. 11, 8B, respectively).

In step 1502, the account corresponding to this customer is validated. Upon validating the account, in step 1503, the inventory items selected and presented for checkout are assigned to the customer's account. In step 1504, the customer's profile is updated to reflect checking out these particular multimedia items. In step 1505, a security countermeasure relating to this inventory item is belayed. For example, an anti-theft bit programmed into an RFID or other device associated with this multimedia inventory item is deactivated. In step 1506, a receipt is printed for the customer, completing process 1500.

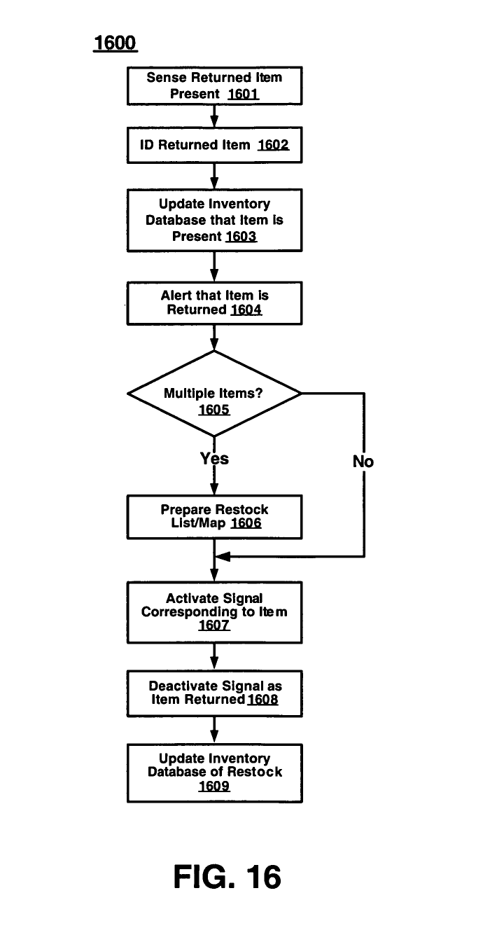

FIG. 16 is a flowchart of an exemplary computer implemented process 1600 for detecting the return of multimedia materials, according to one embodiment of the present invention. Where a customer returns an inventory item to an intelligent multimedia return receptacle (e.g., intelligent multimedia return receptacle 829; FIG. 8B), in step 1601, an RFID or another detector associated with that item is detected.

In step 1602, the inventory item is identified, e.g., from within the intelligent receptacle. In step 1603, an inventory database is updated to reflect the return of the item to stock (e.g., to availability status). In step 1604, the presence of the item in the receptacle is reported, completing process 1600.

For instance, an attendant can be alerted to the presence of the item in the intelligent multimedia item return receptacle, and/or upon a customer making an inquiry for a certain item, which is present in the intelligent return receptacle but not yet returned to stock (e.g., reshelved in a detector-bearing slot such as slot 39; FIG. 3), the presence and availability (notwithstanding its absence from its assigned slot) of the inquired for item can be reported to the inquiring customer and/or the attendant.

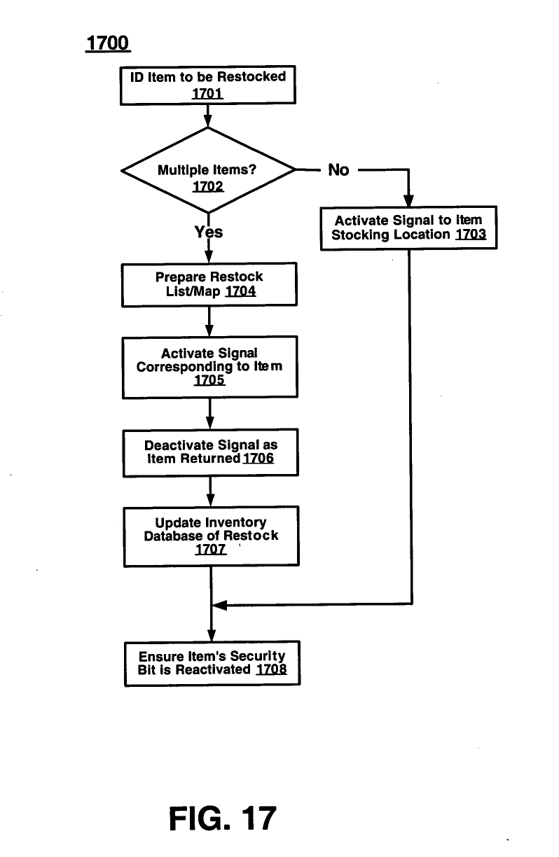

FIG. 17 is a flowchart of an exemplary computer implemented process 1700 for restocking inventory for a multimedia outlet, according to one embodiment of the present invention. In step 1701, an inventory item to be restocked in the multimedia outlet is identified, for instance by (e.g., from within) an intelligent multimedia item return receptacle, as being present at the multimedia outlet and available for restocking.

In step 1702, it is determined whether multiple inventory items are present within the intelligent return receptacle. If not (e.g., a single inventory item is in the intelligent multimedia return receptacle), then in step 1703, an attendant is informed as to the proper place (e.g., the shelf and slot identities) for restocking the inventory item.

If it is determined that multiple inventory items are present within the intelligent return receptacle, then in step 1704, a restocking list, which can include a map of the multimedia outlet and where each item goes, is prepared. In one embodiment, the restocking list comprises an ordered list wherein the list promulgates an efficient order of restocking, so as to simplify and make more efficient the restocking procedure for the restocking attendant.

Upon generating the restocking list, or if it is determined that multiple items are not present within the intelligent return receptacle, then in step 1705, beacons, lights, and/or other indicators (e.g., audible) are activated to flag the proper shelf and slot therein for orderly, proper restocking the item to its proper place within the media outlet. In step 1706, the indicators corresponding to a particular item are extinguished upon returning that item to its proper stocking place. In one embodiment (e.g., described above) wherein a restocking list for restocking multiple items comprises an ordered list, the beacons, lights, etc. are energized according to the ordered list.

For instance, as the attendant takes the items from the intelligent return receptacle to begin restocking, the beacon denoting the section and the light denoting the slot for the first item on the ordered restocking list is illuminated, guiding the attendant thereto. As the return of the first item is detected by the detector corresponding to its slot, the light corresponding to that slot is extinguished (as well as the beacon denoting that section, if the next item is not in that section) and the light (and beacon, if the next item is in another section) for the next item on the ordered restocking list is illuminated, and so forth.

In step 1707, the inventory database is updated to reflect restocking the inventory item to its proper place in the multimedia outlet. In step 1708, a security feature associated with the inventory item being restocked is activated, completing process 1700. For instance, in one embodiment, a security bit programmed into an RFID or other device associated with the inventory item is reactivated upon its retrieval from the intelligent multimedia item return receptacle. In one embodiment, the reactivation of the security feature occurs upon identification of the item within the intelligent multimedia item return receptacle.

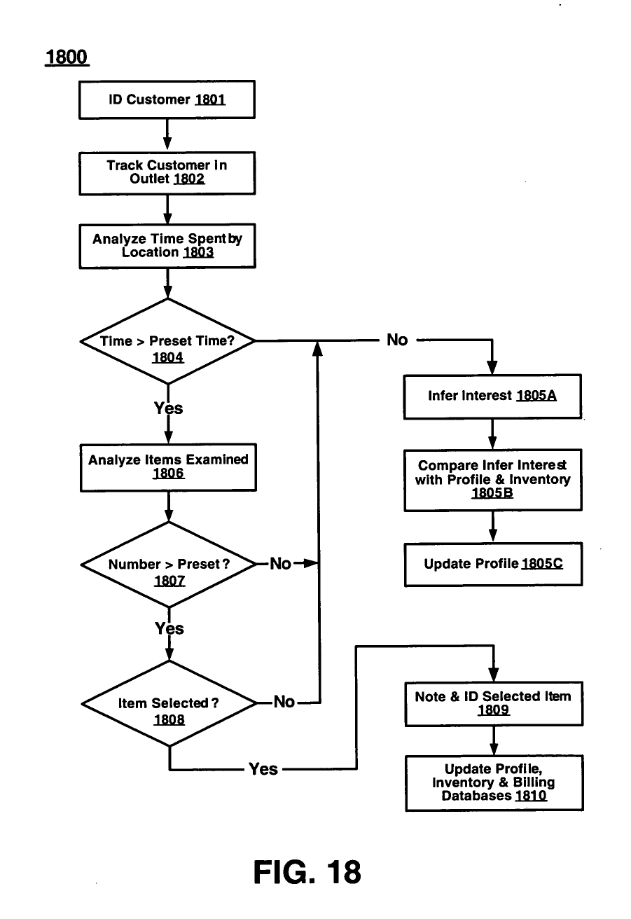

FIG. 18 is a flowchart of an exemplary computer implemented process 1800 for detecting customer dissatisfaction, according to one embodiment of the present invention. Process 1800 begins with step 1801, wherein a customer is identified. For instance, a customer is identified upon presenting a customer identification card to a card reader at an intelligent multimedia outlet, as described above.

In step 1802, the customer is monitored while present within the intelligent multimedia outlet. For instance, the customer's movements are tracked within the multimedia outlet, including the time the customer spends in any area therein. In step 1803, the time that the customer spends in any area within the intelligent multimedia outlet is analyzed. For instance, in an intelligent multimedia outlet wherein multimedia inventory items are arranged by their various genres and subgenres (e.g., to any level of granularity) within certain areas for stocking and/or display, the time that a customer spends within any particular area is inferred to comprise time spent browsing within that section (e.g., perusing the various products displayed therein).

In one embodiment, a time period is set as a value, based on marketing research, customer profile, and/or other information sources, wherein time reaching or exceeding that value is considered significant. In step 1804, it is determined whether the time that a customer spends within a particular area reaches (e.g., and/or exceeds) this predetermined value. If not, then in step 1805A, interest by the customer in the multimedia items stocked in that particular area is inferred from the amount of time the customer spends there. In step 1805B, the customer's multimedia (e.g., genre and sub-genre) interests inferred from the customer's profile and/or other sources are compared with the inventory database. In step 1805C, the profile corresponding to the customer is updated accordingly.

This can allow a system for conducting intelligent multimedia marketing operations to draw inferences relating to its inventory of available multimedia products in that particular multimedia outlet. In one embodiment, a number of items handled is set as a value, based on marketing research, customer profile, and/or other information sources, wherein time reaching or exceeding that value is considered significant.

For instance, where a customer's profile indicates that the customer prefers movies in a certain genre or sub-genre, but the customer spends little time there, it might be inferred that the genre/sub-genre of interest to this customer is light (e.g., underrepresented) at this multimedia outlet, or that a preference is changing. Such an inference can be combined with other inferences, as discussed below.

If it is determined that the time that a customer spends within a particular area reaches (e.g., and/or exceeds) this predetermined value, then in step 1806, the inventory items that the customer handles or picks up (e.g., removes from their assigned slot or otherwise behaves as though she/he is examining, perusing, reading, etc.) within any particular area of the intelligent multimedia outlet (e.g., belonging to a particular genre or sub-genre) are noted and corresponding data are analyzed.

For instance, in one embodiment, a number of items handled is set as a value, based on marketing research, customer profile, and/or other information sources, wherein a number reaching or exceeding that value is considered significant. In step 1807 it is determined whether the number of items so handled reaches or exceeds this pre-set number. If not, then step 1805A is performed, allowing a system for conducting intelligent multimedia marketing operations to draw inferences relating to its inventory of available multimedia products in that particular multimedia outlet.

For instance, where the customer spends significant time (e.g., as determined in step 1804) in an area of a particular multimedia outlet devoted to or otherwise storing multimedia products in a genre or subgenre, known from the customer's profile to be preferred by that customer, but handles few items (e.g., below the number deemed significant relating to step 1807), it might be inferred that the genre/sub-genre of interest to this customer is light (e.g., underrepresented) at this multimedia outlet, that the inventory is saturated, in relation to this particular customer (e.g., the customer is known, by a corresponding profile entry such as the customer's history of rented items, to have already rented, purchased, or otherwise already experienced the current items in stock), that the particular inventory items available are not to this customer's liking (which can be noted in the corresponding customer profile), or that a preference is changing. Such an inference can also be combined with other inferences, as discussed below. Saturation can be measured on any dimension, for any media-related concept.

If it is determined that the time that a customer spends within a particular area reaches (e.g., and/or exceeds) this predetermined value, then in step 1808, it is determined whether the customer selects an item from amongst the available inventory, such as for rental (e.g., according to terms of a subscription agreement) or purchase. If not, then step 1805A is performed, allowing a system for conducting intelligent multimedia marketing operations to draw inferences relating to its inventory of available multimedia products in that particular multimedia outlet.

For instance, where the customer spends significant time (e.g., as determined in step 1804) in the area of the multimedia outlet storing multimedia products in a genre or subgenre preferred by the customer, and handles a significant number of such items (e.g., above the number deemed significant relating to step 1807), yet does not then proceed to select an item from amongst the inventory, a particularly strong inference may be drawn relating to this customer, the customer's profile, and/or the inventory available at this particular outlet.

As above, it might be inferred that the genre/sub-genre of interest to this customer is light at this multimedia outlet, that the inventory is saturated, in relation to this particular customer, that the particular inventory items available are not to this customer's liking, that a preference is changing, and/or that the customer's profile should be updated. Such an inference can combine inferences discussed above, and can be used for further analyses, such as for outlet inventory stocking decisions, customer profile accuracy and/or precision determination, estimating a churn probability relating to this customer, and/or other studies of other factors.

Where it is determined that a customer selects an item from amongst the inventory, in step 1809 the item is noted. In step 1810, the item notation is used to update various databases of the system for conducting intelligent multimedia marketing operations (e.g., customer profile database 109, inventory database 107, accounting database 123, etc., system 100; FIG. 1B), completing process 1800.

Exemplary Documents

Exemplary Inventory Item History Document

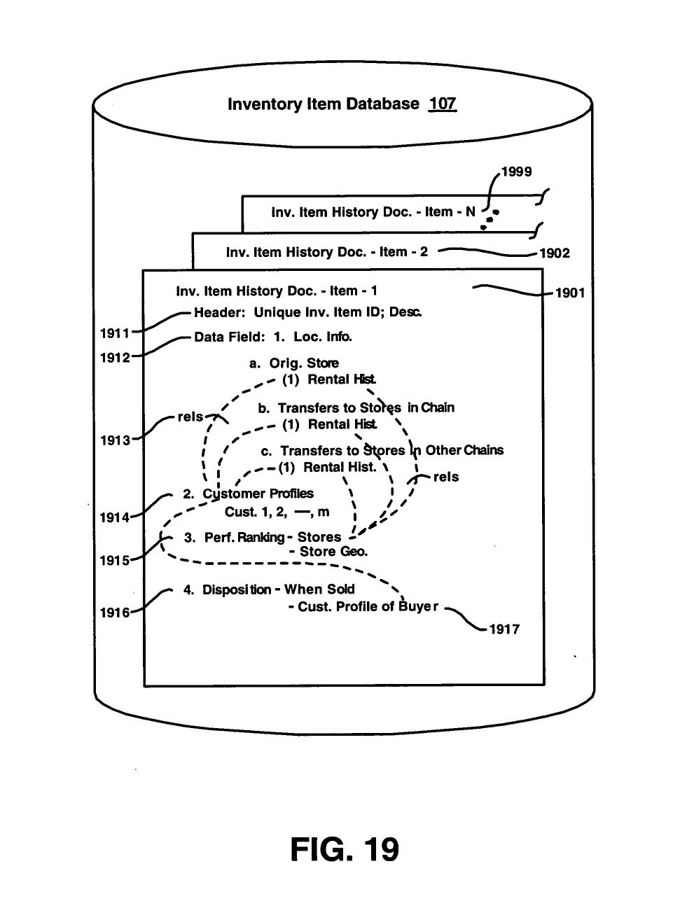

FIG. 19 depicts a databased inventory item history document 1901, according to one embodiment of the present invention. Inventory item history document 1901 records data relating to a particular first inventory item. Inventory item history document 1901 is stored in inventory database 107 amongst other inventory item history documents, including inventory item history document 1902 and 1999, inventory item history document relating to a second and an Nth inventory item, respectively. Inventory item history documents 1901, 1902, and 1999, as well as other inventory item history documents stored in inventory database 107, can share similar format, features, and other attributes.

Inventory item history document 1901 comprises a header 1911, which includes a unique identifier such as an inventory item number, a name, and/or a description. Inventory item history document 1901 can be retrieved by a request for data identified by reference to header 1911 by a RDBMS or another component of a system for conducting intelligent multimedia marketing operations (e.g., RDBMS 117, system 100; FIG. 1B).

A data field 1912 contains inventory related information. For instance, data field 1912 can store historical and locational information relating to the inventory item, such as its rental history, its history of assignment, e.g., to various multimedia outlets, transfers, repairs, rental history particularized by multimedia outlet, and the like. A rental performance history field 1915 and a customer profile reference 1914, which can also be particularized by multimedia outlet, can comprise entries to data field 1912, as well as a dispositional entry 1916.

Dispositional entry 1916 comprises data regarding a disposition of the inventory item, such as a dated sales record, which can include a customer profile reference 1917 to the buyer of the item. Relational vectors 1913 provide inter-references between various elements of data field 1912, such as between outlet-particularized historical entries and performance rankings 1915, dispositional profile reference 1917, customer profile references 1914, and the like.

Performance history field 1915 can rate performance of a particular inventory item by multimedia outlet, by a geographic, demographic, or another locational or social criteria.

Exemplary Customer Profile Document

FIG. 20 depicts a databased customer profile document, according to one embodiment of the present invention. Customer profile document 2001 records data relating to a particular first customer, who can have a contractual relationship such as a subscription, or any transactional relationship with an entity administering a system conducting intelligent multimedia marketing operations.

Customer profile document 2001 is stored in customer profile database 109 amongst other customer profile documents, including customer profile document 2002, relating to an Nth customer. Customer profile documents 2001 and 2002, as well as other customer profile documents stored in customer profile database 109, can share similar format, features, and other attributes.

Customer profile document 2001 comprises a header 2011, which includes a unique identifier such as a unique customer identification number, which corresponds to the customer who's profile is stored in customer profile 2001. Customer profile document 2001 can be retrieved by a request for data identified by reference to header 2011 by a RDBMS or another component of a system for conducting intelligent multimedia marketing operations (e.g., RDBMS 117, system 100; FIG. 1B).

Customer profile document 2001 also comprises a data field 2012, which in one embodiment includes a personal data subfield 2013. Personal data subfield 2013 includes personal information relating to the customer who's profile is stored in customer profile 2001, such as a name, and other identifying information, such as an address, an email address, a telephone number, etc. Personal data subfield 2013 also includes descriptive information relating to the customer, such as age, birth date, gender, various demographic data, and other information In one embodiment, such descriptive information includes characteristics of the customer relating to the customer's preferences in selecting multimedia items such as interests, lifestyle, education level, and other attributes.

Data field 2012 also contains a multimedia data subfield 2015. Multimedia data subfield 2015 includes information gathered about the customer during visits to multimedia outlets. For instance, multimedia data subfield 2015 includes data relating to the genres and sub-genres (to any level of granularity) browsed and to the relative degree to which the various genres and sub-genres are browsed, the time a customer spends in each of various multimedia outlets, time a customer spends in each of various multimedia outlets, time a customer spends in each of various areas within each of various multimedia outlets, and similar time recordings as related to genre characteristics, titles, series, actors, studios, artistic attributes (e.g., cinematographic, musical, literary, and the like), and other information categories, e.g., included in a sub-field 2019. Relational vectors 2018 provide inter-references between various elements of data field 1912, such as between genre-related data entries and entries within personal information sub-field 2013.

Components of a system for conducting intelligent multimedia marketing operations, such as a profile engine, a churn management component, or a marketing component (e.g., system 100, profile engine 13, churn management engine 119, marketing engine 17; FIG. 1B) can retrieve customer profile document 2001 from customer profile database 109. These components can use data from customer profile document 2001 for various applications.

In one embodiment for instance, profile engine 13 (FIG. 1B) examines any information within data field 2012, analyzes this data as well as relationship vectors 2018 between elements comprising the information therein, and generates a customer profile 2022. In the present embodiment, the customer profile 2022 itself is written back to data field 2012 (e.g., stored within customer profile database 109), where it is available to other components, such as the churn management module and the marketing engine.

With reference again to FIG. 1B, customer profile 2022 is used in one embodiment by churn management engine 119 (FIG. 1B) to detect a pattern that can indicate a probability that the customer profiled therein might not renew a subscription, and to recommend or trigger ameliorative action. For instance, the customer's profile may indicate that the frequency of the customer's visits to one or more multimedia outlets (e.g., served by system 100) has diminished, in one embodiment dropping below some threshold value indicative of a significant probability that the customer will not renew a current subscription. This setpoint can trigger an analyzing action by churn management engine 119.

The customer's profile may indicate that the customer is of a certain age, or within an age range, and of a certain gender; that the customer shops at one or more particular multimedia outlets associated with system 100, and prefers a particular format of media products in a certain genre (e.g., and sub-genre, to any level of granularity), and is a fan of certain stars, producers, studios, composers, etc. The customer profile might indicate that the customer spends more time in one area of a multimedia outlet that houses the preferred genre, and examines other media in this genre, but does or does not rent them, and the customer's rental history indicates that they have already viewed a number of movies in the preferred genre, particularly those with a certain star. Any sort of customer patterns can comprise profile 2022.

Analysis of this customer profile 2022 by churn management engine 119, triggered by sensing that the frequency of this customer's visits have dropped below a churn alert threshold, can perceive this as a significant pattern which can be expanded or understood by seeking other relevant, perhaps related information. For instance, detection of this pattern may automatically and/or programmatically trigger churn management engine 119 to examine information from inventory database 107. Such information can relate, for example, to the inventory of the customer's preferred genres, in the media outlet this customer normally patronizes. A lapse profile entry 2023 highlights patterns of customer behavior that can signify a tendency to or probability of churn (e.g., of the customer failing to renew a subscription).

Exemplary Process for Detecting Customer Dissatisfaction

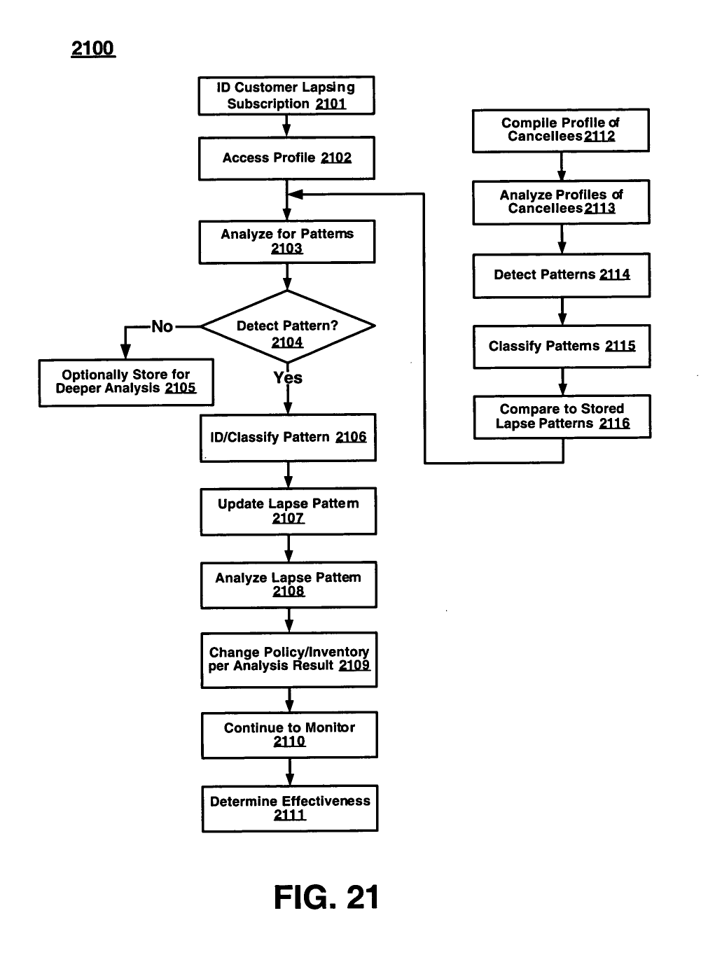

FIG. 21 is a flowchart of an exemplary computer implemented process 2100 for detecting a pattern characterizing customer dissatisfaction, according to one embodiment of the present invention. Process 2100 begins with step 2101, wherein a customer is identified who's subscription is lapsing, for instance by an account manager module and/or a subscription management application (e.g., account management module 175, subscription manager application 507; FIG. 1B, 5, respectively), which can inform a churn manager (e.g., churn management engine 119; FIG. 1B).

In step 2102, a customer profile (e.g., customer profile 2001; FIG. 20) is accessed, for instance by the churn manager. In step 2103, the customer profile is analyzed for patterns indicative of a subscription lapsing pattern, such as diminished frequency of visits, increased customer browsing time in a preferred genre area of an outlet without selecting a multimedia item for checkout, etc. In step 2104, it is determined whether any patterns are detected. If not, then in step 2105, the customer profile is optionally stored, such as for deeper analysis. If a pattern is detected, then in step 2106, the pattern is identified and classified.

In step 2107, the customer profile is updated to highlight this pattern as a lapse profile entry (e.g., lapse profile entry 2032; FIG. 20). In step 2108, the lapse pattern is analyzed, such as to determine an ameliorative action (e.g., an action designed to increase customer satisfaction and thus prevent churn). In step 2109, an ameliorative action is taken (e.g., by the churn management engine) according to the analysis result (step 2108). Examples of ameliorative action include providing an incentive, such as a premium or a special, changing inventory in a particular multimedia outlet, such as stocking more and/or newer inventory items in the customer's preferred genre.

In step 2110, monitoring of the customer is continued. In step 2111, the effectiveness of the ameliorative action is ascertained, at which point process 2100 can be complete. In one embodiment, process 2100 identifies lapse patterns beginning with step 2112, wherein customer profiles are compiled for customers who have allowed their subscriptions to lapse, cancelled their subscriptions, or exhibited other churn related behavior. In step 2113, each of the customer profiles is analyzed for the presence of patterns. In step 2114, patterns detected are identified as particular lapse patterns. In step 2115, identified lapse patterns are classified, such as for further analysis. In step 2116, lapse patterns are provided to a churn manager, such as for comparison to an individual customer profile (e.g., step 2103).

Exemplary Process for Acting to Ameliorating Customer Dissatisfaction

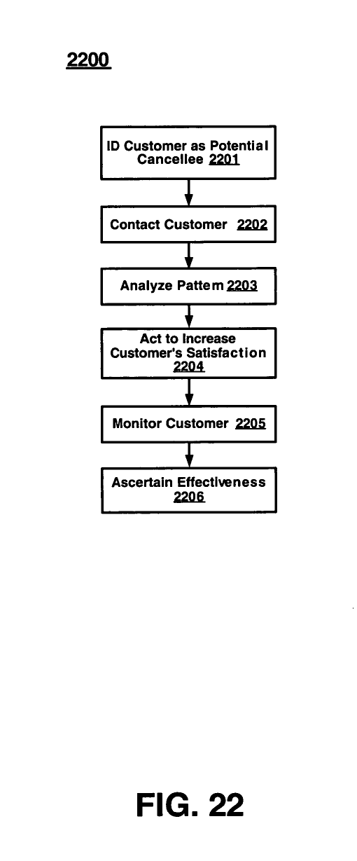

FIG. 22 is a flowchart of an exemplary computer implemented process 2200 for acting to ameliorate customer dissatisfaction, according to one embodiment of the present invention. Process 2200 begins with step 2201, wherein a customer is identified as a candidate to likely engage in churn related behavior, such as allowing a subscription to lapse, for instance by performing process 2100 (FIG. 21).

In step 2202, the customer is contacted by the system for conducting intelligent multimedia marketing operations. In one embodiment, how the customer is contacted can depend upon various circumstances. For instance, where the customer is identified during a visit to a multimedia outlet, the customer can be contacted via a monitor at a customer service kiosk. Where the frequency of customer visits to associated multimedia outlets as diminished to the point where contacting the customer by kiosk therein might be immediately impracticable upon identifying the customer as one likely to churn, the customer is contacted by email or another medium.

In step 2203, the customer's lapse profile is analyzed to determine an effective action to take to increase the customer's satisfaction level. For instance, upon analyzing a customer's profile, an effective action to increase the customer's satisfaction level might be determined to comprise an action selected from the group of extending a promotional offer, offering an incentive, special offers, adjusting inventory available at certain multimedia outlets and offering free subscription extensions, and others. In step 2204, the most effective action is selected and performed.

In step 2205, the customer is monitored after taking the action to increase the customer's satisfaction level. In step 2206, the effectiveness of the action increase the customer's satisfaction level is ascertained, completing process 2200.

Exemplary Process for Profiling Multimedia Items

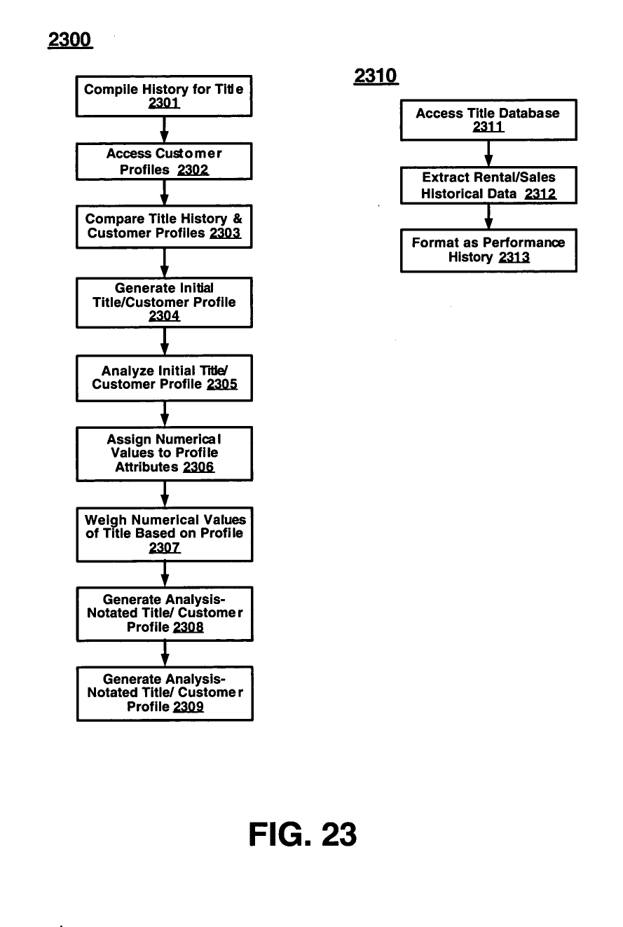

FIG. 23 is a flowchart of an exemplary computer implemented process 2300 for profiling multimedia items, according to one embodiment of the present invention. Process 2300 begins with step 2301, wherein a history is compiled for a particular multimedia item, such as a certain title in a certain format.

In one embodiment, step 2301 is performed by executing a routine 2310, which begins with step 2311, wherein an inventory database (e.g., inventory database 107; FIG. 1B) is accessed. In step 2312, performance data relating to the particular inventory item is extracted from the inventory database. In step 2313, the performance data is formatted as a performance history.

In step 2302, customer profiles (e.g., customer profiles 2001, 2002; FIG. 20) relating to customers listed in the performance history are accessed. In step 2303, the customer profiles so accessed are compared with the generated performance history. In step 2304, an initial title-medium/customer profile match profile is generated, which profiles the customers with whom this particular multimedia item is popular.

In step 2305, the initial title-medium/customer profile is analyzed. In step 2306, numerical values are assigned based on this analysis to various profile characteristics, which can be selected by marketing and other research. In step 2307, the numerical values are weighed, based for instance upon the profiles. In step 2308, an analysis-notated title/customer profile is generated, which can relate various customer profiles to the particular multimedia product, for use in marketing and other research, data mining, business intelligence, and the like, which completes process 2300.

Exemplary Process for Profiling a Customer

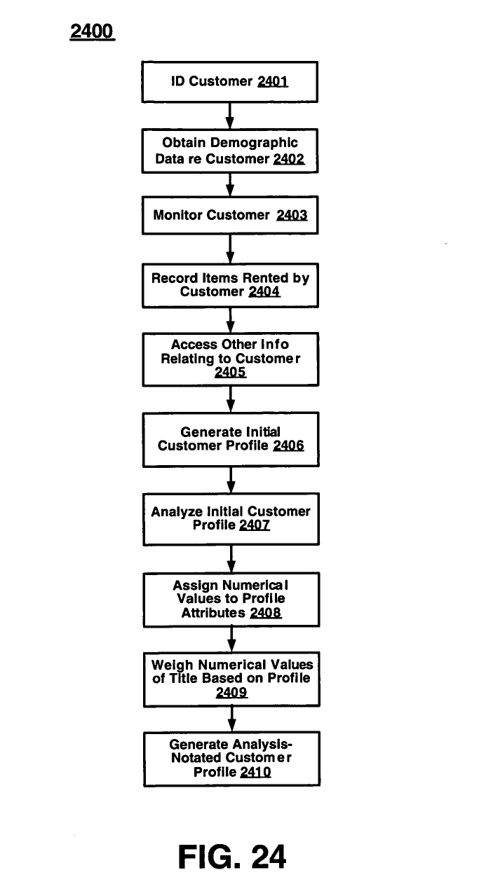

FIG. 24 is a flowchart of an exemplary computer implemented process 2400 for profiling a customer, according to one embodiment of the present invention. Process 2400 begins with step 2401, wherein a customer is identified. In step 2402, information such as demographic and geographic data relating to the customer is obtained and recorded in a profile document (e.g., customer profile document 2001; FIG. 20).

In step 2403, the customer is monitored. In monitoring the customer, information relating to the customer's behavior within a multimedia outlet is gathered, as well as information relating to the customer's relationship with the system for conducting intelligent multimedia marketing operations such as subscription performance, etc.

In monitoring the customer's behavior in an associated multimedia outlet, the time that the customer spends in various areas of the outlet, time the customer spends with each specific genre or sub-genre (to any level of granularity), items of inventory examined by the customer, and items selected (and/or handled and not selected) by the customer are recorded.

In step 2404, items of inventory selected by the customer for rental, purchase, etc., are recorded by a unique inventory item identifier number, title, a particular artist, artists (actors, producers, studios, composers, performers, etc.), genre, sub-genre (to any level of granularity), combined genres, and/or any other attributes.

In step 2405, other information relating to the customer is accessed. Such information can include information regarding other multimedia and non-multimedia products the customer prefers, purchases, rents, etc. Such information is obtained in one embodiment from a source of business information, such as a business intelligence source (e.g., BI database 7, BI source 8; FIG. 1A), another business with which the system for conducting intelligent multimedia marketing operations exchanges information, such as by agreement, a subscription-based information source, a source to which the customer has agreed can provide data relating to the customer, etc. Such information can be provided by various sources and related by an RDBMS (e.g., RDBMS 117; FIG. 1A). Relevant information can include any kind of data relating to the customer, and can be gleaned from any source. Such sources can include banking, stock market, other financial information, economic indicators, employment (e.g., and unemployment) data, calendar appointments, and seasonal data, among others.

In step 2406, an initial customer profile (e.g., customer profile 2001; FIG. 20) is generated, which stores and formats this information. In step 2407, the initial customer profile is analyzed. In step 2408, numerical values are assigned based on this analysis to various profile characteristics, which can be selected by marketing and other research. In step 2409, the numerical values are weighed, based for instance upon the profiles. In step 2410, an analysis-notated customer profile is generated, which can relate various multimedia product inventory item profiles to the particular customer profile, for use in marketing and other research, data mining, business intelligence, and the like, which completes process 2400.

Exemplary Process for Profiling a Multimedia Outlet

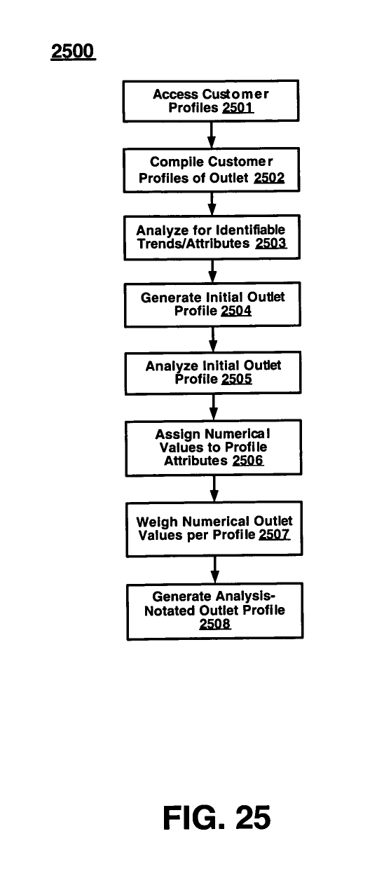

FIG. 25 is a flowchart of an exemplary computer implemented process 2500 for profiling a multimedia outlet, according to one embodiment of the present invention. Process 2500 begins with step 2501, wherein customer profiles including demographic and/or geographic data, are accessed. In step 2502, the customer profiles relating to customers who frequent the particular multimedia outlet to be profiled are compiled and examined. In step 2503, these customer profiles are analyzed to identify any trends, common characteristics, and similarities.

In step 2504, an initial multimedia outlet profile listing the trends, common characteristics, and similarities is generated from this analysis. In step 2505, the significance of the trends, common characteristics, and similarities in the initial multimedia outlet profile is analyzed. In step 2506, numerical values are assigned based on this analysis to the various trends, common characteristics, similarities, and other profiled multimedia outlet characteristics, which can be selected by marketing and other research. In step 2507, the numerical values are weighed, based for instance upon the profiles. In step 2508, an analysis-notated multimedia outlet profile is generated, which can relate various customer profiles to the particular multimedia outlet, for use in marketing, demographic, and other research, data mining, business intelligence, and the like, which completes process 2500.

Exemplary Process for Profiling Using Demographic/Geographic Data

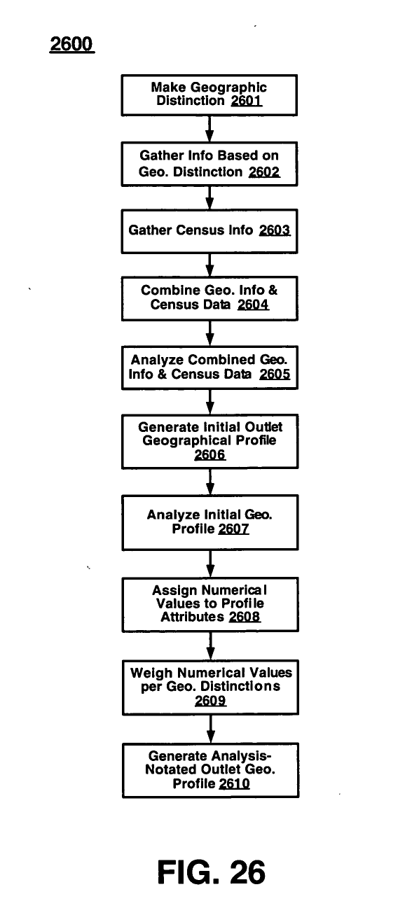

FIG. 26 is a flowchart of an exemplary computer implemented process 2600 for profiling a multimedia outlet using geographic data, according to one embodiment of the present invention. Process 2600 begins with step 2601, wherein a geographic distinction is made between various associated multimedia outlets, such as based on their respective locations, addresses, etc.

In step 2602, information is gathered based on this geographic distinction. For instance, information received from a RDBMS and/or a BI source (e.g., RDBMS 117, BI source 8; FIG. 1B, 1A, respectively), such as customer profiles and/or performance ratings for particular inventory items relating to a particular multimedia outlet at a certain location. In step 2603, demographic data is gathered relating to the geographic distinction, such as census data, socioeconomic information, or the like.

In step 2604, the geographic distinction is combined with the demographic information. In step 2605, the combined geographic and demographic information is analyzed. In step 2606, an initial multimedia outlet geographic profile listing trends, common characteristics, and similarities within and between various multimedia outlets is generated from this analysis. In step 2607, the significance of the trends, common characteristics, and similarities in the initial multimedia outlet geographic profile is analyzed.

In step 2608, numerical values are assigned based on this analysis to the various trends, common characteristics, similarities, and other profiled multimedia outlet characteristics, which can be selected by demographic, marketing, and other research. In step 2609, the numerical values are weighed, based for instance upon the geographical distinctions. In step 2610, an analysis-notated multimedia outlet geographic profile is generated, which can relate various geographic and demographic information to the particular multimedia outlet, for use in marketing, demographic, and other research, data mining, business intelligence, and the like, which completes process 2600.

Exemplary Processes for Marketing a Multimedia Product

Exemplary Process for Marketing a Multimedia Product to a Customer

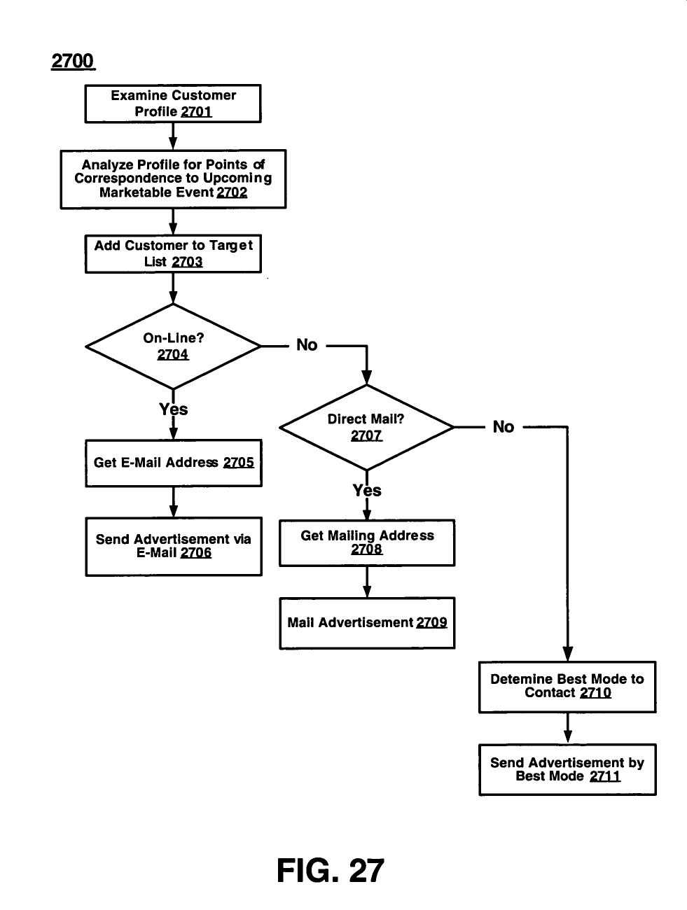

FIG. 27 is a flowchart of an exemplary computer implemented process 2700 for is a flowchart of an exemplary computer implemented process for marketing a multimedia product based on multimedia product usage, according to one embodiment of the present invention. Process 2700 begins with step 2701, wherein a customer profile is examined for information such as a rental history.

In step 2702, the profile, for instance, the rental history components, are analyzed for points of correspondence to an upcoming marketable event, such as a release of a new movie. Such analysis can be based upon, for instance, attributes of the new movie that correspond to preferences of a customer revealed by the customer's profile (e.g., category, genre and sub-genre, artists, combinations, etc.), which reveal multimedia products frequently used (e.g., rented or purchased) by the customer.

Based on the points of correspondence detected by the analysis between the marketable event and a particular customer, in step 2703 the customer is targeted for the direction of a marketing effort in promotion of the marketable event. For instance, where a particular customer's profile indicates that she enjoys movies in the action-adventure genre and/or is an avid Arnold Schwarzenegger fan, and where the marketable event is the new release of a new action-adventure movie starring this particular artist, then this customer is targeted for a marketing effort promoting the new release.

In one embodiment, the marketing effort comprises a promotional premium. For instance, the customer may be offered free or inexpensive tickets to the new movie release, e.g., to view its initial screening in a theater, along with a discount coupon to purchase the movie for her own film library upon its release in another format, such as DVD, VHS, etc. In one embodiment, the marketing effort comprises any marketing activity, whether run with promotions, premiums, or not.

Once a customer is targeted for directing a marketing effort towards them, in step 2704, it is determined whether it is convenient to directing the marketing effort towards the person through an on-line medium, such as email, which can be very cost-effective and done with prior agreement of the customer, such as through the customer's subscription process.

If it is determined that it is convenient to directing the marketing effort towards the person through an on-line medium such as email, then in step 2705 that customer's email address is retrieved. In various embodiments, the email address can be obtained from the customer profile or from corresponding information sources, such as the customer's account information, lists, databases, or by other information sources, e.g., using a RDBMS (e.g., RDBMS 117; FIG. 1B) or another mechanism. In step 2706, the marketing effort is directed towards the customer via email (or another on-line mode).

If it is determined that it is not convenient to directing the marketing effort towards the person through an on-line medium, then in step 2707, it is determined whether it is convenient to directing the marketing effort towards the person via direct mail. If so, then in step 2708, that customer's mailing address is retrieved. In various embodiments, the mailing address can be obtained from the customer profile or from corresponding information sources, such as the customer's account information, lists, databases, or other information sources, e.g., using a RDBMS (e.g., RDBMS 117; FIG. 1B) or by another mechanism. In step 2709, the marketing effort is directed towards the customer by direct mail.

If it is determined that it is not convenient to directing the marketing effort towards the person through direct mail, then in step 2710, a convenient mode of directing the marketing effort towards the customer, such as via telemarketing or another mode, is determined. In step 2711, the marketing effort is directed towards the customer by that mode, completing process 2700.

Exemplary Process for Marketing a Multimedia Product to Customers

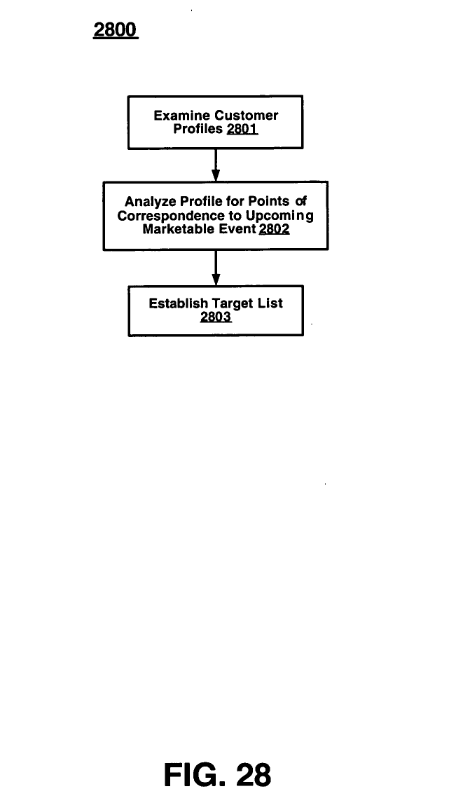

With reference to FIG. 28, in one embodiment, process 2700 can be facilitated or otherwise assisted by a process 2800. FIG. 28 is a flowchart of an exemplary computer implemented process for marketing a multimedia related product based on various consumer behavior, according to one embodiment of the present invention. Process 2800 begins with a step 2801, wherein a plurality of customer profiles, such as those for all customers, are examined for information such as their rental histories.

In step 2802, the profiles, for instance, the rental history components thereof, are analyzed for points of correspondence to an upcoming marketable event, such as a release of a new movie. Based on the points of correspondence detected by the analysis between the marketable event and any of the customers, in step 2803 a target list is established. The target list comprises a list of the customers from among the plurality of customers who's profiles were examined, to whom a marketing effort is to be directed, in promotion of the marketable event. Process 2800 may be complete with executing step 2803. However, process 2700 can proceed with step 2703, wherein a particular customer is targeted for the direction of a marketing effort in promotion of the marketable event, as appearing on the target list generated in step 2803 of process 2800.

Exemplary Process for Listing Targeted Customers for Marketing

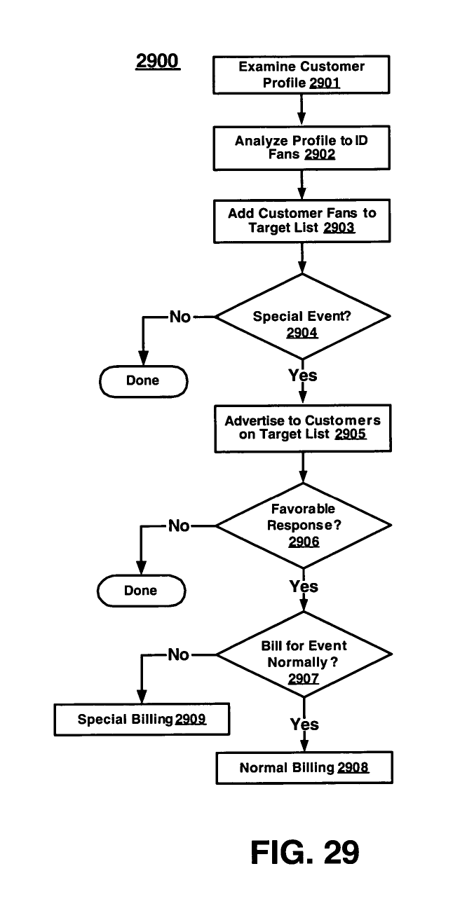

FIG. 29 is a flowchart of an exemplary computer implemented process 2900 for creating a list of targeted multimedia consumers, according to one embodiment of the present invention. Process 2900 begins with step 2901, wherein a plurality of customer profiles, such as those for all customers, are examined for information such as their rental histories.

In step 2902, the profiles, for instance, the rental history components thereof, are analyzed for points of correspondence that can characterize customers as those who prefer (e.g., aficionados, fans, admirers, purchasers, contributors, etc.) of an artistic or other identifiable attribute relating to a multimedia entity (e.g., movie or other artistic release, actor, studio, etc.). For instance, the artistic or other identifiable attribute can comprise a particular actor or director in the credits of a multimedia product such as a movie. The points of correspondence between a customer profile and this attribute in one embodiment comprise data in the customer profile that can imply that the corresponding customer prefers (e.g., rents with significant frequency) multimedia products associated with this attribute, such as starring this particular actor or directed by this particular director, etc.

In step 2903, a target list is generated based on this analysis of customers from among the plurality of customers who's profiles were examined, to whom a marketing effort can effectively be directed, relating to the identifiable attribute (e.g., fans of the particular actor or director). In step 2904, it is determined whether a marketable event relating to the identifiable attribute is to occur; if not, process 2900 can be complete. Such a marketable event comprises any event which can be of interest to customers on the target list for this identifiable attribute. For instance, a marketable event can comprise a special event, such as a special showing of pre-production footage, director's cuts, outtakes, comical bloopers, and/or book signings, speeches, lectures, on-line personal or group chats, concerts, intimate gatherings, seminars, or any other event.

Where it is determined that such a marketable event is to occur, in step 2905, the marketable event is advertised to customers on the target list for participation by subscription or individual payment. In step 2906, it is determined whether a customer responds favorably to the marketing effort, such as by placing an order to participate in the event; if not, process 2900 can be complete. If it is determined that a customer responds favorably to the marketing effort, then in step 2907 it is determined whether the customer is to be billed for participation in the event according to the customer's normal billing arrangement. Where it is determined whether the customer is to be billed for participation in the event according to the customer's normal billing arrangement, then in step 2908, the customer is billed according to the normal course. Where it is determined that the customer is to be billed for participation in the event other than according to the customer's normal billing arrangement, then in step 2908, the customer is billed specially for participation in the special event, completing process 2900.

Exemplary Process for Narrowcasting

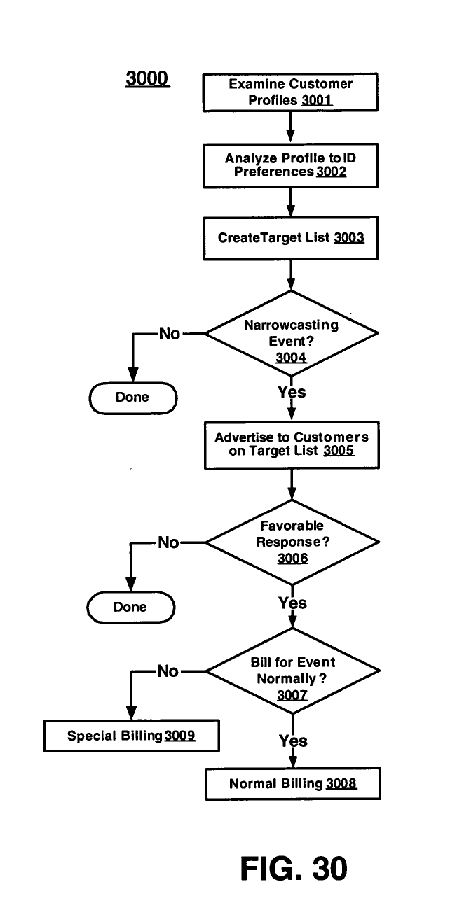

FIG. 30 is a flowchart of an exemplary computer implemented process 3000 for marketing narrowcasting services based on multimedia consumer behavior, according to one embodiment of the present invention. Process 3000 begins with step 3001, wherein a plurality of customer profiles, email addresses, account data, and/or other information sources, such as those for all customers, are examined for information such as their rental histories, and multimedia use (e.g., viewing) history. For instance, customers are identified as users of certain multimedia access sources, such as cable television/internet, etc., pay-per-view, video-on-demand, and the like.

In step 3002, the profiles, for instance, the rental history components thereof, are analyzed for points of correspondence that can characterize customers as preferring an artistic or other identifiable attribute relating to a multimedia entity. In step 3003, a target list is generated based on this analysis of customers from among the plurality of customers who's profiles were examined, to whom a marketing effort can effectively be directed, relating to the identifiable attribute.

In step 3004, it is determined whether a marketable event relating to the identifiable attribute and amenable to narrowcasting is to occur; if not, process 3000 can be complete. Such a narrowcasting event comprises any event that can be of interest to customers on the target list for this identifiable attribute and which can be narrowcast to them upon request, demand, etc. For instance, a narrowcasting event can comprise a movie having an artistic or other attribute relating to a preference of the customers on the target list, such as belonging to a genre or sub-genre, starring a certain actor, or directed by a certain director, etc., preferred by the customer.

Where it is determined that such a narrowcasting event is to occur, in step 3005, the narrowcasting event is advertised to customers on the target list for participation by subscription or individual payment. In step 3006, it is determined whether a customer responds favorably to the marketing effort, such as by placing an order to participate in the event; if not, process 3000 can be complete. If it is determined that a customer responds favorably to the marketing effort, then in step 3007 it is determined whether the customer is to be billed for participation in the event according to the customer's normal billing arrangement.

Where it is determined whether the customer is to be billed for participation in the event according to the customer's normal billing arrangement, then in step 3008, the customer is billed according to the normal course. Where it is determined that the customer is to be billed for participation in the event other than according to the customer's normal billing arrangement, then in step 3008, the customer is billed specially for participation in the special event, completing process 3000.

Exemplary Process for Marketing Video on Demand Products

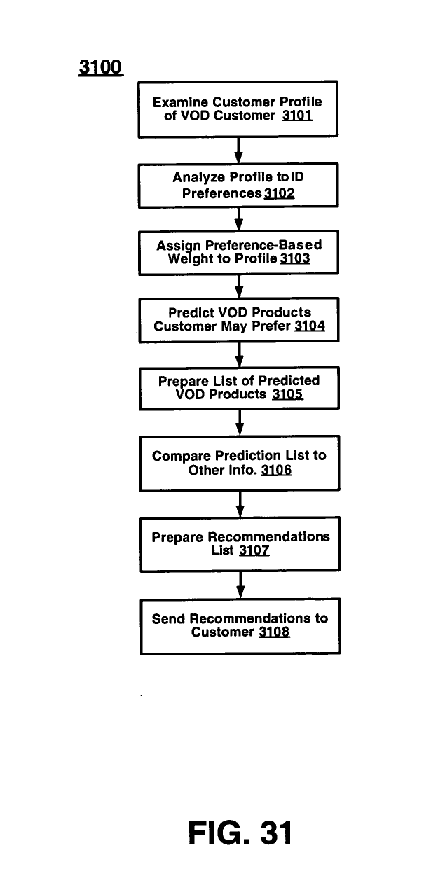

FIG. 31 is a flowchart of an exemplary computer implemented process 3100 for marketing video on demand products, according to one embodiment of the present invention. Process 3100 begins with step 3101, wherein a customer profile of a particular customer, known to use video on demand, and/or other information sources relating to that customer are examined for information such as their rental histories, and multimedia use (e.g., viewing) history.

In step 3102, the profile, for instance, the rental history component thereof, is analyzed for characterizing customers as preferring an artistic or other identifiable attribute relating to an inventory of video on demand products, such as a particular actor, director, producer, studio, etc., or any combination of such artistic or other attributes. In step 3103, the profile is weighted according to the characterization.

In step 3104, video on demand products, for instance, genres, sub-genres, titles, sequels, etc. of movies that are available in the video on demand format and that would be of interest to this customer, based on the characteristics-weighted profile are predicted. Based on these predictions, in step 3105, a list of titles predicted to be of particular interest to the customer is prepared.

In step 3106, the list is compared to the customer profile and/or other information relating to the customer based on characteristics other than artistic considerations, such as account status, rental availability (e.g., how many titles the customer may rent under the terms of the subscription agreement, etc.), or other considerations. In step 3107, a recommendation list having for instance a manageable number of recommended titles is culled from the list of titles based on this additional information. In step 3108, the recommendation list is sent to the customer, completing process 3100.

Exemplary Process for Marketing Based on Preferences for Other Products

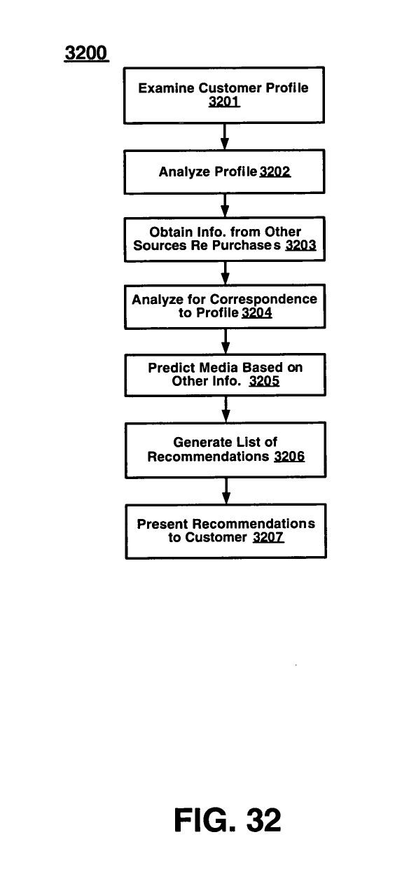

FIG. 32 is a flowchart of an exemplary computer implemented process 3200 for marketing a multimedia product based on consumer preferences for other product, according to one embodiment of the present invention. Process 3200 begins with step 3201, wherein a customer profile is examined for information such as a rental history, for instance, to determine what multimedia products the customer prefers (e.g., frequently rents and/or purchases).

In step 3202, the profile, for instance, the rental history components, are analyzed for points of correspondence to multimedia products, such as particular movies, games, or the like. In step 3203, information relating to other products used and/or preferred by the customer is accessed from other information sources. Such sources include, in one embodiment, a business intelligence (BI) source (e.g., BI source 8, BI database 7; FIG. 1A). The information sources can also include a database, server, report generator, or another information source of an associated, cooperative, and/or networked business, information provided by the customer, such as by surveys, use of product-related coupons, premiums, etc., or another information source.

In step 3204, the information relating to other products used and/or preferred by the customer is analyzed for points of correspondence to the customer profile. For instance, one exemplary customer profile indicates that a particular customer frequently rents and/or purchases multimedia products relating to children. Exemplary information accessed that relates to other products used and/or preferred by that customer can have a point of correspondence to the customer profile where the information indicates that, at a networked toy store the customer purchases stuffed animals and dolls that are related to characters in a particular children's show, such as Earnie™ and Big Bird™ dolls relating to Sesame Street™. A second exemplary customer profile for another customer indicates that this customer frequently rents and/or purchases multimedia products relating to military themed electronic games. In this example, information accessed that relates to other products used and/or preferred by that customer can have a point of correspondence to the customer profile where the information indicates that, at a networked electronics store the customer purchases a joy stick and game controller console having a new capability.

Based on the points of correspondence between the customer profile and the information accessed relating to other products used and/or preferred by that customer, in step 3205 multimedia product identities such as titles are predicted that might be of interest to the customer. For instance, in the first example above, a new Sesame Street™ DVD release might be predicted to be of interest to the customer who frequently rents/purchases children‘s’ multimedia products and who purchased the Earnie™ and Big Bear™ dolls. In the second example, a new air war electronic game that can fully utilize the capabilities of the newly purchased joy stick/controller might be predicted to be of interest to the customer who frequently rents/purchases military themed electronic games.

In step 3206, a recommendation list is generated based on the titles that are predicted to be of possible interest to the customer. In step 3207, the recommendation list is given to the customer, completing process 3200. The recommendation list can be given to the customer by any method, such as by email or upon logging into the intelligent infrastructure of a multimedia marketing outlet (e.g., intelligent infrastructure 11, multimedia marketing outlet 9; FIG. 1A).

Exemplary Process for Marketing Using Directed Incentive

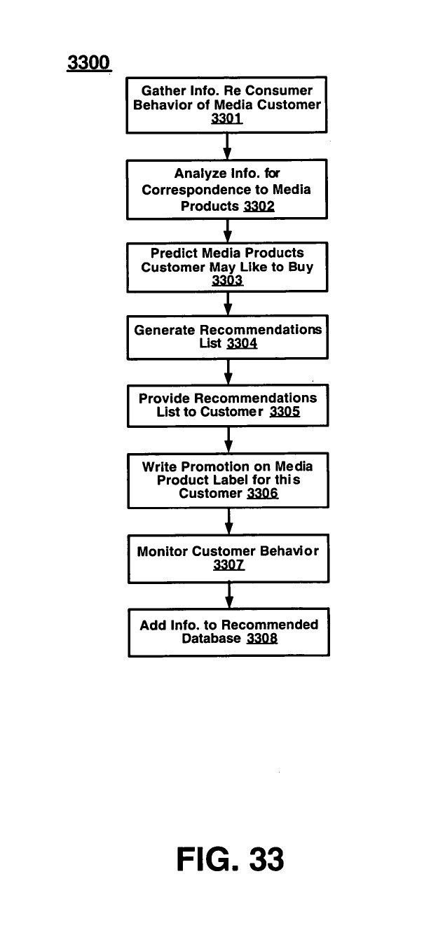

FIG. 33 is a flowchart of an exemplary computer implemented process 3300 for marketing using directed incentive, according to one embodiment of the present invention. Process 3300 begins with step 3301, wherein information is gathered relating to consumer behavior, such as product purchasing trends for a multimedia customer, such as by accessing a BI source or another information source of an associated, cooperative, and/or networked business, information provided by the customer, such as by surveys, use of product-related coupons, premiums, etc., or another information source.

In step 3302, this consumer behavior information is analyzed for points of correspondence to multimedia products, such as particular movies, games, or the like. In step 3303, particular multimedia products are predicted to be of interest to the customer for purchase from these points of correspondence. In step 3304, from these predictions, a recommendation list of such multimedia products is prepared for the customer. In step 3305, the list is given to the customer, such as via email or upon the customer logging in at an associated multimedia outlet, or by any other means.

In step 3306, a promotion such as a product discount or another premium is written to the identifier such as an RFID or a similar type of electronic tag, an electronic label, code plate, or transponder (e.g., RFID tag 151; FIG. 3) of a multimedia product recommended to the customer, completing process 3300.

Exemplary Process for Identifying Patterns Relating to Churn

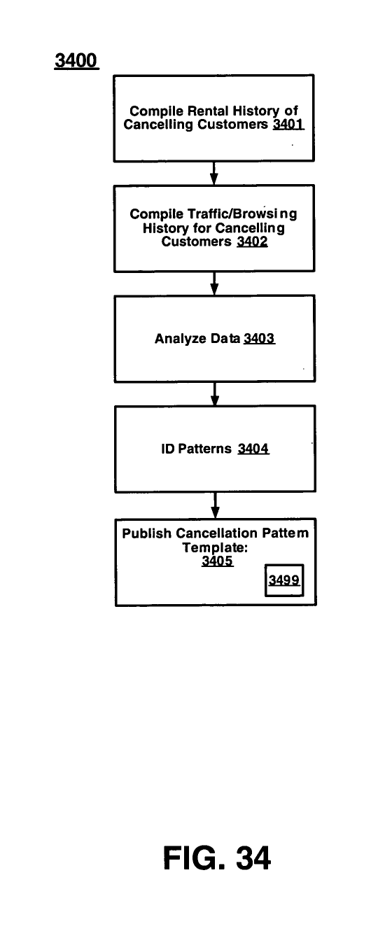

FIG. 34 is a flowchart of an exemplary computer implemented process 3400 for identifying patterns relating to subscription cancellations (e.g., churn), according to one embodiment of the present invention. Process 3400 begins with step 3401, wherein the rental histories are compiled for customers identified as allowing their subscriptions to lapse, such as from their customer profiles.

In step 3402, information is gathered, such as from the customer profiles associated with these customers, relating to their traffic patterns, browsing activity, and similar behavior displayed by these customers while they were in associated multimedia outlets over the history of their subscription. In step 3403, this information is combined and analyzed. In step 3404, patterns are identified based on this analysis that correspond to customers at risk of canceling their subscriptions.

For instance, the canceling customers' profiles may indicate that the customers' visits to associated multimedia outlets had become less frequent during the course of their subscriptions. By analysis of this pattern, a threshold value may be identified that indicates a certain probability of subscription cancellation. The customers' profiles may indicate by traffic, browsing, rental, and/or other patterns that the customers traffic in the areas of associated multimedia outlets where multimedia products relating to their preferences are kept, but that, after a certain point in their subscription histories, the customers fail to select a multimedia product for checkout. Such information can be compared to inventory databases and other information sources to identify issues that can result in subscription churning.

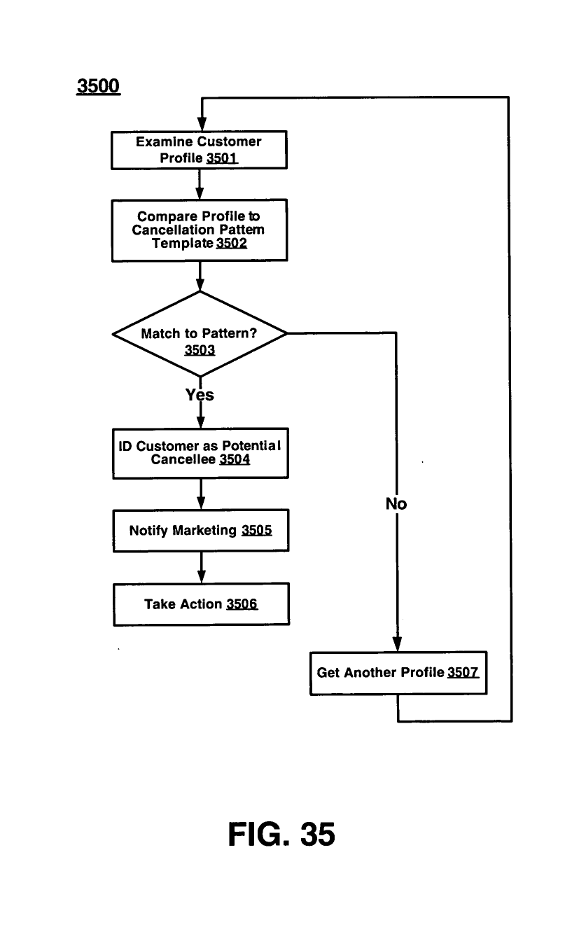

In step 3405, a churn pattern template 3499 is generated (e.g., published, promulgated, transmitted, etc.) for key personnel (e.g., managers, marketers, etc.) and/or components (e.g., component systems, subsystems, engines, etc.) of a system for intelligent multimedia marketing operations (e.g., system 10, 100; FIG. 1A, 1B, respectively). In step 3406, the churn pattern template 3499 is used by such components and key personnel to study and understand, plan to correct, and take action to ameliorate such churn causing factors (e.g., churn causing conditions, processes, issues, etc.), completing process 3400. One such action is exemplified below (e.g., process 3500; FIG. 35).

Exemplary Process for Identifying Potentially Subscription Lapses

FIG. 35 is a flowchart of an exemplary computer implemented process 3500 for identifying a customer as a potential for subscription cancellation, according to one embodiment of the present invention. Process 3500 begins with step 3501, wherein a customer profile (e.g., customer profile document 2001; FIG. 20) is examined. Customer profiles can be examined by various components of a system for intelligently marketing multimedia products (e.g., system 10, 100; FIG. 1A, 1B, respectively) and at various times and or event occurrences.

For instance, in one embodiment customer profiles are routinely examined during a examination of customer profiles, for example by a churn management agent (e.g., churn management engine 119; FIG. 3). In one embodiment, a customer profile can also be examined upon updating the profile, for example by a profile engine (e.g., profile engine 13; FIG. 1B). In other embodiments, customer profiles are examined at other times and/or event occurrences by various components of the system for intelligently marketing multimedia products.

In step 3502, the customer profile under examination (e.g., being examined) is compared to a churn (e.g., subscription cancellation) pattern template, such as churn pattern template 3499 (FIG. 34). Various statistical and econometric techniques can be applied to effectuate this examination. In step 3503, it is determined (e.g., statistically) whether a match is identified between the customer profile under examination and the churn pattern template. If not, process 3500 can be complete, or can loop back to repeat step 3501 for another customer profile.

Where it is determined that a match is identified between the customer profile under examination and the churn pattern template, in step 3504 the customer corresponding to the customer profile under examination is identified as a potential churn candidate. A potential churn candidate is a customer identified as one having significant (e.g., statistically relevant) potential for allowing their subscription to lapse without renewal and/or for subscription cancellation. In step 3505, a marketing and/or subscription management entity (e.g., marketing engine 17, account management module 175; FIG. 1B) is notified.

In step 3506, action is taken, e.g., by the marketing module, to prevent churn with respect to the subscription of the customer identified as a potential churn candidate, completing process 3500. For instance, action is taken in one embodiment to increase the customer satisfaction level of the customer identified as a potential churn candidate.

Exemplary Process for Improving and Monitoring Customer Satisfaction

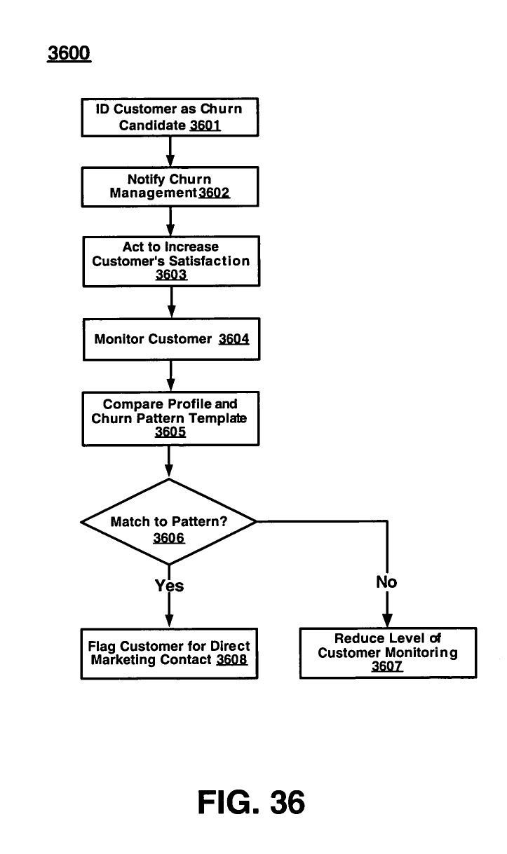

FIG. 36 is a flowchart of an exemplary computer implemented process 3600 for improving and monitoring customer satisfaction, according to one embodiment of the present invention. Process 3600 begins with step 3601, wherein a customer is identified as a potential churn candidate (e.g., step 3504 of process 3500; FIG. 35). A potential churn candidate is a customer identified as one having statistically significant potential for allowing their subscription to lapse without renewal and/or for subscription cancellation. In step 3602, a marketing and/or subscription management entity is notified that the customer is a potential churn candidate.

In step 3603, action is taken, e.g., by the marketing module and/or account management module, to prevent churn with respect to the subscription of the customer identified as a potential churn candidate. For instance, action is taken in one embodiment to increase the customer satisfaction level of the customer identified as a potential churn candidate. A variety of measures can be used to raise the level of customer satisfaction for a customer identified as a churn candidate. In one embodiment, this can be performed by an incentive engine (e.g., incentive engine 183; FIG. 1B).

In one embodiment action to increase the customer satisfaction level of a customer identified as a churn candidate includes increasing the inventory of available multimedia items known to be preferred (e.g., by examination of the associated customer profile) by this customer (and e.g., notifying the customer of the inventory change). In one embodiment, action to increase the customer satisfaction level of a customer identified as a churn candidate includes providing an incentive to continue, renew, reactivate, or otherwise extend their subscription. In one embodiment, such incentives include premiums, discounts, special offers, free (or reduced price) subscription extension periods, and/or other inducement. Various other measures can be taken to increase the customer satisfaction level of a customer identified as a churn candidate.

Upon taking action to increase the customer satisfaction level of a customer identified as a churn candidate, in step 3604, the customer is monitored. The customer is monitored in one embodiment by watching the customer's subscription status as to renewals, continuation, acceptance of offers, or other indicators that are positive with respect to churn management and for lapsing, cancellation, and other indicators that are negative with respect to churn management. In one embodiment, the customer's behavior within associated multimedia outlets is monitored, as discussed above, for traffic within the intelligent infrastructure thereof, browsing within various areas thereof, and check out (e.g., rental and/or purchase) of various multimedia items. This can be useful especially where inventory was adjusted, changed, augmented, etc., to accommodate the customer's preferences and/or to increase the customer's satisfaction level (e.g., step 3603, above). In one embodiment, the customer is monitored to ascertain whether an incentive that was offered (e.g., step 3603, above) to the customer was accepted.

In step 3605, the customer profile associated with the customer is monitored and continuously or periodically compared to the churn pattern template. In step 3606, it is determined whether the customer's profile continues to match the churn pattern template. Where it is determined that the customer's profile does not continue to match the churn pattern template, in step 3607, the level of monitoring applied to this customer is reduced, which advantageously conserves processing, database, networking, and/or other computing resources associated with the monitoring. Where it is determined that the customer's profile continues to match the churn pattern template, then in step 3608, the customer is flagged for more intensive churn management efforts, such as direct human marketing intervention. Process 3600 can be complete upon executing either step 3607 or step 3608. Direct human marketing intervention can include contacting the customer directly to ascertain reasons for the customer's continuing dissatisfaction. Action can be taken based on the reasons given in the direct contact discussions.

Exemplary Process for Replenishing Inventory

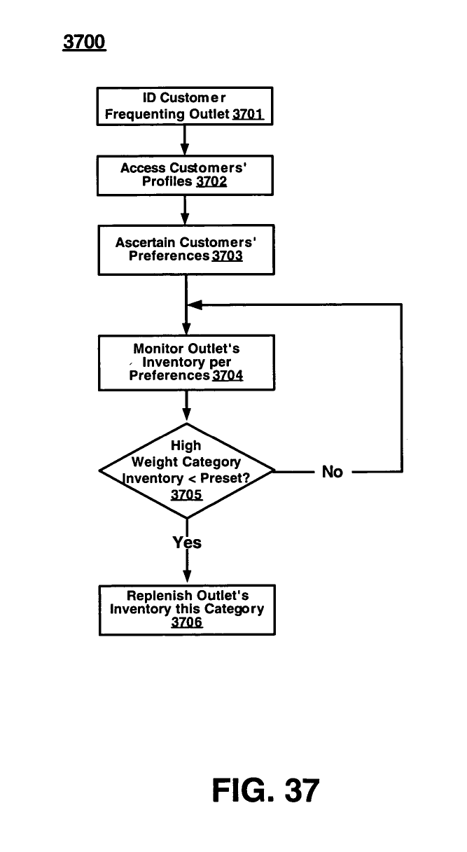

FIG. 37 is a flowchart of an exemplary computer implemented process 3700 for replenishing inventory in a multimedia outlet, according to one embodiment of the present invention. Process 3700 begins with step 3701, wherein the customers frequenting a particular multimedia outlet are ascertained, such as by monitoring the customers logging in and/or checking out (e.g., renting and/or purchasing) multimedia products comprising the inventory thereof.

In step 3702, the customer profiles associated with the customers frequenting that multimedia outlet are accessed. In step 3703, these customer profiles are analyzed to ascertain the preferences therein for various multimedia products, for instance, as to media (e.g., DVD, VHS, games, etc.), genre, sub-genre, and genre combination, and other artistic considerations such as actor, director, studio, producer, and the like.

In step 3704, the inventory of an associated multimedia outlet is monitored with respect to these preferences so as to determine the correspondence of the inventory thereto. In one embodiment, various criteria are applied to categorize the inventory with respect to the preferences. In one embodiment, the categories are weighted according to the demand for them expressed by the preferences. In one embodiment, the population of each category (e.g., quantity available within each category) is compared to a pre-set value, based on their various weightings. In a high weight category, which correspond for instance to a highly preferred medium and set of artistic considerations in one embodiment, the pre-set value may be lower than a low weight category.

In step 3705, it is determined whether the inventory population within a category is below the pre-set value, or is similarly deficient with respect to the preferences. If not, process 3700 loops back to step 3704 and continues to monitor the inventory with respect to the preferences. Where it is determined that the inventory population within a category is below the pre-set value (or is similarly deficient with respect to the preferences), in step 3706 action is taken to replenish the inventory of this multimedia outlet with respect to the preferences, for instance by implementing a procurement or inventory management stock transfer regime, completing process 3700.

Exemplary Process for Preference Based Inventory Transfer

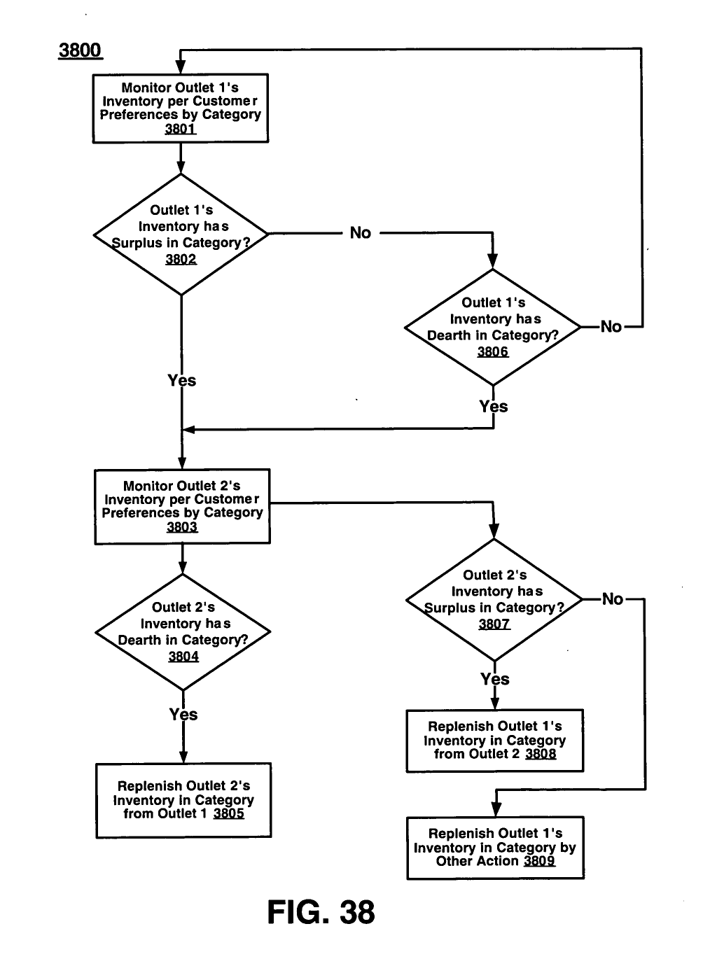

FIG. 38 is a flowchart of an exemplary computer implemented process 3800 for replenishing inventory in a multimedia outlet from another multimedia outlet, according to one embodiment of the present invention. Process 3800 begins with step 3801, wherein the inventory of a first particular associated multimedia outlet is monitored with respect to customer preferences (e.g., as to media, genre, sub-genre, and genre combination, and other artistic considerations such as actor, director, studio, producer, and the like) so as to determine the correspondence of the inventory thereto.

In step 3802, it is determined whether that store has a surplus of inventory items with respect to preferences in any particular inventory category (e.g., as to media, genre, sub-genre, and genre combination, and other artistic considerations such as actor, director, studio, producer, and the like). If so, then in step 3803, the inventory of other associated multimedia outlets is similarly monitored with respect to customer preferences so as to determine the correspondence of the inventory thereto.

In step 3804, it is determined whether the other stores have a dearth (e.g., lack, shortage, scarcity, deficiency, etc.) of inventory. If so, then in step 3805, inventory management action is taken to replenish the inventory-deficient categories of the other stores from the surplus inventory of the first store.

Where it is determined that the first store does not have a surplus, it is determined in step 3806 whether that store has a dearth of inventory items with respect to preferences in any particular inventory category. If not, the monitoring of the outlet's inventory can continue, as in step 3801, for example, periodically, occasionally, regularly, continuously, etc.

Where it is determined that the first store has a dearth in inventory in a category, then in step 3803, the inventory of other associated multimedia outlets is similarly monitored with respect to customer preferences so as to determine the correspondence of the inventory thereto. In step 3807, it is determined whether the other stores have a surplus of inventory in the category deficient in the first store. If so, then in step 3808, inventory management action is taken to replenish the inventory-deficient categories of the first store from the surplus inventory of the other stores. If not, in step 3809, other inventory management action, such as procurement action, is taken to replenish the deficient inventory of the first store. Process 3800 can be complete upon execution of either step 3808 or step 3809.

Exemplary Process for Dealing with Inventory Saturation

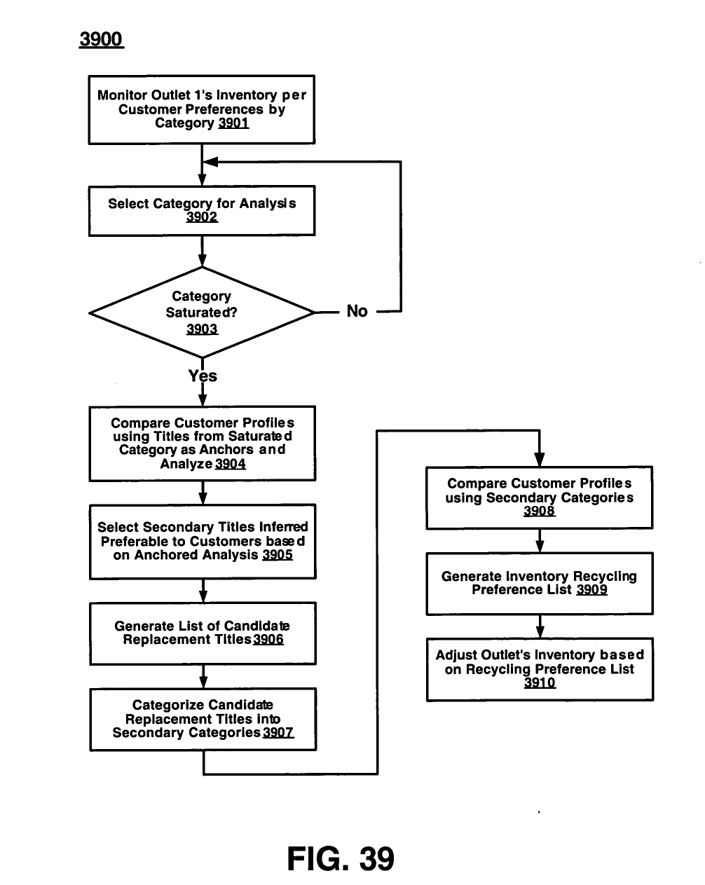

FIG. 39 is a flowchart of an exemplary computer implemented process 3900 for detecting and replacing saturated inventory in a multimedia outlet, according to one embodiment of the present invention. Process 3900 begins with step 3901, wherein the inventory of a particular associated multimedia outlet is monitored with respect to customer preferences (e.g., as to media, genre, sub-genre, and genre combination, and other artistic considerations such as actor, director, studio, producer, and the like), as expressed for example in customer profiles, so as to determine the correspondence of the inventory thereto. In one embodiment, the inventory is thus classified, for instance by title of each multimedia product comprising the inventory or by another such attribute, into a plurality of categories.

In step 3902, a category is selected for analysis. In step 3903, it is determined whether the inventory in that category is saturated, e.g., that the customers of that multimedia outlet whose profiles reveal that they prefer that category have already viewed, rented, purchased, or otherwise used the multimedia products comprising the inventory classified in that category. Where it is determined that the inventory in that category is not saturated, process 3900 loops back to step 3902 for selection of another category to analyze. Where it is determined that the inventory in that category is saturated, in step 3904 these and other customer profiles (e.g., the customer preferences expressed therein) are compared using the titles determined to be saturated as anchors (e.g., setting these titles as primary representatives of the category) and analyzed.

Based on this analysis, which is anchored by the primary titles, in step 3905 a secondary group of titles is selected, wherein the secondary group of titles is inferred (e.g., from marketing studies, database analysis, BI sources, surveys, and the like) to be preferable by the customers from whose profiles the original preferences were ascertained (e.g., in step 3901). For instance, it may be determined (e.g., or known, inferred, predicted, etc.) that customers who prefer primary titles in the romance and/or personal bonding genres/sub-genres/genre combinations may also prefer titles selected from the secondary light comedy adventure sub-genre/genre combination, or that customers who prefer titles in the primary action-adventure genre combination may also prefer titles selected from the secondary sports heroism sub-genre, etc.

In step 3906, the secondary titles thus selected is used to generate a list of candidate replacement titles. In step 3907, the list of candidate replacement titles is classified into secondary categories, in one embodiment similar to the manner in which the primary titles were categorized (e.g., in step 3901). In step 3908, the customer profiles are compared using the secondary categories. Based on this comparison, in step 3909, an inventory recycling preference list is generated. In step 3910, action is taken to adjust the inventory at the multimedia outlet according to the inventory recycling preference list, completing process 3900.

Exemplary Process for Transmigrating Inventory

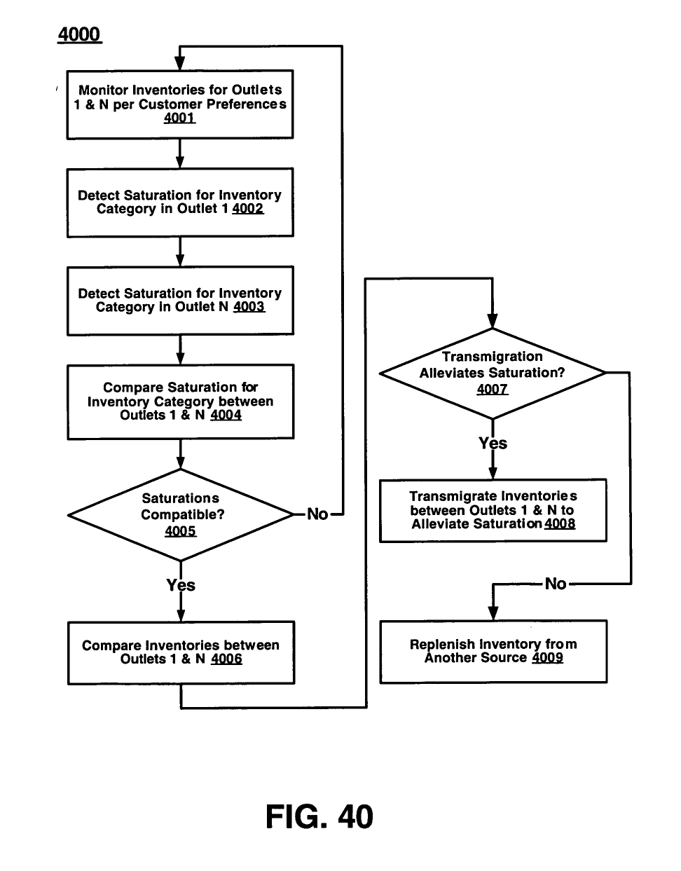

FIG. 40 is a flowchart of an exemplary computer implemented process 4000 for transmigrating saturated inventory between multimedia outlets, according to one embodiment of the present invention. Process 4000 begins with step 4001, wherein the inventory of a first and of an Nth associated multimedia outlets are monitored with respect to customer preferences, wherein N is any positive number greater than one (1) for a particular category. In step 4002, saturation is detected in the inventory of one, e.g., the first of the multimedia outlets. In step 4003, saturation is detected in the inventory of another, e.g., the Nth of the multimedia outlets.

In step 4004, the respective saturations of the first and the Nth outlets are compared. In step 4005, it is determined whether the respective saturations of the inventories of the first and Nth stores are complimentary. For instance, both the first and the Nth multimedia outlets are saturated with respect to a certain category (e.g., as classified above in process 3900; FIG. 39); however, the titles comprising the category in the multimedia outlets differ (e.g., multimedia outlet 1 has saturated titles 1-100 in a category ‘A’; multimedia outlet N has saturated titles 101-200 in that category, which differ from titles 1-100). Where it is determined that the respective saturations of the inventories of the first and Nth stores are not complimentary, process 4000 loops back to step 4001 and monitors the inventory of the first and the Nth multimedia outlets with respect to customer preferences for another category.

Where it is determined that the respective saturations of the inventories of the first and Nth stores are complimentary, in step 4006 the inventories of the first and the Nth multimedia outlets are compared, one to another in that category. In step 4007, it is determined whether transmigration of inventory in that category (e.g., exchanging, transferring, shifting, etc.) of the first and the Nth multimedia outlets in that category one to another) alleviates the saturation in either (e.g., or both) multimedia outlet. Where it is determined that transmigration of inventory in that category between the first and the Nth multimedia outlets alleviates the saturation in either, in step 4008, the inventory in that category is transferred from the first to the Nth, and from the Nth to the first multimedia outlets.

Where it is determined that transmigration of inventory in that category between the first and the Nth multimedia outlets does not alleviate the saturation in either multimedia outlet, in step 4009 action is taken to obtain new titles for the multimedia outlet which remains saturated in that category from another source. Such action can comprise a procurement or another action. Process 4000 can be complete upon execution of either step 4008 or step 4009.

Exemplary Process for Profiling Retail Environments

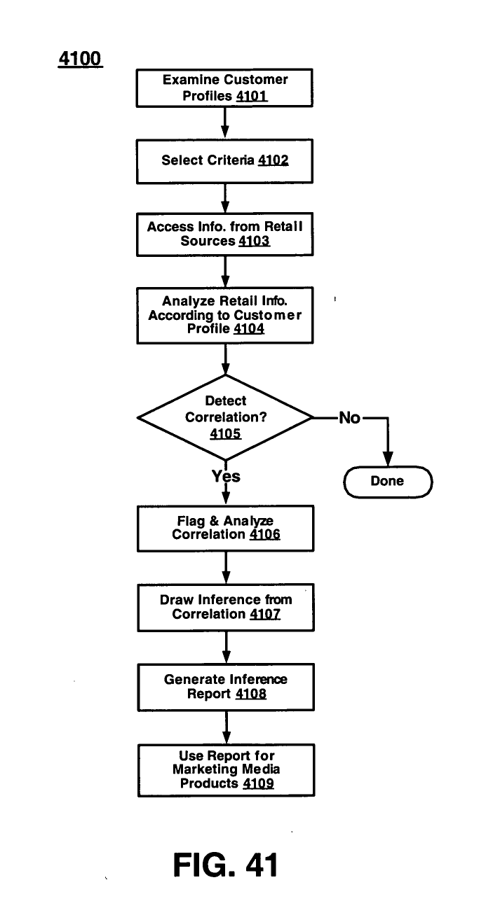

FIG. 41 is a flowchart of an exemplary computer implemented process 4100 for profiling retail environments, according to one embodiment of the present invention. Process 4100 begins with step 4101, wherein customer profiles are examined. In step 4102, a criteria (e.g., category) is selected for information therein.

In step 4103, related information is obtained from another source, such as a source of business intelligence (BI) information (e.g., BI database 7, BI source 8; FIG. 1A, 1B), or from an associated retail establishment, another business with which the system for performing intelligent multimedia marketing operations has an information exchange or provision agreement or the like, etc.

In step 4104, the related information is analyzed according to the criteria selected from the customer profiles. In step 4105, it is determined whether a correlation is detected between the related information and the customer profile criteria. If not, process 4100 loops back to step 4102 and another criterion is selected by which to analyze related information.

Where it is determined that a correlation is detected between the related information and the customer profile criteria, in step 4106 the correlation is noted and analyzed. In step 4107, an inference is drawn from the correlation. In step 4109, a report on the correlation and associated inference is generated. In step 4109, the report is used for marketing, completing process 4100.

Exemplary Intelligent Label Applicators

Exemplary Applicator Device

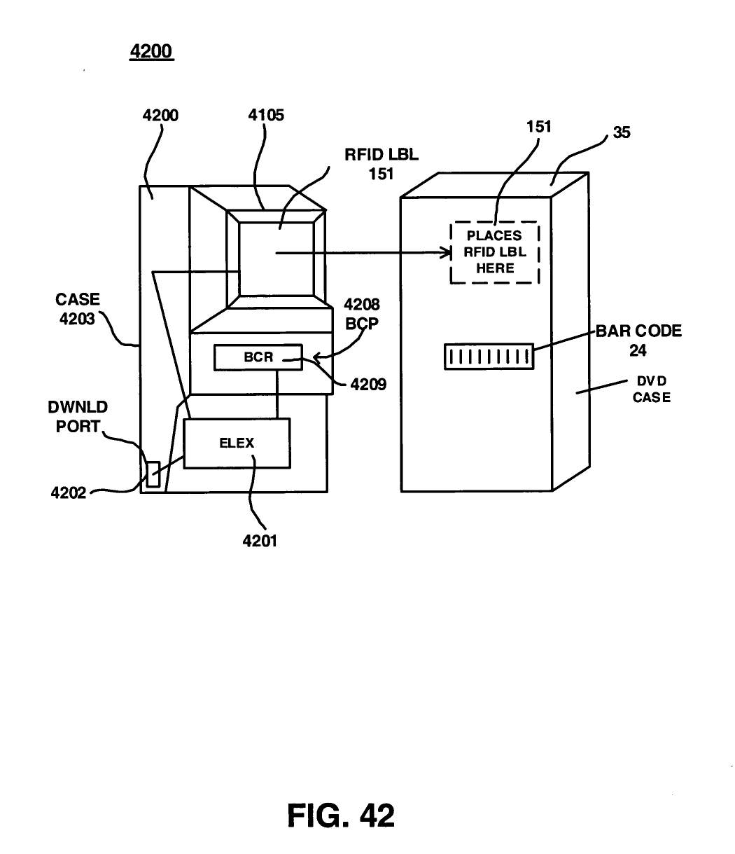

FIG. 42 depicts an exemplary multimedia intelligent label writer device 4200, according to one embodiment of the present invention. Multimedia intelligent label writer device 4200 is self-contained within a case 4203, which can be plastic, metal, or any other material. Multimedia intelligent label writer device 4200 comprises an electronics module 4201, which can be coupled to an external computer via a communications port 4202, for uploading and downloading data for programming electronics module 4201.

Communications port 4202 can comprise any functional connector, including but not limited to a serial or parallel port, a telephone jack, a firewire connector, a universal serial bus (USB) connector, a banana plug, etc. The data can be transferred to a tagging device 151 via a tag programmer 4105, which is controlled by electronics module 4201. In one embodiment, tag programmer 4105 also allows multimedia intelligent label writer device 4200 to read from tagging device 151.

Once so programmed, tagging device 151 can be applied by multimedia intelligent label writer device 4200 to a multimedia product (e.g., or product enclosure) 35. Tagging device 151 comprises, in one embodiment, a type of electronic tag, electronic label, code plate, or transponder, which can include (but is not limited to) an RFID device. The data can also be transferred to a bar code strip by a bar code printer 4208. A bar code reader (BCR) 4209 allows multimedia intelligent label writer device 4200 to read bar code 24, for instance from multimedia product 35.

In one embodiment, tagging device 151 and/or bar code 24 are provided in (e.g., or on) a media products 35, such as the case of rental DVDs and includes information relating to those media products, including (but not limited to) titles, stars, genre, subgenre classifications (to any level of granularity desired by or useful to system 100), and profile information relating to customers renting or otherwise accessing the media.

Exemplary Self-Contained Applicator Controller System

FIG. 42 depicts an exemplary self-contained multimedia intelligent label writer system 4300, according to one embodiment of the present invention. Multimedia intelligent label writer system 4300 comprises electronics module 4201, and in one embodiment thus incorporates multimedia intelligent label writer device 4200.

Electronics module 4201 comprises a microprocessor (e.g., or microcontroller) 4301, which is coupled to a memory functionality 4302 by a bus 4305. In one embodiment, memory functionality 4302 comprises a flash memory device, advantageously saving space, weight, and expense while providing ruggedness and ready erasability and programmability. In another embodiment, memory functionality 4302 comprises a static random access memory (SRAM) device, or another kind of memory device.

Bus 4305 also couples microprocessor 4301 to communications port 4202, to allow communications for programming, uploading, and downloading of data to an off board (e.g., external) computer 4392. Bus 4305 also couples bar code programmer 4304 and RFID (or other tagging device) write controller 4303 to microprocessor 4301, such as for control and programming purposes. Bar code programmer 4304 controls bar code printer 4208 and bar code reader 4209. RFID write controller 4303 controls RFID writer 4205.

Exemplary On-Line Multimedia Functionality

Exemplary On-Line Media Download Sub-System

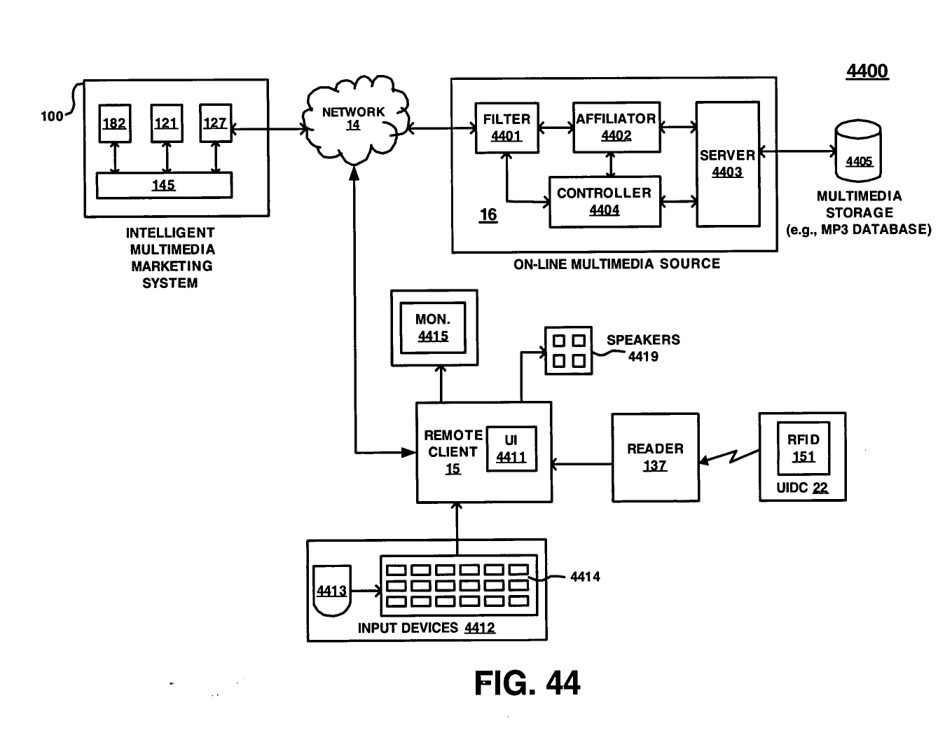

FIG. 44 depicts an exemplary networking system 4400 for accessing, providing, and allowing downloading of on-line media products with an intelligent multimedia rental operation, according to one embodiment of the present invention. Networking system 4400 couples intelligent multimedia marketing system 100, a remote client computer 15 that is accessed by a customer, subscriber, or another user of system 100, and on-line multimedia source 16, via network 14. Network 14, in one embodiment, comprises the Internet.

Intelligent multimedia marketing system 100 is discussed at length above at FIG. 1B. It is appreciated that, in the exemplary processes that follow, components of system 100 discussed above (FIG. 1B) not depicted in the present FIG. 44 can function to facilitate operations therein. Relating to networking system 4400, networking module 127 couples system 100 to network 14. System master controller 182 controls networking module 127 and other functions of system 100 via software bus 195.

Remote client computer 15 is operable by a user of system 100 such as a customer, subscriber, etc. to access networking system 4400 via network 14. Client computer 15 can be a user's home or work computer, a laptop or other portable computer, or any computer coupled to network 14 to which the user has access.

Client computer 15 has a user interface (UI) 4411. In one embodiment, user interface 4411 comprises a GUI. In another embodiment, UI 4411 is voice activated. A suite 4412 of input devices comprises a mouse 4413 or another point and select type device, and a keyboard 4414 or another alphanumeric input device. A monitor 4415 allows client computer 15 to display information to the user and, with GUI 4411, to provide input to networking system 4400. Speakers 4419 allow client computer to provide audio information to the user, such as music downloaded from on-line multimedia source 16.

Reader 137 provides input to client computer 15. In one embodiment, reader 137 comprises a peripheral component of client computer 15. In another embodiment, reader 137 comprises an integral component of client computer 15. Reader 137 reads a RFID tag 151 (e.g., or another electronic tag, electronic label, code plate, transponder, etc.), which comprises an encoded part of unique customer identifier card 22.

In one embodiment, system 4400 is accessed where a user exposes (e.g., presents, etc.) their unique customer identifier card 22 to reader 137. Reader 137 reads RFID tag 151 within (e.g., on, of, etc.) customer identifier card 22 and provides the data encoded therein via network 14 to system 100. System 100 identifies the customer and can access the customer's profile, billing record, and related information.

Upon receiving an input from client computer 15 indicative of a user's customer identifier card 22 being read there, on-line multimedia module 121 automatically networks client computer 15 with on-line multimedia source 16. In one embodiment, on-line multimedia module 121 automatically networks client computer 15 with on-line multimedia source 16 by linking, by proxy, or by another means. For instance, on-line multimedia source 16 can have a unique Universal Resource Locator (URL) to which on-line multimedia module 121 automatically links client computer 15.

On-line multimedia source 16 can comprise a variety of architectures, structures, and/or entities. In one embodiment, on-line multimedia source 16 networks with network 14 via a filter 4401. Filter 4401 allows authorized users to access on-line multimedia source 16, and excludes unauthorized users. Filter 4401 allows customers, subscribers, etc. of system 100 to access on-line multimedia source 16. Affiliator module 4402 affiliates on-line multimedia source 16 and system 100, to exchange information relating to the user, subscriber, customer, etc., such as from profile database 109 (FIG. 1B), billing information, marketing information, demographic data, and the like.

A controller module 4404 controls and directs the function and/or interaction of filter 441, affiliator 4402, and a server 4403. Server 4403 accesses a multimedia storage 4405 and retrieves information there from. Such information comprises, in one embodiment, downloadable music, such as MP3 files. Multimedia storage 4405 comprises, in one embodiment, a database, a large scale data storage facility, or another data storage medium. The information is provided to the user at client computer 15 via network 14. In one embodiment, server 4403 provides the information via affiliator 4402 and filter 4401. In another embodiment, server 4403 provides the information via filter 4401, or directly to network 14.

Exemplary Multimedia Downloading Processes

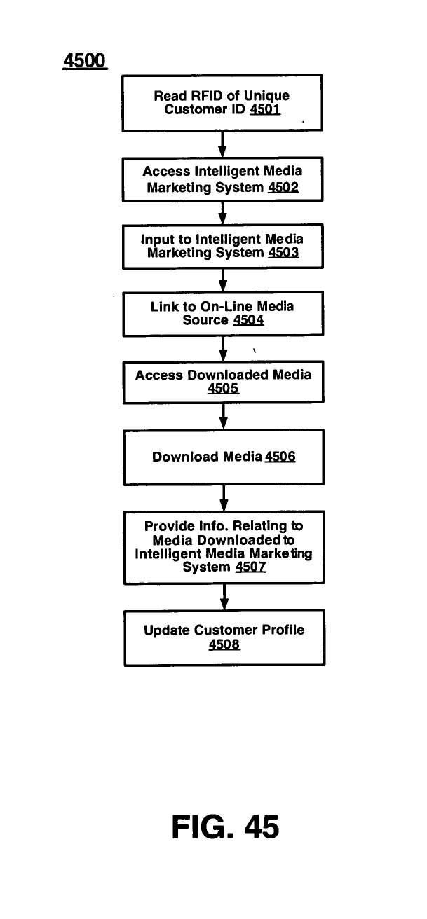

FIG. 45 is a flowchart of an exemplary computer implemented process 4500 for downloading on-line media products with an intelligent multimedia rental operation, according to one embodiment of the present invention. Process 4500 begins with step 4501, wherein an RFID tag or another electronic tag, electronic label, code plate, transponder, etc. associated with a unique customer identifier such as a customer card is read into a client computer.

In step 4502, in response to reading the RFID tag, the client computer accesses an intelligent multimedia marketing system via a network (e.g., where the client computer is not already networked with the system). In step 4503, the information read from the RFID tag is provided to the intelligent multimedia marketing system. In step 4504, the intelligent multimedia marketing system links the client computer to an on-line multimedia source, such as a music downloading source.

In step 4505, the client computer accesses downloadable multimedia, such as downloadable music in an MP3 or another format. In step 4506, selected multimedia products, such as an MP3 file relating to music (e.g., a song, an album or other musical compilation, or other media products) is downloaded from the on-line multimedia source to the client computer via the network.

In step 4507, information relating to the music or other multimedia download is provided to the intelligent multimedia marketing system. In step 4508, the intelligent multimedia marketing system updates the customer profile with data relating to the download, completing process 4500.

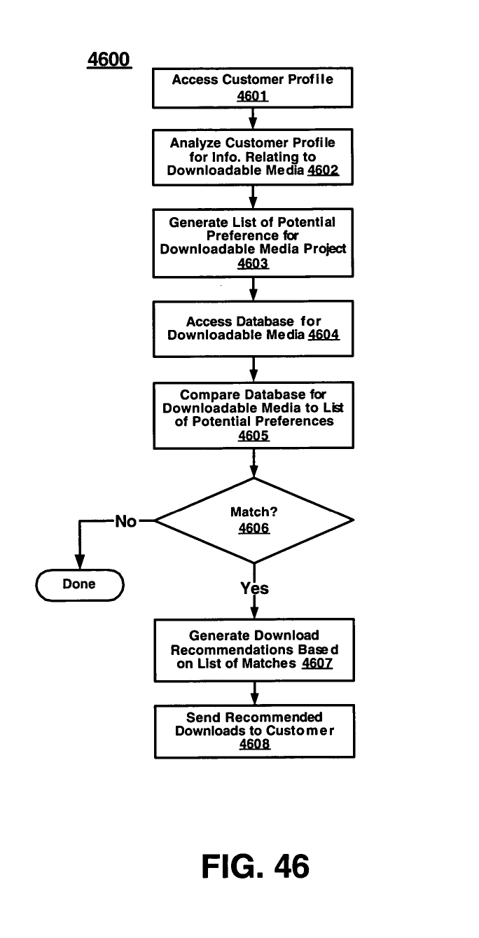

FIG. 46 is a flowchart of an exemplary computer implemented process 4600 for marketing downloadable on-line media products to customers of an intelligent multimedia rental operation, according to one embodiment of the present invention. Process 4600 begins with step 4601, wherein a customer profile is accessed.

In step 4602, the customer profile is analyzed for information that implies a potential preference for a downloadable multimedia product. For instance, a customer profile may indicate that a particular customer prefers media products from associated media outlets that relate to musicals, concerts, band documentaries, movies with famous and/or award-winning musical scores, etc.

In step 4603, a list of such potential preferences for downloadable media is generated for that customer. In step 4604, a database relating to downloadable media is accessed. In step 4605, the generated potential preference list is compared to information from the database of downloadable media.

In step 4607, it is determined whether a match exists between the generated potential preference list and the information from the database of downloadable media (e.g., that the potentially preferable downloadable media is available from the database). If the potentially preferred downloadable media is not available at the downloadable media database, in one embodiment, process 4600 is complete. In another embodiment, another database of downloadable media can be checked for availability of the potential preference.

Where it is determined that a match exists between the generated potential preference list and the information from the database of downloadable media, in step 4608, the match is listed as an available potential preference. In step 4609, a recommendation for downloading media, based on those listed, is sent to the customer.

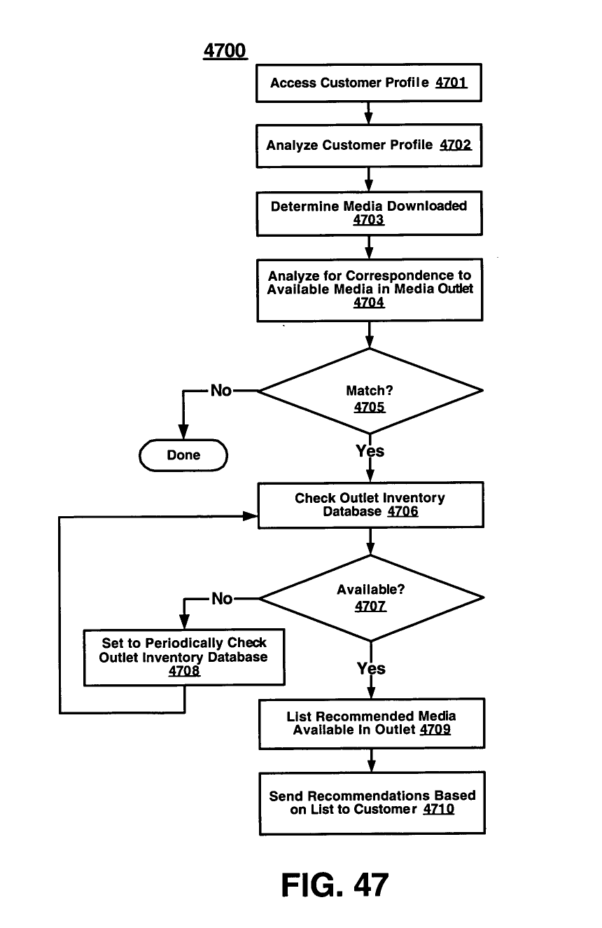

FIG. 47 is a flowchart of an exemplary computer implemented process 4700 for marketing media products to customers of an intelligent multimedia rental operation based on downloaded on-line media products, according to one embodiment of the present invention. Process 4700 begins with step 4701, wherein a customer profile is accessed.

In step 4702, the customer profile is analyzed. In step 4703, media products such as music, which the customer has downloaded is determined from the customer profile. In step 4704, information relating to the media products that the customer has downloaded is analyzed for points of correspondence to available media within an associated multimedia outlet frequented by the customer.

For instance, where analysis of the customer profile reveals that the customer has downloaded a significant number of MP3 files relating to a particular musical genre, artist, or other criteria, the inventory of the outlet the customer frequents for DVDs, for instance, is analyzed for correspondence to those criteria. By way of example, a customer profile may reveal that the customer has downloaded a collection of songs or albums by a particular band. The multimedia outlet that the customer frequents has a movie relating to that same band. Thus, a point of correspondence exists between the music the customer downloads and a movie available in the media outlet.

In step 4705, it is determined whether a match exists between the media the customer downloads and media available at the media outlet the customer frequents. If not, process 4700 can be complete. Where it is determined that a match exists between the media the customer downloads and media available at the media outlet the customer frequents, in step 4706, the inventory database relating to that media outlet is checked as to the availability of the corresponding media product.

In step 4707, it is determined whether the corresponding media product is currently available in the outlet. If not, in step 4708, the inventory database of the outlet is flagged for periodic recheck for that item (and/or e.g., steps are taken to procure the corresponding item), and step 4707 is thus periodically repeated. Where it is determined that the corresponding media product is currently available in the outlet, a list of the matching media products is generated. In step 4710, the list is sent to the customer, completing process 4700.

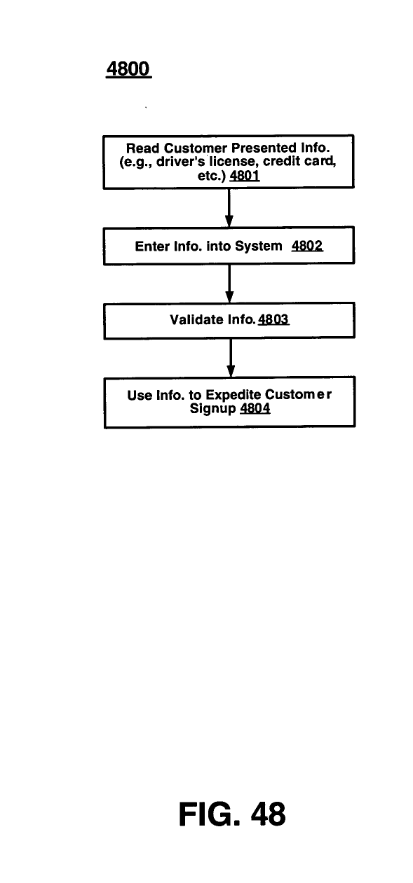

FIG. 48 is a flowchart of a process 4800 for expediting customer signups, according to one embodiment of the present invention. Process 4800 begins with step 4801, wherein customer presented information (e.g., a driver's license, a credit card, etc.) is read. In step 4802, the customer presented information is entered into a system for conducting intelligent multimedia marketing operations. In step 4803, the customer presented information is validated. In step 4804, the validated customer information is used to expedite customer signup.

In summary, a system and method for conducting intelligent multimedia marketing operations is disclosed. In one embodiment, a computer based system, which can operate in a network environment, conducts the intelligent multimedia operation. In one embodiment, the system is deployed in a physical asset such as a multimedia outlet (e.g., a store) wherein an intelligent infrastructure monitors customer behavior therein and inventory. In one embodiment, the system performs a variety of computer implemented processes related to conducting intelligent multimedia marketing operations.

1. A method for conducting an intelligent multimedia marketing operation, comprising:
identifying a customer;
accessing a profile corresponding to said customer wherein said profile relates to multimedia preferences of said customer;
based on said profile, generating a list of recommendations for multimedia products for said customer;
monitoring behavior of said customer;
analyzing said behavior;
based on said analysis, inferring a level of satisfaction corresponding to said customer;
updating said customer profile according to said level of satisfaction;
comparing said level of satisfaction with a preset minimum satisfaction value; and
upon determining that said level of satisfaction falls below a minimum satisfaction value, flagging said customer as having a significant probability of churn; and
taking an action to reduce a probability of churn associated with said customer.

2. The method as recited in claim 1 wherein said identifying comprises one or more of:
recognizing said customer upon arrival of said customer at an intelligent multimedia marketing outlet; and
authenticating communication from said customer upon contact via a network.

3. The method as recited in claim 2 wherein said intelligent multimedia marketing outlet comprises:
an inventory of multimedia items; and
a plurality of sections for appropriately displaying said items of said inventory, each said section corresponding to one or more of:
a type of media product displayed therein; and
a genre characterizing a media product corresponding to said type displayed therein;
wherein said monitoring comprises:
tracking said customer within said intelligent multimedia marketing outlet;
timing the presence of said customer in each of said sections;
noting which, if any inventory items said customer examines in each of said sections;
noting which, if any said inventory items said customer selects;
noting which, if any said inventory items said customer checks out; and
updating said profile accordingly.

4. The method as recited in claim 3 wherein said analyzing comprises:
based on said timing, comparing a time said customer spends in each said section with a preset time value;
upon said time exceeding said preset time value and based on said noting which, if any inventory items said customer examines, comparing a number of said inventory items examined with a preset minimum item value;
upon said number of said inventory items examined exceeding said with a preset minimum item value, determining whether said customer makes a selection;
upon one or more of said time falling below said minimum time value, said number of inventory items examined falling below said preset minimum item value, and determining that said customer does not make a selection:
inferring an interest of said customer in one or more of said type and said genre;
comparing said inferred interest with said profile and said inventory; and
updating said profile according to said inferred interest; and
upon determining that said customer makes a selection, noting an identity corresponding to said item; and
updating said profile accordingly.

5. The method as recited in claim 1 wherein said customer comprises one of a plurality of customers, wherein each said customer of said plurality thereof has associated therewith a unique, corresponding said profile, said method further comprising:
recognizing said customer and a segment of other customers of said plurality of customers according to said significant probability of churn;
accessing a plurality of profiles, each said profile of said plurality of profiles corresponding to one of said segment of other customers;
analyzing said plurality of profiles for any pattern;
upon detecting one of said patterns, classifying said pattern; and
taking an action to change said pattern.

6. The method as recited in claim 5 wherein said segment of customers includes former customers.

7. The method as recited in claim 1 wherein said taking an action to reduce a probability of churn associated with said customer comprises one or more of:
adjusting said inventory of said intelligent multimedia marketing outlet;
offering said customer a premium; and
changing a policy relating to a function of said intelligent multimedia marketing outlet;
according to customer's profile, said method further comprising:
further monitoring said customer;
based on said monitoring, ascertaining effectiveness associated with said action; and
based on said ascertaining said effectiveness, changing said action.

8. A computer usable medium having encoded thereon instructions for allowing a computer system to perform a process for conducting an intelligent multimedia marketing operation, said process comprising:
identifying a customer;
accessing a profile corresponding to said customer wherein said profile relates to multimedia preferences of said customer;
based on said profile, generating a list of recommendations for multimedia products for said customer;
monitoring behavior of said customer;
analyzing said behavior;
based on said analysis, inferring a level of satisfaction corresponding to said customer;
updating said customer profile according to said level of satisfaction;
comparing said level of satisfaction with a preset minimum satisfaction value; and
upon determining that said level of satisfaction falls below a minimum satisfaction value, flagging said customer as having a significant probability of churn; and
taking an action to reduce a probability of churn associated with said customer.

9. The computer usable medium as recited in claim 8 wherein said computer usable medium comprises one or more of a plurality of computer usable media and wherein said identifying comprises one or more of:
recognizing said customer upon arrival of said customer at an intelligent multimedia marketing outlet; and
authenticating communication from said customer upon contact via a network.

10. The computer usable medium as recited in claim 9 wherein said intelligent multimedia marketing outlet comprises:
an inventory of multimedia items; and
a plurality of sections for appropriately displaying said items of said inventory, each said section corresponding to one or more of:
a type of media product displayed therein; and
a genre characterizing a media product corresponding to said type displayed therein;
wherein said monitoring comprises:
tracking said customer within said intelligent multimedia marketing outlet;
timing the presence of said customer in each of said sections;
noting which, if any inventory items said customer examines in each of said sections;
noting which, if any said inventory items said customer selects;
noting which, if any said inventory items said customer checks out; and
updating said profile accordingly.

11. The computer usable medium as recited in claim 10 wherein said analyzing comprises:
based on said timing, comparing a time said customer spends in each said section with a preset time value;
upon said time exceeding said preset time value and based on said noting which, if any inventory items said customer examines, comparing a number of said inventory items examined with a preset minimum item value;
upon said number of said inventory items examined exceeding said with a preset minimum item value, determining whether said customer makes a selection;
upon one or more of said time falling below said minimum time value, said number of inventory items examined falling below said preset minimum item value, and determining that said customer does not make a selection:
inferring an interest of said customer in one or more of said type and said genre;
comparing said inferred interest with said profile and said inventory; and
updating said profile according to said inferred interest; and
upon determining that said customer makes a selection, noting an identity corresponding to said item; and
updating said profile accordingly.

12. The computer usable medium as recited in claim 8 wherein said customer comprises one of a plurality of customers, wherein each said customer of said plurality thereof has associated therewith a unique, corresponding said profile, said method further comprising:
recognizing said customer and a segment of other customers of said plurality of customers according to said significant probability of churn;
accessing a plurality of profiles, each said profile of said plurality of profiles corresponding to one of said segment of other customers;
analyzing said plurality of profiles for any pattern;
upon detecting one of said patterns, classifying said pattern; and
taking an action to change said pattern.

13. The computer usable medium as recited in claim 12 wherein said segment of customers includes former customers.

14. The computer usable medium as recited in claim 8 wherein said taking an action to reduce a probability of churn associated with said customer comprises one or more of:
adjusting said inventory of said intelligent multimedia marketing outlet;
offering said customer a premium; and
changing a policy relating to a function of said intelligent multimedia marketing outlet;
according to customer's profile, said method further comprising:
further monitoring said customer;
based on said monitoring, ascertaining effectiveness associated with said action; and
based on said ascertaining said effectiveness, changing said action.

15. A system for conducting an intelligent multimedia marketing operation, comprising:
means for identifying a customer;
means for accessing a profile corresponding to said customer wherein said profile relates to multimedia preferences of said customer;
means for, based on said profile, generating a list of recommendations for multimedia products for said customer;
means for monitoring behavior of said customer;
means for analyzing said behavior;
means for, based on said analysis, inferring a level of satisfaction corresponding to said customer;
means for updating said customer profile according to said level of satisfaction;
means for comparing said level of satisfaction with a preset minimum satisfaction value; and
means for, upon determining that said level of satisfaction falls below a minimum satisfaction value, flagging said customer as having a significant probability of churn; and
means for taking an action to reduce a probability of churn associated with said customer.

16. The system as recited in claim 15 wherein said identifying means comprises one or more of:
means for recognizing said customer upon arrival of said customer at an intelligent multimedia marketing outlet; and
means for authenticating communication from said customer upon contact via a network.

17. The system as recited in claim 16 wherein said intelligent multimedia marketing outlet comprises:
an inventory of multimedia items; and
a plurality of sections for appropriately displaying said items of said inventory, each said section corresponding to one or more of:
a type of media product displayed therein; and
a genre characterizing a media product corresponding to said type displayed therein;
wherein said monitoring means comprises:
means for tracking said customer within said intelligent multimedia marketing outlet;
means for timing the presence of said customer in each of said sections;
means for noting which, if any inventory items said customer examines in each of said sections;
means for noting which, if any said inventory items said customer selects;
means for noting which, if any said inventory items said customer checks out; and
means for updating said profile accordingly.

18. The system as recited in claim 17 wherein said analyzing means comprises:
based on said timing, means for comparing a time said customer spends in each said section with a preset time value;
upon said time exceeding said preset time value and based on said noting which, if any inventory items said customer examines, means for comparing a number of said inventory items examined with a preset minimum item value;
upon said number of said inventory items examined exceeding said with a preset minimum item value, means for determining whether said customer makes a selection;
means for, upon one or more of said time falling below said minimum time value, said number of inventory items examined falling below said preset minimum item value, and determining that said customer does not make a selection:
inferring an interest of said customer in one or more of said type and said genre;
comparing said inferred interest with said profile and said inventory; and
updating said profile according to said inferred interest; and
means for, upon determining that said customer makes a selection, noting an identity corresponding to said item; and
means for, updating said profile accordingly.

19. The system as recited in claim 15 wherein said customer comprises one of a plurality of customers, wherein each said customer of said plurality thereof has associated therewith a unique, corresponding said profile, said system further comprising:
means for recognizing said customer and a segment of other customers of said plurality of customers according to said significant probability of churn;
means for accessing a plurality of profiles, each said profile of said plurality of profiles corresponding to one of said segment of other customers;
means for analyzing said plurality of profiles for any pattern;
means for, upon detecting one of said patterns, classifying said pattern; and
means for taking an action to change said pattern.

20. The system as recited in claim 15 wherein said means for taking an action to reduce a probability of churn associated with said customer comprises one or more of:
means for adjusting said inventory of said intelligent multimedia marketing outlet;
means for offering said customer a premium; and
means for changing a policy relating to a function of said intelligent multimedia marketing outlet;
according to customer's profile, said system further comprising:
means for further monitoring said customer;
means for, based on said monitoring, ascertaining effectiveness associated with said action; and
means for, based on said ascertaining said effectiveness, changing said action.
